(19) United States
(12) Patent Application Publication
(10) Pub. No.: US 2024/0283023 A1
(43) Pub. Date: Aug. 22, 2024

(54) SECONDARY BATTERY AND ELECTRONIC DEVICE

(71) Applicant: SEMICONDUCTOR ENERGY LABORATORY CO., LTD., Kanagawa (JP)

(72) Inventors: Kazutaka KURIKI, Ebina, Kanagawa (JP); Yumiko YONEDA, Isehara, Kanagawa (JP); Yoshiharu ASADA, Odawara, Kanagawa (JP); Tetsuya KAKEHATA, Isehara, Kanagawa (JP)

(21) Appl. No.: 18/557,127

(22) PCT Filed: Apr. 15, 2022
(86) PCT No.: PCT/IB2022/053559

§ 371 Date: Oct. 25, 2023

(30) Foreign Application Priority Data
Apr. 29, 2021 (JP) 2021-076906
May 11, 2021 (JP) 2021-080507
Oct. 26, 2021 (JP) 2021-174720
Dec. 3, 2021 (JP) 2021-196646

(51) Int. Cl. H01M 10/0567; H01G 11/46; H01G 11/50; H01G 11/62; H01M 4/02; H01M 4/131; H01M 4/525; H01M 10/0525

(52) U.S. Cl. CPC H01M 10/0567; H01G 11/46; H01G 11/50; H01G 11/62; H01M 4/131; H01M 4/525; H01M 10/0525; H01M 2004/028; H01M 2300/0025

(57) ABSTRACT

A lithium-ion secondary battery with a high capacity and excellent charge and discharge cycle performance is provided. A secondary battery with a high capacity is provided. A secondary battery whose shape hardly changes in a vacuum is provided. A bendable secondary battery is provided. The secondary battery contains a positive electrode active material and an electrolyte; the positive electrode active material is lithium cobalt oxide to which magnesium is added; magnesium has a gradient in which a concentration increases from an inner portion toward a surface of the positive electrode active material; the electrolyte contains an imidazolium salt; and a temperature range where the secondary battery can operate is higher than or equal to −20° C. and lower than or equal to 100° C.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, and a manufacturing method thereof. In particular, one embodiment of the present invention relates to a positive electrode active material that can be used for a secondary battery, a secondary battery, an electronic device including a secondary battery, and a vehicle including a secondary battery.

Another embodiment of the present invention relates to a power storage system including a secondary battery and a battery control circuit. Another embodiment of the present invention relates to an electronic device and a vehicle each including a power storage system.

Note that in this specification, a power storage device refers to every element and device having a function of storing power. Examples of the power storage device include a storage battery (also referred to as a secondary battery) such as a lithium-ion secondary battery, a lithium-ion capacitor, and an electric double layer capacitor.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of semiconductor devices, for portable information terminals such as mobile phones, smartphones, tablets, and laptop computers, portable music players, digital cameras, medical equipment, and next-generation clean energy vehicles (e.g., hybrid vehicles (HVs), electric vehicles (EVs), and plug-in hybrid vehicles (PHVs)), for example. The lithium-ion secondary batteries are essential as rechargeable energy supply sources for today's information society.

The performances required for lithium-ion secondary batteries are much higher energy density, improved cycle performance, safety under a variety of operation environments, and improved long-term reliability, for example.

In view of the above, improvement of positive electrode active materials has been studied to improve the cycle performance and increase the capacities of lithium-ion secondary batteries (Patent Document 1 and Patent Document 2). In addition, crystal structures of positive electrode active materials have been studied (Non-Patent Document 1 to Non-Patent Document 3).

### REFERENCES

### Patent Documents

[Patent Document 1] Japanese Published Patent Application No. 2002-216760
[Patent Document 2] Japanese Published Patent Application No. 2006-261132

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LixCoO₂ (0.0≤x≤1.0)”, Physical Review B, 80 (16); 165114.
[Non-Patent Document 3] Zhaohui Chen et al., “Staging Phase Transitions in LixCoO₂”, Journal of The Electrochemical Society, 2002, 149 (12) A1604-A1609.
[Non-Patent Document 4] Belsky, A. et al., “New developments in the Inorganic Crystal Structure Database (ICSD): accessibility in support of materials research and design”, Acta Cryst., (2002) B58, pp. 364-369.

### SUMMARY OF THE INVENTION

### Problems to be Solved by the Invention

An object of one embodiment of the present invention is to provide a lithium-ion secondary battery having a high capacity and excellent charge and discharge cycle performance, and a fabrication method thereof. Another object of one embodiment of the present invention is to provide a secondary battery that can be rapidly charged, and a fabrication method thereof. Another object of one embodiment of the present invention is to provide a high-capacity secondary battery, and a fabrication method thereof. Another object of one embodiment of the present invention is to provide a secondary battery having excellent charge and discharge characteristics, and a fabrication method thereof. Another object is to provide a secondary battery in which a capacity decrease is inhibited even when a state of being charged with a high voltage is held for a long period, and a fabrication method thereof. Another object of one embodiment of the present invention is to provide a highly safe or reliable secondary battery, and a fabrication method thereof. Another object of one embodiment of the present invention is to provide a secondary battery in which a capacity decrease is inhibited even at high temperatures, and a fabrication method thereof. Another object of one embodiment of the present invention is to provide a long-life secondary battery, and a fabrication method thereof.

Another object of one embodiment of the present invention is to provide a safe, long-life, and excellent secondary battery that can be rapidly charged, can be used at high temperatures, and can have a high energy density due to increased charge voltage.

Another object of one embodiment of the present invention is to provide a secondary battery that can be used in a vacuum and a fabrication method thereof. Another object is to provide a bendable secondary battery and a fabrication method thereof. Another object is to provide a bendable secondary battery that can be used in a vacuum and a fabrication method thereof.

Another object of one embodiment of the present invention is to provide a positive electrode active material that has a high capacity and excellent charge and discharge cycle performance for a lithium-ion secondary battery, and a fabrication method thereof. Another object is to provide a method for forming a positive electrode active material with high productivity. Another object of one embodiment of the present invention is to provide a positive electrode active material that inhibits a capacity decrease in charge and discharge cycles when used for a lithium-ion secondary battery. Another object of one embodiment of the present invention is to provide a positive electrode active material in which dissolution of a transition metal such as cobalt is inhibited even when a state of being charged with a high voltage is held for a long period.

Another object of one embodiment of the present invention is to provide a novel material, a novel active material, a novel power storage device, or a formation method thereof.

Note that the description of these objects does not preclude the existence of other objects. One embodiment of the present invention does not have to achieve all these objects. Note that other objects can be derived from the description of the specification, the drawings, and the claims.

### Means for Solving the Problems

One embodiment of the present invention is a secondary battery containing a positive electrode active material and an electrolyte, in which the positive electrode active material is lithium cobalt oxide to which magnesium is added, magnesium has a gradient in which a concentration increases from an inner portion toward a surface of the positive electrode active material, the electrolyte contains an imidazolium salt, and a temperature range where the secondary battery can operate is higher than or equal to −20° C. and lower than or equal to 100° C.

Another embodiment of the present invention is a secondary battery containing a positive electrode active material, an electrolyte, and an exterior body, in which the positive electrode active material is lithium cobalt oxide containing magnesium, magnesium has a gradient in which a concentration increases from an inner portion toward a surface of the positive electrode active material, the electrolyte contains an imidazolium salt, the exterior body includes a film having a depression and a projection, and a temperature range where the secondary battery can operate is higher than or equal to −20° C. and lower than or equal to 100° C.

In the above structure, it is preferable that the positive electrode active material be lithium cobalt oxide containing aluminum in addition to magnesium, aluminum have a gradient in which a concentration increases from the inner portion toward the surface of the positive electrode active material, and a peak of the concentration of magnesium be closer to the surface than a peak of the concentration of aluminum is in a surface portion of the positive electrode active material.

In the above structure, the electrolyte preferably contains a compound represented by General Formula (G1).

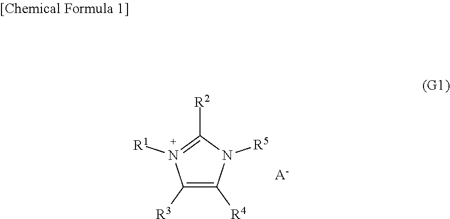

In the formula, R¹ represents an alkyl group having 1 to 4 carbon atoms, R², R³, and R⁴ each independently represent a hydrogen atom or an alkyl group having 1 to 4 carbon atoms, and R⁵ represents an alkyl group or a main chain composed of two or more atoms selected from C, O, Si, N, S, and P atoms. In addition, A⁻ represents an amide-based anion represented by (CₙF₂ₙ₊₁SO₂)₂N⁻ (n is greater than or equal to 0 and less than or equal to 3).

In the above structure, it is preferable that R¹ in General Formula (G1) represent one group selected from a methyl group, an ethyl group, and a propyl group, one of R², R³, and R⁴ represent a hydrogen atom or a methyl group and the other two of R², R³, and R⁴ each represent a hydrogen atom, R⁵ represent an alkyl group or a main chain composed of two or more atoms selected from C, O, Si, N, S, and P atoms, and A⁻ represent one of (FSO₂)₂N⁻ and (CF₃SO₂)₂N⁻ or a mixture of (FSO₂)₂N⁻ and (CF₃SO₂)₂N⁻.

In the above structure, it is preferable that the sum of the number of carbon atoms of R¹, the number of carbon atoms of R⁵, and the number of oxygen atoms of R⁵ be less than or equal to 7 in General Formula (G1).

In the above structure, it is preferable that R¹ represent a methyl group, R² represent a hydrogen atom, and the sum of the numbers of carbon atoms and oxygen atoms of R⁵ be less than or equal to 6 in General Formula (G1).

Another embodiment of the present invention is an electronic device including the secondary battery described in any of the above and a solar panel.

A method for fabricating a bendable secondary battery includes a first step of forming a stack by stacking a positive electrode, a negative electrode, and a separator; a second step of placing the stack inside an exterior body; a third step of injecting an electrolyte containing an ionic liquid into the exterior body to impregnate the stack with the electrolyte; and a fourth step of sealing the exterior body. The exterior body includes a film having a depression and a projection. The third step and the fourth step are performed at lower than or equal to 1000 Pa.

### Effect of the Invention

According to one embodiment of the present invention, a lithium-ion secondary battery having a high capacity and excellent charge and discharge cycle performance, and a fabrication method thereof can be provided. According to another embodiment of the present invention, a secondary battery that can be rapidly charged, and a fabrication method thereof can be provided. A secondary battery in which a capacity decrease is inhibited even when a state of being charged with a high voltage is held for a long period, and a fabrication method thereof can be provided. According to another embodiment of the present invention, a highly safe or reliable secondary battery, and a fabrication method thereof can be provided. According to another embodiment of the present invention, a secondary battery in which a capacity decrease is inhibited even at high temperatures, and a fabrication method thereof can be provided. According to another embodiment of the present invention, a long-life secondary battery, and a fabrication method thereof can be provided.

According to another embodiment of the present invention, a safe, long-life, and excellent secondary battery that can be rapidly charged, can be used at high temperatures, and can have a high energy density due to increased charge voltage can be provided.

According to another embodiment of the present invention, a secondary battery that can be used in a vacuum and a fabrication method thereof can be provided. Alternatively, a bendable secondary battery and a fabrication method thereof can be provided. Alternatively, a bendable secondary battery that can be used in a vacuum and a fabrication method thereof can be provided.

According to another embodiment of the present invention, a positive electrode active material that has a high capacity and excellent charge and discharge cycle performance for a lithium-ion secondary battery, and a fabrication method thereof can be provided. A method for forming a positive electrode active material with high productivity can be provided. According to another embodiment of the present invention, a positive electrode active material that inhibits a capacity decrease in charge and discharge cycles when used for a lithium-ion secondary battery can be provided. According to another embodiment of the present invention, a positive electrode active material in which dissolution of a transition metal such as cobalt is inhibited even when a state of being charged with a high voltage is held for a long period can be provided.

According to another embodiment of the present invention, a novel material, a novel active material, a novel power storage device, or a formation method thereof can be provided.

Note that the description of these effects does not preclude the existence of other effects. One embodiment of the present invention does not have to have all these effects. Note that effects other than these will be apparent from the description of the specification, the drawings, the claims, and the like and effects other than these can be derived from the description of the specification, the drawings, the claims, and the like.

### BRIEF DESCRIPTION OF THE DRAWINGS

FIG. 1A1, FIG. 1A2, FIG. 1B, FIG. 1C, FIG. 1D, and FIG. 1E are cross-sectional views of a positive electrode active material.

FIG. 2A, FIG. 2B, FIG. 2C, and FIG. 2D are cross-sectional views of a positive electrode active material.

FIG. 3 is a cross-sectional view of a positive electrode active material.

FIG. 4A and FIG. 4B are cross-sectional views of a positive electrode active material.

FIG. 5 is a diagram illustrating crystal structures of a positive electrode active material.

FIG. 6 is a diagram illustrating crystal structures of a positive electrode active material of a comparative example.

FIG. 7A to FIG. 7C are diagrams showing methods for forming a positive electrode active material.

FIG. 8 is a diagram showing a method for forming a positive electrode active material.

FIG. 9A to FIG. 9C are diagrams showing methods for forming a positive electrode active material.

FIG. 10A and FIG. 10B are photographs showing electrolyte solutions.

FIG. 11A to FIG. 11D are schematic cross-sectional views of a negative electrode active material.

FIG. 12A to FIG. 12D are schematic cross-sectional views illustrating examples of cross sections of a secondary battery.

FIG. 13 is a diagram illustrating a cross section of a film.

FIG. 14A to FIG. 14F are diagrams illustrating cross sections of a film.

FIG. 15A to FIG. 15D are diagrams illustrating cross sections of a film.

FIG. 16A and FIG. 16B are diagrams illustrating top surfaces of films.

FIG. 17A to FIG. 17D are diagrams illustrating top surfaces of films.

FIG. 18A and FIG. 18B are diagrams illustrating top surfaces of films.

FIG. 19A to FIG. 19D are diagrams illustrating top surfaces of films.

FIG. 20A and FIG. 20B are diagrams illustrating examples of the appearance of a secondary battery.

FIG. 21A and FIG. 21B are diagrams illustrating cross sections of a secondary battery.

FIG. 22A is a diagram illustrating an example of the appearance of a secondary battery. FIG. 22B is a diagram illustrating a cross section of the secondary battery.

FIG. 23A and FIG. 23B are diagrams illustrating a method for fabricating a secondary battery.

FIG. 24A and FIG. 24B are diagrams illustrating a method for fabricating a secondary battery.

FIG. 25A is a diagram illustrating components of a secondary battery. FIG. 25B is a diagram illustrating an example of the appearance of the secondary battery.

FIG. 26 is a top view illustrating an example of a manufacturing apparatus for a secondary battery.

FIG. 27 is a cross-sectional view illustrating an example of a secondary battery.

FIG. 28A to FIG. 28C are perspective views illustrating an example of a method for fabricating a secondary battery. FIG. 28D is a cross-sectional view corresponding to FIG. 28C.

FIG. 29A to FIG. 29F are perspective views illustrating an example of a method for fabricating a secondary battery.

FIG. 30 is a cross-sectional view illustrating an example of a secondary battery.

FIG. 31A is diagram illustrating an example of a secondary battery. FIG. 31B and FIG. 31C are diagrams illustrating an example of a method for forming a stack.

FIG. 32A to FIG. 32C are diagrams illustrating an example of a method for fabricating a secondary battery.

FIG. 33A and FIG. 33B are cross-sectional views illustrating examples of stacks. FIG. 33C is a cross-sectional view illustrating an example of a secondary battery.

FIG. 34A and FIG. 34B are diagrams illustrating examples of a secondary battery. FIG. 34C is a diagram illustrating an internal state of the secondary battery.

FIG. 35A to FIG. 35C are diagrams illustrating an example of a secondary battery.

FIG. 36A to FIG. 36E are diagrams illustrating a bendable secondary battery.

FIG. 37A and FIG. 37B are diagrams illustrating a bendable secondary battery.

FIG. 38A and FIG. 38B are diagrams illustrating a film processing method.

FIG. 39A to FIG. 39C are diagrams illustrating a film processing method.

FIG. 40A to FIG. 40E are top views, a cross-sectional view, and a schematic view illustrating one embodiment of the present invention.

FIG. 41A and FIG. 41B are cross-sectional views of a secondary battery illustrating one embodiment of the present invention.

FIG. 42A to FIG. 42E are diagrams illustrating a method for fabricating a secondary battery.

FIG. 43A to FIG. 43E are diagrams illustrating a structure example of a secondary battery.

FIG. 44A to FIG. 44C are diagrams illustrating structure examples of a secondary battery.

FIG. 45A to FIG. 45C are diagrams illustrating structure examples of a secondary battery.

FIG. 46A to FIG. 46C are diagrams illustrating structure examples of a secondary battery.

FIG. 47A is a perspective view illustrating an example of a battery pack. FIG. 47B is a block diagram illustrating an example of a battery pack. FIG. 47C is a block diagram illustrating an example of a vehicle including a motor.

FIG. 48A to FIG. 48E are diagrams illustrating examples of transport vehicles.

FIG. 49A is a diagram illustrating an electric bicycle, FIG. 49B is a diagram illustrating a secondary battery of the electric bicycle, and FIG. 49C is a diagram illustrating a motor scooter.

FIG. 50A and FIG. 50B are diagrams illustrating examples of power storage devices.

FIG. 51A to FIG. 51E are diagrams illustrating examples of an electronic device.

FIG. 52A to FIG. 52H are diagrams illustrating examples of electronic devices.

FIG. 53A to FIG. 53C are diagrams illustrating an example of an electronic device.

FIG. 54 is a diagram illustrating examples of electronic devices.

FIG. 55A to FIG. 55C are diagrams illustrating examples of electronic devices.

FIG. 56A to FIG. 56C are diagrams illustrating examples of electronic devices. FIG. 56D and FIG. 56E are diagrams illustrating examples of devices for space.

FIG. 57 is a photograph of a secondary battery.

FIG. 58A and FIG. 58B are diagrams showing cycle performance of a secondary battery.

FIG. 59A and FIG. 59B are diagrams showing cycle performance of a secondary battery.

FIG. 60A and FIG. 60B are diagrams showing cycle performance of a secondary battery.

FIG. 61 is a diagram showing cycle performance of a secondary battery.

FIG. 62A and FIG. 62B are photographs of the appearance of a secondary battery.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification and the like, crystal planes and orientations are indicated by the Miller index. In the crystallography, a bar is placed over a number in the expression of crystal planes and orientations; however, in this specification and the like, because of application format limitations, crystal planes and orientations may be expressed by placing − (a minus sign) at the front of a number instead of placing a bar over the number. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”.

In this specification and the like, segregation refers to a phenomenon in which in a solid made of a plurality of elements (e.g., A, B, and C), a certain element (e.g., B) is spatially non-uniformly distributed.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

A theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of lithium nickel oxide (LiNiO₂) is 275 mAh/g, and the theoretical capacity of lithium manganese oxide (LiMn₂O₄) is 148 mAh/g.

The remaining amount of lithium that can be inserted into and extracted from a positive electrode active material is represented by x in a compositional formula, e.g., x in LiₓCoO₂ or x in LiₓMO₂ (M is a transition metal). That is, x can also be referred to as the occupancy rate of Li in lithium sites. In the case of a positive electrode active material in a secondary battery, x can be represented by (theoretical capacity−charge capacity)/theoretical capacity. For example, in the case where a secondary battery using LiCoO₂ as a positive electrode active material is charged to 219.2 mAh/g, it can be said that the positive electrode active material is represented by Li_{0.2}CoO₂ or x=0.2. Small x in LiₓCoO₂ means, for example, 0.1<x≤0.24. Note that the transition metal M can be selected from the elements belonging to Groups 3 to 11 of the periodic table and, for example, at least one of manganese, cobalt, and nickel is used.

In the case where lithium cobalt oxide almost satisfies the stoichiometric proportion, lithium cobalt oxide is LiCoO₂ and x=1. For a secondary battery after its discharging ends, it can be said that lithium cobalt oxide is LiCoO₂ and x=1. Here, “discharging ends” means that voltage becomes lower than or equal to 2.5 V (vs. lithium counter electrode) at a current of 100 mA/g, for example. In a lithium-ion secondary battery, voltage rapidly decreases when x in LiₓCoO₂ of a positive electrode becomes close to 1 and more lithium cannot enter the lithium-ion secondary battery. At this time, it can be said that discharging ends. In general, in a lithium-ion secondary battery using LiCoO₂, the discharge voltage rapidly decreases until discharge voltage reaches 2.5 V; thus, discharging ends under the above-described conditions.

It is preferable to measure a charge capacity and/or a discharge capacity used for calculation of x in LiₓCoO₂ under the conditions where there is no influence or small influence of a short circuit and/or decomposition of an electrolyte. For example, it is preferable that data of a secondary battery containing a sudden capacity change that seems to result from a short circuit not be used for calculation of x.

In this specification and the like, a rock-salt crystal structure refers to a structure in which cations and anions are alternately arranged. Note that a cation or anion vacancy may exist.

In this specification and the like, an O3′ type crystal structure (also referred to as a pseudo-spinel crystal structure) of a composite oxide containing lithium and a transition metal refers to a crystal structure with a space group R-3m, which is not a spinel crystal structure but a crystal structure in which an ion of cobalt, magnesium, or the like is coordinated to six oxygen atoms and the cation arrangement has symmetry similar to that of the spinel crystal structure. Note that in the O3′ type crystal structure, a light element such as lithium occupies a site coordinated to four oxygen atoms in some cases. Also in that case, the ion arrangement has symmetry similar to that of the spinel crystal structure.

The O3′ type crystal structure can be regarded as a crystal structure that contains lithium between layers randomly and is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have this crystal structure generally.

Anions of a layered rock-salt crystal and anions of a rock-salt crystal form a cubic close-packed structure (face-centered cubic lattice structure). Anions of an O3′ type crystal are presumed to form a cubic close-packed structure. When these crystals are in contact with each other, there is a crystal plane at which orientations of cubic close-packed structures composed of anions are aligned. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other.

XRD (X-ray diffraction) is one of methods used for analysis of a crystal structure of a positive electrode active material. With the use of the ICSD (Inorganic Crystal Structure Database) described in Non-Patent Document 4, XRD data can be analyzed.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

### Embodiment 1

In this embodiment, an example of a secondary battery of one embodiment of the present invention will be described.

An electronic device in an artificial satellite, a space probe, or the like needs to operate normally under a severe environment in outer space. For example, a difference between temperature in the sunshine and temperature in the shade is extremely large in outer space; thus, an electronic device needs to operate normally in a wide temperature range. A secondary battery provided in an electronic device can be held in an airtight container with a high heat-retaining property, for example. However, a temperature change is inevitable even when a secondary battery is held in such a container; thus, a temperature range where a secondary battery can operate is preferably as wide as possible. For example, a secondary battery of one embodiment of the present invention preferably operates at higher than or equal to −60° C. and lower than or equal to 150° C., higher than or equal to −40° C. and lower than or equal to 120° C., or higher than or equal to −20° C. and lower than or equal to 100° C. The secondary battery of one embodiment of the present invention preferably has excellent charge and discharge cycle performance especially at higher than or equal to −20° C. and lower than or equal to 80° C.

Here, an operation of a secondary battery refers to, for example, a state where discharging can be observed, a state where charging can be observed, or a state where charging and discharging can be observed.

A state where charging and discharging can be observed refers to, for example, a state where a secondary battery can have a capacity that is higher than or equal to 1%, preferably higher than or equal to 10%, further preferably higher than or equal to 25% of a rated capacity of the secondary battery. The rated capacity conforms to JIS C 8711:2019.

The secondary battery of one embodiment of the present invention is preferably stable in preservation at higher than or equal to −150° C. and lower than or equal to 250° C., higher than or equal to −80° C. and lower than or equal to 200° C., or higher than or equal to −60° C. and lower than or equal to 150° C., for example. Being stable after preservation refers to, for example, a state where an operation of a secondary battery can be observed after preservation.

In order to reduce the cost for the launch or transportation of an artificial satellite and a space probe for space use, the sizes of them need to be reduced. An artificial satellite or a space probe needs to have excellent performance even with a size limit; thus, a secondary battery provided in an artificial satellite or a space probe preferably has a high capacity and a small size. That is, at least one of the capacity per volume and the capacity per weight needs to be high. In addition, the volume and weight of components other than an active material, such as an exterior body, are preferably as small as possible, for example.

In outer space, an electronic device needs to operate normally in a vacuum (e.g., a pressure environment at 1000 Pa or lower) and thus needs to have high airtightness.

In the secondary battery of one embodiment of the present invention, an ionic liquid is used as a solvent of an electrolyte solution. An ionic liquid has a feature of being nonvolatile. This can inhibit a change in the shape (e.g., expansion) of the secondary battery of one embodiment of the present invention due to the vaporization of the electrolyte solution even in a vacuum. In addition, in a fabrication process of the secondary battery, an exterior body can be sealed in a vacuum (also referred to as reduced-pressure sealing) after the injection of the electrolyte solution. That is, in the fabrication process of the secondary battery, a gas remaining inside the secondary battery or a gas contained in the electrolyte solution can be deaerated and degassed; thus, a change in the shape of the secondary battery due to a change in the volume of such gases can be inhibited even when the secondary battery is put in a vacuum.

When the structure of the above-described secondary battery is employed for a bendable secondary battery described in Embodiment 3 below, a secondary battery that can be bent even in a vacuum can be achieved. An example of a method for fabricating such a secondary battery will be described below. First, a stack is formed by stacking a positive electrode, a negative electrode, and a separator in a first step. Next, the stack is placed inside an exterior body formed into a bag-like shape in a second step. The exterior body preferably includes a film that has depressions and projections and will be described later.

Next, an electrolyte solution containing an ionic liquid is injected into the exterior body so that the stack is impregnated with the electrolyte solution in a third step, and the periphery of the exterior body is sealed in a fourth step. Here, the steps from the injection of the electrolyte solution to the sealing of the exterior body are performed in a vacuum (e.g., a pressure environment at 1000 Pa or lower), whereby a secondary battery that can be bent even in a vacuum can be fabricated.

In a secondary battery using an ionic liquid, expansion due to volatilization of an electrolyte solution hardly occurs. Thus, the secondary battery can have high airtightness. By contrast, a solvent used in a general electrolyte solution, e.g., an organic solvent described later, might be volatilized even within an operating temperature range of a secondary battery. The volatilized solvent might become a gas and cause the expansion of an exterior body of a secondary battery. Alternatively, the gas might leak to the outside of the exterior body of the secondary battery.

A secondary battery provided in an electronic device used in outer space can be held in a container with high airtightness, for example. However, even when the secondary battery is held in such a container, the expansion of the secondary battery and the gas generation from the secondary battery might cause deformation of the container and a decrease in airtightness.

In some cases, an electrolyte solution causes reaction on the surface of a positive electrode or a negative electrode in charging and discharging of a secondary battery so that a gas is generated. Since the secondary battery of one embodiment of the present invention is fabricated using the ionic liquid stable at the potentials of the positive electrode and the negative electrode, such gas generation can sometimes be inhibited.

The secondary battery of one embodiment of the present invention is fabricated using, as a positive electrode active material, a material in which a capacity decrease due to charge and discharge cycles is small. That is, the secondary battery of one embodiment of the present invention has a long lifetime and its capacity decrease can be inhibited even when a usage period is long.

In the secondary battery of one embodiment of the present invention, a capacity decrease caused by long-term use can be inhibited and thus the reaction of the electrolyte solution is small, so that a high capacity after long-term use can be achieved even when charge voltage does not exceed a stable range. Accordingly, with the use of the secondary battery of one embodiment of the present invention, a high capacity after long-term use can be achieved and gas generation due to charging and discharging can be inhibited at the same time.

A positive electrode active material of one embodiment of the present invention has a layered rock-salt crystal structure and thus has an extremely high capacity. A conventional material having a layered rock-salt crystal structure is unstable in the state where a large amount of lithium is extracted; hence, reversible charging and discharging are sometimes difficult. Thus, it is sometimes difficult to use the conventional material for a secondary battery used in outer space where stability in long-term use is required. The positive electrode active material of one embodiment of the present invention having a layered rock-salt crystal structure has a feature of being stable even in the state where a large amount of lithium is extracted. Accordingly, with the use of the positive electrode active material of one embodiment of the present invention, both an extremely high capacity and stability in long-term use can be achieved.

It is preferable that power generated by a solar panel be stored in a secondary battery provided in an electronic device used in outer space, for example. A solar panel has a function of generating power using sunlight. A solar panel is referred to as a solar cell module in some cases. A solar panel generates power in the sunshine. On the other hand, a solar panel generates an extremely small amount of power or no power in the shade.

The secondary battery of one embodiment of the present invention is fabricated using a combination of the positive electrode active material of one embodiment of the present invention described later and the electrolyte solution containing the ionic liquid, whereby charging and discharging at a high rate can be performed. Thus, the secondary battery of one embodiment of the present invention has excellent output characteristics, so that power supplied from a solar panel in the sunshine can be efficiently stored in a shorter time.

Note that outer space in this specification and the like refers to, for example, the expanse beyond the earth's atmosphere.

As described in Example below, it has been found that the secondary battery of one embodiment of the present invention has extremely stable performance even when charged with a high voltage. In addition, the secondary battery of one embodiment of the present invention can operate stably in a wide temperature range. According to one embodiment of the present invention, a secondary battery having significantly excellent performance can be achieved.

The positive electrode active material used for the secondary battery of one embodiment of the present invention is preferably an oxide containing an element A, a transition metal M, and an additive element X.

As the element A, one or more selected from alkali metals such as lithium, sodium, and potassium and Group 2 elements such as calcium, beryllium, and magnesium can be used, for example. The element A is preferably an element that functions as a metal serving as a carrier ion.

The positive electrode active material of one embodiment of the present invention contains one or more of cobalt, nickel, and manganese, particularly cobalt, as the transition metal M, for example.

The positive electrode active material used for the secondary battery of one embodiment of the present invention may be represented by the chemical formula AM_{y}O_{z} (y>0 and z>0). Lithium cobalt oxide may be represented by LiCoO₂. Lithium nickel oxide may be represented by LiNiO₂.

The positive electrode active material used for the secondary battery of one embodiment of the present invention preferably contains the additive element X. An element such as magnesium, calcium, zirconium, lanthanum, barium, titanium, or yttrium can be used as the additive element X. An element such as nickel, aluminum, cobalt, manganese, vanadium, iron, chromium, or niobium can be used as the additive element X. An element such as copper, potassium, sodium, zinc, chlorine, fluorine, hafnium, silicon, sulfur, phosphorus, boron, or arsenic can be used as the additive element X, for example. Two or more of the elements described above may be used in combination as the additive element X. For example, one or more selected from magnesium, calcium, and barium and one or more selected from nickel, aluminum, and manganese can be used as the additive element X.

Part of the additive element X may substitute at the element A position, for example. Alternatively, part of the additive element X may substitute at the transition metal M position, for example.

The positive electrode active material used for the secondary battery of one embodiment of the present invention may be represented by the chemical formula A_{1-w}X_{w}M_{y}O_{z} (y>0, z>0, and 0<w<1). The positive electrode active material used for the secondary battery of one embodiment of the present invention may be represented by the chemical formula AM_{y-j}XⱼO_{z} (y>0, z>0, and 0<j<y). The positive electrode active material used for the secondary battery of one embodiment of the present invention may be represented by the chemical formula A_{1-w}X_{w}M_{y-j}XⱼO_{z} (y>0, z>0, 0<w<1, and 0<j<y).

The positive electrode active material used for the secondary battery of one embodiment of the present invention preferably contains halogen in addition to the additive element X. Halogen such as fluorine or chlorine is preferably contained. When the positive electrode active material used for the secondary battery of one embodiment of the present invention contains the halogen, substitution of the additive element X at the element A position is promoted in some cases.

As charge voltage of a secondary battery increases, the crystal structure of a positive electrode active material becomes unstable and the performance of the secondary battery is reduced in some cases. For example, the case is described where a material which has a layered crystal structure and in which the element A is extracted from a space between layers because of a charge reaction is used as a positive electrode active material. The increase in charge voltage can increase the charge capacity and the discharge capacity of such a positive electrode active material. Meanwhile, as charge voltage increases, a larger amount of element A may be extracted from the positive electrode active material and a change in the crystal structure such as a change in the interlayer distance or generation of displacement of a layer may noticeably occur. In the case where a change in the crystal structure due to insertion and extraction of the element A is irreversible, the crystal structure may be gradually broken along with repetitive charging and discharging and a capacity decrease due to charge and discharge cycles may noticeably occur.

An increase in charge voltage may facilitate dissolution of the transition metal M contained in the positive electrode active material into an electrolyte. Dissolution of the transition metal M from the positive electrode active material into the electrolyte might decrease the amount of transition metal M of the positive electrode active material and might decrease the capacity of a positive electrode.

In the positive electrode active material used for the secondary battery of one embodiment of the present invention, the transition metal M is mainly bonded to oxygen. Release of oxygen from the positive electrode active material might cause dissolution of the transition metal M.

Cobalt is dissolved in lithium cobalt oxide because of charging and discharging with a high voltage or in a high-temperature environment, whereby a crystal phase that is different from the lithium cobalt oxide may be formed in a surface portion. For example, one or more of CO₃O₄ having a spinel structure, LiCo₂O₄ having a spinel structure, and CoO having a rock-salt structure may be formed. These materials are materials having lower discharge capacities than lithium cobalt oxide or not contributing to charging and discharging, for example. Thus, formation of these materials in the surface portion might decrease the discharge capacity of the secondary battery. Furthermore, the output characteristics and low-temperature characteristics of the secondary battery might be decreased.

In some cases, the transition metal M is dissolved from the positive electrode active material, the electrolyte transfers an ion of the transition metal M, and the transition metal M is precipitated at the surface of a negative electrode. In addition, at the surface of the negative electrode, a coating film may be formed from the transition metal M and a decomposition product of the electrolyte. The formation of the coating film makes insertion and extraction of carrier ions into/from a negative electrode active material difficult, which might decrease the rate characteristics, low-temperature characteristics, or the like of the secondary battery.

Since the positive electrode active material used for the secondary battery of one embodiment of the present invention can have an O3′ structure described later in charging, charging can be performed to a large charge depth. The increase in charge depth can increase the capacity of the positive electrode, so that the energy density of the secondary battery can be increased. Even in the case of using an extremely high charge voltage, charging and discharging can be repeated.

Note that in the case where charging is performed at a higher charge voltage, the transition metal M has a larger oxidation number. In such a state, dissolution of the transition metal M easily occurs as described above.

In the secondary battery of one embodiment of the present invention, dissolution of the transition metal M easily occurs because of an extremely high charge voltage, but the electrolyte containing a desired ionic liquid can suppress dissolution of the transition metal M. Thus, both a high charge voltage and suppression of dissolution of the transition metal M can be achieved. Moreover, charging and discharging at a high rate can be achieved. Furthermore, excellent charge and discharge characteristics at low temperatures can be achieved.

When a positive electrode active material layer is formed on a current collector and then pressing is performed, steps may be observed on the particle surface that is in the perpendicular direction (the c-axis direction) with respect to the lattice fringes observed in a cross-sectional STEM image or the like. In addition, a trace of deformation along the lattice fringe direction (the ab plane direction) may be observed. A stripe pattern observed on the particle surface due to the steps on the particle surface where displacement is caused by the pressing is referred to as a slip. A crystal structure is unstable at such a slip of the particle, which might decrease the performance of the secondary battery. Thus, it is desirable to reduce the number of slips of the particle or prevent generation of a slip.

The present inventors have found that the use of a later-described positive electrode active material, which is used for the secondary battery of one embodiment of the present invention, and an electrolyte containing an ionic liquid enables a secondary battery to have excellent performance.

The present inventors also have found that, in the secondary battery of one embodiment of the present invention, generation of a pit is inhibited in the positive electrode active material after repetitive charging and discharging. It is also found that, in the secondary battery of one embodiment of the present invention, a heterogeneous phase does not exist or a heterogeneous phase is not included substantially in the surface portion of the positive electrode active material after repetitive charging and discharging. Specifically, for example, it is found that, in the case where the positive electrode active material is lithium cobalt oxide, CO₃O₄ having a spinel structure, LiCo₂O₄ having a spinel structure, and CoO having a rock-salt structure do not exist or are not included substantially in the surface portion of the positive electrode active material. It is also found that, in the secondary battery of one embodiment of the present invention, a heterogeneous phase does not exist or a heterogeneous phase is not included substantially in the vicinity of a pit of the positive electrode active material after repetitive charging and discharging. Specifically, for example, it is found that, in the case where the positive electrode active material is lithium cobalt oxide, CO₃O₄ having a spinel structure, LiCo₂O₄ having a spinel structure, and CoO having a rock-salt structure do not exist or are not included substantially in the vicinity of a pit of the positive electrode active material. For the expression “not included substantially”, dust or the like attached to a surface is not taken into consideration, for example.

The present inventors also have found that, in the secondary battery of one embodiment of the present invention, after repetitive charging and discharging, a coating film on the surface of a negative electrode active material is thin and the amount of transition metal M detected on the surface of the negative electrode active material or in the coating film formed on the surface of the negative electrode active material is extremely small.

It is suggested that, in the secondary battery of one embodiment of the present invention, the amount of transition metal M detected on the surface of the negative electrode active material or in the coating film formed on the surface of the negative electrode active material is extremely small and the coating film is thin. For this reason, it is possible to achieve a secondary battery that contains a negative electrode active material into and from which carrier ions are easily inserted and extracted, has high output characteristics, and is easily charged and discharged even at low temperatures, for example.

In the secondary battery of one embodiment of the present invention, dissolution of the transition metal M can be inhibited; thus, a capacity decrease can be inhibited and the breakage of a crystal structure can also be inhibited. Thus, it is possible to achieve an excellent secondary battery in which a capacity decrease is inhibited even when the secondary battery is charged and discharged repeatedly, held in a charged state, or held at high temperatures.

In the secondary battery of one embodiment of the present invention, a heterogeneous phase is not formed substantially on the surface of the positive electrode, so that a capacity decrease is inhibited and carrier ions are easily inserted and extracted into/from the positive electrode active material. Thus, a secondary battery in which a capacity decrease is inhibited can be achieved. Moreover, a secondary battery that has high output characteristics and is easily charged and discharged even at low temperatures can be achieved.

An ionic liquid has low volatility and low inflammability, and is stable in a wide temperature range. An ionic liquid is not easily volatilized even at high temperatures, so that expansion of a secondary battery due to gas generated from an electrolyte solution can be inhibited. Thus, the secondary battery operates stably even at high temperatures. Furthermore, an ionic liquid has low inflammability and is unlikely to burn.

For example, the above-described organic solvent has a boiling point lower than 150° C. and has high volatility; thus, gas might be generated when a secondary battery is used at high temperatures and an exterior body of the secondary battery might be expanded. In addition, an organic solvent has a flash point lower than or equal to 50° C. in some cases. By contrast, an ionic liquid has low volatility, and is extremely stable at up to a temperature lower than a temperature at which a reaction such as decomposition occurs, e.g., up to approximately 300° C.

Accordingly, with the use of an ionic liquid, a secondary battery can be used in a high-temperature environment, and a highly safe secondary battery can be achieved. For example, with the use of an ionic liquid, a secondary battery that has stable performance even at 50° C. or higher, 60° C. or higher, or 80° C. or higher can be achieved.

That is, the secondary battery of one embodiment of the present invention can perform an excellent operation in a wide temperature range from a low temperature to a high temperature.

With the use of a positive electrode active material in which an irreversible change in a crystal structure is inhibited also at a high charge voltage, the charge voltage of the secondary battery of one embodiment of the present invention can be increased. Thus, the secondary battery can have high energy density. In addition, an ionic liquid is used for the electrolyte of the secondary battery of one embodiment of the present invention, so that dissolution of the transition metal M from the positive electrode active material can be inhibited. Thus, even when charging is performed repeatedly at a high charge voltage, a capacity decrease due to charge and discharge cycles can be inhibited.

An ionic liquid used for the electrolyte of the secondary battery of one embodiment of the present invention is a salt containing a combination of a cation and an anion. An ionic liquid is referred to as a room temperature molten salt in some cases.

When the positive electrode active material described in this embodiment and an ionic liquid are used in combination, dissolution of the transition metal M from the positive electrode active material can be inhibited in the state where the charge depth is deep (e.g., the state where x in LiₓCoO₂ is small). The positive electrode active material of one embodiment of the present invention contains the additive element X. The additive element X in the positive electrode active material of one embodiment of the present invention preferably has a concentration gradient. The concentration of the additive element X preferably has a gradient that increases from the inner portion toward the surface. The gradient of the concentration of the additive element X can be evaluated using energy dispersive X-ray spectroscopy (EDX).

As described above, an ionic liquid is chemically stable even at high temperatures. However, when other components of a secondary battery, such as a positive electrode active material, a negative electrode active material, and an exterior body, change at high temperatures, particularly irreversibly change, a significant capacity decrease might occur in the secondary battery.

For example, when the crystal structure of a material included in a positive electrode active material changes irreversibly because of charging at high temperatures, a secondary battery significantly deteriorates. For example, a significant capacity decrease due to charge and discharge cycles might occur. The crystal structure of a positive electrode might become more unstable at higher temperatures and at a higher charge voltage.

When a positive electrode active material whose crystal structure is extremely stable at a high charge voltage and at high temperatures is used for the secondary battery of one embodiment of the present invention, excellent performance can be achieved even at high temperatures and at a high charge voltage, so that an ionic liquid can sufficiently exert its effect. That is, a significant improvement in performance achieved by employing the structure of the secondary battery of one embodiment of the present invention is found when the structure is combined with the positive electrode active material described in the embodiment.

The positive electrode active material used for the secondary battery of one embodiment of the present invention preferably contains the additive element X as described later, and preferably contains halogen in addition to the additive element X. It is suggested that when the positive electrode active material of one embodiment of the present invention contains the additive element X or contains halogen in addition to the additive element X, a reaction with an ionic liquid on the surface of the positive electrode active material is inhibited. As described above, an ionic liquid is extremely stable even at high temperatures. Meanwhile, in the secondary battery of one embodiment of the present invention, the range of reaction potential is extremely wide. In such a wide reaction potential range, a reaction with an ionic liquid on the surface of the active material is concerned in some cases. When the positive electrode active material of one embodiment of the present invention is used, a reaction with an ionic liquid is inhibited and it is suggested that a more stable secondary battery is provided.

The secondary battery of one embodiment of the present invention is preferably used in combination with a battery control circuit. The battery control circuit preferably has a function of controlling charging, for example. Controlling charging refers to, for example, monitoring a parameter of a secondary battery and changing charge conditions in accordance with a state. Examples of a parameter to be monitored of a secondary battery include the voltage, current, temperature, amount of electric charge, and impedance of the secondary battery.

The secondary battery of one embodiment of the present invention is preferably used in combination with a sensor. The sensor preferably has a function of measuring, for example, one or more of displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, and infrared rays.

Charging of the secondary battery of one embodiment of the present invention is preferably controlled in accordance with a value measured by the sensor. An example of control of the secondary battery using a temperature sensor will be described later.

### [Structure 1 of Positive Electrode Active Material]

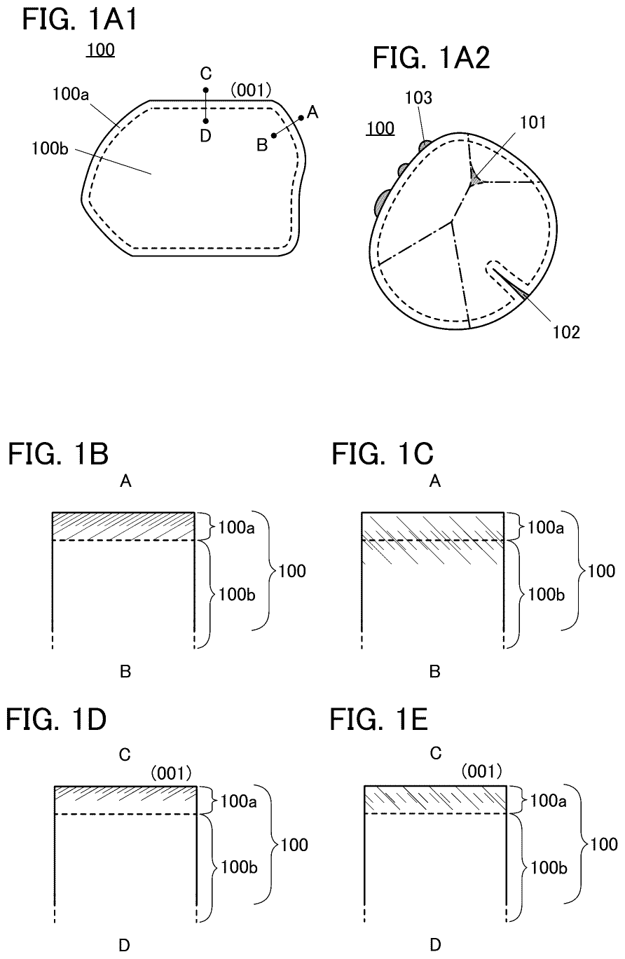

FIG. 1A1 and FIG. 1A2 are cross-sectional views of a positive electrode active material 100 that can be used for the secondary battery of one embodiment of the present invention. FIG. 1B and FIG. 1C show enlarged views of a portion near the line A-B in FIG. 1A1. FIG. 1D and FIG. 1E show enlarged views of a portion near the line C-D in FIG. 1A1.

As illustrated in FIG. 1A1 to FIG. 1E, the positive electrode active material 100 includes a surface portion 100a and an inner portion 100b. In each drawing, the dashed line denotes a boundary between the surface portion 100a and the inner portion 100b. In FIG. 1A2, the dashed-dotted line denotes part of a crystal grain boundary 101.

In this specification and the like, the surface portion 100a of the positive electrode active material 100 refers to, for example, a region that is within 50 nm, preferably within 35 nm, further preferably within 20 nm, and most preferably within 10 nm in depth from the surface toward the inner portion. A plane generated by a fissure and/or a crack can be considered as a surface. A region that is deeper than the surface portion 100a is referred to as the inner portion 100b.

The surface portion 100a preferably has a higher concentration of the additive element X, which is described later, than the inner portion 100b. The additive element preferably has a concentration gradient. In the case where a plurality of kinds of additive elements X are included, the additive elements X preferably exhibit concentration peaks at different depths from a surface depending on the kind.

The concentration of the additive element X in the surface portion 100a is preferably higher than the average concentration of the additive element X in the whole particle.

The concentration of the additive element can be measured by XPS (X-ray photoelectron spectroscopy), ICP-MS (inductively coupled plasma mass spectrometry), STEM-EDX analysis, or the like.

For example, an additive element X1 preferably has a concentration gradient as illustrated in FIG. 1B by gradation, in which the concentration increases from the inner portion 100b toward the surface. As examples of the additive element X1 that preferably has such a concentration gradient, one or more of the above-described additive elements X can be given, and specific examples include magnesium, fluorine, titanium, silicon, phosphorus, boron, and calcium.

An additive element X2, which is different from the additive element X1, preferably has a concentration gradient as illustrated in FIG. 1C by gradation and exhibits a concentration peak, i.e., a local maximum value of concentration, at a deeper region than that illustrated in FIG. 1B. The concentration peak may be located in the surface portion 100a or located deeper than the surface portion 100a. The concentration peak is preferably located in a region other than an outermost surface layer. For example, the peak is preferably located in a region of 5 nm to 30 nm inclusive in depth from the surface toward the inner portion. As examples of the additive element X2 that preferably has such a concentration gradient, one or more of the above-described additive elements X can be given, and specific examples include aluminum.

It is preferable that the crystal structure continuously change from the inner portion 100b toward the surface owing to the above-described concentration gradients of the additive element X1 and the additive element X2.

In order to prevent breakage of a layered structure formed of octahedrons of the transition metal M and oxygen even when lithium is extracted from the positive electrode active material 100 of one embodiment of the present invention owing to charging, the surface portion 100a having high concentrations of the additive element X1 and the additive element X2, i.e., the outer portion of the particle, is reinforced.

Note that the additive element X1 and the additive element X2 do not necessarily have similar concentration gradients throughout the surface portion 100a of the positive electrode active material 100. For example, an example of distribution of the additive element X1 near the line C-D in FIG. 1A1 is illustrated in FIG. 1D and an example of distribution of the additive element X2 near the line C-D is illustrated in FIG. 1E where one of the additive elements is referred to as the additive element X1 and another of the additive elements is referred to as the additive element X2.

Here, the portion near the line C-D has a layered rock-salt crystal structure belonging to R-3m and the surface of the portion has a (001) orientation. The distribution of the additive element at the surface having a (001) orientation may be different from that at other surfaces. For example, at least one of the additive element X1 and the additive element X2 may be distributed shallower from the surface having a (001) orientation and the surface portion 100a thereof than from other surfaces. Alternatively, the surface having a (001) orientation and the surface portion 100a thereof may have a lower concentration of at least one of the additive element X1 and the additive element X2 than other surfaces. Further alternatively, at the surface having a (001) orientation and the surface portion 100a thereof, the concentration of at least one of the additive element X1 and the additive element X2 may be below the lower detection limit.

In a layered rock-salt crystal structure belonging to R-3m, cations are arranged parallel to a (001) plane. In other words, an MO₂ layer formed of octahedrons of the transition metal M and oxygen and a lithium layer are alternately stacked parallel to a (001) plane. Accordingly, a diffusion path of lithium ions also exists parallel to a (001) plane.

Since the MO₂ layer formed of octahedrons of the transition metal M and oxygen is relatively stable, a (001) plane having the MO₂ layer in the surface is relatively stable. A diffusion path of lithium ions is not exposed at a (001) plane.

By contrast, a diffusion path of lithium ions is exposed at a surface having an orientation other than a (001) orientation. Thus, the surface having an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is important to distribute the additive element X1 and the additive element X2 in the plane having an orientation other than a (001) orientation and the surface portion 100a thereof as illustrated in FIG. 1B and FIG. 1C. By contrast, in the (001) plane and the surface portion 100a thereof, the additive element X1 and the additive element X2 may be absent, or the peak positions of the additive element X1 and the additive element X2 may be shallower or the concentrations of the additive element X1 and the additive element X2 may be lower than those in the plane having an orientation other than a (001) orientation and the surface portion 100a thereof, as described above.

In a formation method as described later, in which high-purity LiMO₂ is formed, the additive element X is mixed afterwards, and heating is performed, the additive element X spreads mainly via a diffusion path of lithium ions; thus, distribution of the additive element X in the plane having an orientation other than a (001) orientation and the surface portion 100a thereof can easily fall within a preferred range.

By the formation method in which high-purity LiMO₂ is formed, the additive element X is then mixed, and heating is performed, the additive element X can have a preferable distribution in the plane having an orientation other than a (001) orientation and the surface portion 100a thereof as compared to in a (001) plane. Moreover, in the formation method involving the initial heating, lithium atoms in the surface portion are expected to be extracted from LiMO₂ owing to the initial heating; thus, the additive element X such as magnesium atoms can be probably distributed more easily in the surface portion at a high concentration.

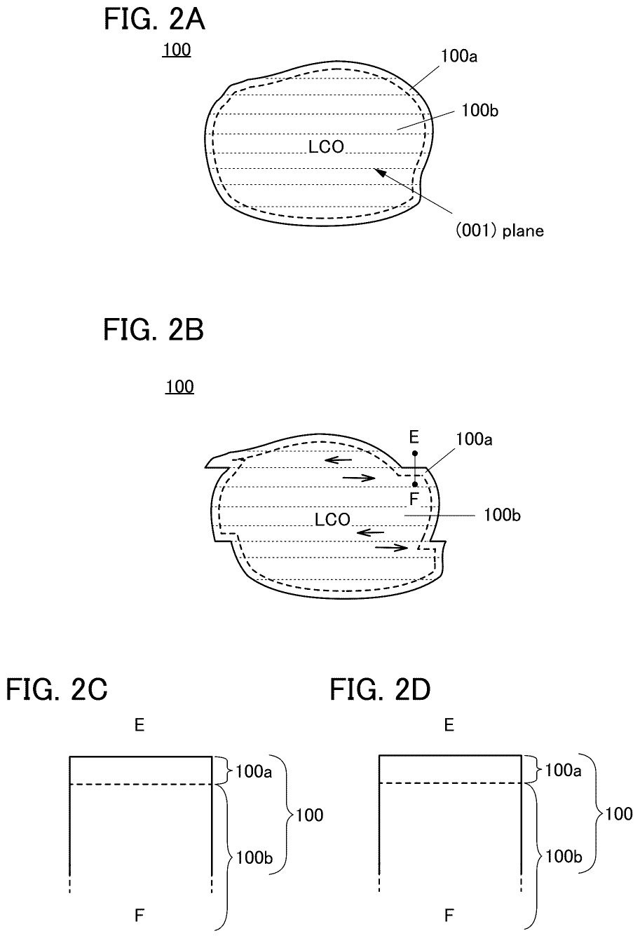

The positive electrode active material 100 preferably has a smooth surface with little unevenness; however, it is not necessary that the whole positive electrode active material 100 be in such a state. In a composite oxide with a layered rock-salt crystal structure belonging to R-3m, slipping easily occurs at a plane parallel to a (001) plane, e.g., a plane where lithium atoms are arranged. In the case where a (001) plane is horizontal as shown in FIG. 2A, steps such as pressing sometimes cause slipping in a horizontal direction as denoted by arrows in FIG. 2B, resulting in deformation.

In this case, at a surface newly formed as a result of slipping and the surface portion 100a thereof, the additive element X does not exist or the concentration of the additive element X is below the lower detection limit in some cases. The line E-F in FIG. 2B denotes examples of the surface newly formed as a result of slipping and its surface portion 100a. FIG. 2C and FIG. 2D show enlarged views of the vicinity of the line E-F. Unlike in FIG. 1B to FIG. 1E, there exists neither gradation of the additive element X1 nor that of the additive element X2 in FIG. 2C and FIG. 2D.

However, since slipping easily occurs parallel to a (001) plane, the newly formed surface and the surface portion 100a thereof have a (001) orientation. Since a diffusion path of lithium ions is not exposed at a (001) plane and a (001) plane is relatively stable, substantially no problem is caused even when the additive element X does not exist or the concentration of the additive element X is below the lower detection limit.

Note that as described above, in a composite oxide whose composition is LiMO₂ and which has a layered rock-salt crystal structure belonging to R-3m, the transition metals M are arranged parallel to a (001) plane. In a HAADF-STEM (High-angle Annular Dark Field Scanning TEM) image, the luminance of the transition metal M, which has the largest atom number in LiMO₂, is the highest. Thus, in a HAADF-STEM image, arrangement of atoms with a high luminance may be regarded as arrangement of the transition metals M. Repetition of such arrangement with a high luminance may be referred to as crystal fringes or lattice fringes. Such crystal fringes or lattice fringes may be deemed to be parallel to a (001) plane in the case of a layered rock-salt crystal structure belonging to R-3m.

The positive electrode active material 100 has a depression, a crack, a concave, a V-shaped cross section, or the like in some cases. These are examples of defects, and when charging and discharging are repeated, dissolution of the transition metal M, breakage of a crystal structure, cracking of the positive electrode active material 100, extraction of oxygen, or the like might be derived from these defects. However, when there is a filling portion 102 that fills such defects, dissolution of the transition metal M or the like can be inhibited. Thus, the positive electrode active material 100 can have high reliability and excellent cycle performance.

The positive electrode active material 100 may include a projection 103, which is a region where the additive element X is unevenly distributed.

An excessive amount of the additive element X in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element X is insufficient, the additive element X is not distributed throughout the surface portion 100a, which might diminish the effect of inhibiting degradation of a crystal structure. The additive element X is thus required to be contained in the positive electrode active material 100 at an appropriate concentration; however, the adjustment of the concentration is not easy.

For this reason, when the positive electrode active material 100 includes the region where the additive element X is unevenly distributed (e.g., the projection 103), part of the excess additive element X is removed from the inner portion 100b of the positive electrode active material 100, so that the concentration of the additive element X can be appropriate in the inner portion 100b. This can inhibit an internal resistance increase, a charge and discharge capacity decrease, and the like when a secondary battery is fabricated. A feature of inhibiting an internal resistance increase in a secondary battery is extremely preferable especially in charging and discharging at a high rate such as charging and discharging at 2 C or more.

Here, a charge rate and a discharge rate will be described. A charge rate of 1 C means a current value with which charging of a battery at a constant current is terminated in exactly 1 hour. A charge rate of 0.2 C means a current value with which charging of a battery at a constant current is terminated in exactly 5 hours, and a charge rate of 2 C means a current value with which charging of a battery at a constant current is terminated in exactly 30 minutes.

In the positive electrode active material 100 including the region where the additive element X is unevenly distributed, addition of the excess additive element X to some extent in the formation process is acceptable. This is preferable because the margin of production can be increased.

In this specification and the like, uneven distribution refers to a state where the concentration of a certain element in a certain region is different from that in other regions, and may be rephrased as segregation, precipitation, unevenness, deviation, a mixture of a high-concentration portion and a low-concentration portion, or the like.

Magnesium, which is an example of the additive element X1, is divalent and is more stable in lithium sites than in transition metal sites in a layered rock-salt crystal structure; thus, magnesium is likely to enter the lithium sites. An appropriate concentration of magnesium in the lithium sites of the surface portion 100a facilitates maintenance of the layered rock-salt crystal structure. Magnesium can inhibit extraction of oxygen around magnesium at the time when the charge depth is deep (x in LiₓCoO₂ is small). Magnesium is also expected to increase the density of the positive electrode active material. An appropriate concentration of magnesium does not have an adverse effect on insertion or extraction of lithium in charging and discharging, and is thus preferable. However, excess magnesium might adversely affect insertion and extraction of lithium. Thus, as will be described later, the concentration of the transition metal M is preferably higher than that of magnesium in the surface portion 100a, for example.

Aluminum, which is an example of the additive element X2, is trivalent and can exist at a transition metal site in a layered rock-salt crystal structure. Aluminum can inhibit dissolution of surrounding cobalt. The bonding strength of aluminum with oxygen is high, thereby inhibiting extraction of oxygen around aluminum. Hence, aluminum contained as the additive element X2 enables the positive electrode active material 100 to have the crystal structure that is unlikely to be broken by repeated charging and discharging.

When fluorine, which is a monovalent anion, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 for a secondary battery is preferable because the charge and discharge characteristics, rate characteristics, and the like are improved.

A titanium oxide is known to have superhydrophilicity. Accordingly, the positive electrode active material 100 including a titanium oxide in the surface portion 100a presumably has good wettability with respect to a high-polarity solvent. Such a positive electrode active material 100 and a high-polarity electrolyte solution can have favorable contact at the interface therebetween and presumably inhibit an internal resistance increase when a secondary battery is formed using such a positive electrode active material 100.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a charge and discharge capacity decrease due to repeated charging and discharging.

A short circuit of a secondary battery might cause not only malfunction in a charge operation and/or a discharge operation of the secondary battery but also heat generation and firing. In order to obtain a safe secondary battery, a short-circuit current is preferably inhibited even at a high charge voltage. In the positive electrode active material 100 of one embodiment of the present invention, a short-circuit current is inhibited even at a high charge voltage. Thus, a secondary battery having high charge and discharge capacity and a high level of safety can be obtained.

The concentration gradient of the additive element X can be evaluated using, for example, energy dispersive X-ray spectroscopy (EDX), EPMA (electron probe microanalysis), or the like. In the EDX measurement, the measurement in which a region is measured while scanning the region and evaluated two-dimensionally is referred to as EDX area analysis. The measurement by line scan, which is performed to evaluate the atomic concentration distribution in a positive electrode active material, is referred to as linear analysis. Furthermore, extracting data of a linear region from EDX area analysis is referred to as linear analysis in some cases. The measurement of a region without scanning is referred to as point analysis.

By EDX area analysis (e.g., element mapping), the concentrations of the additive element X in the surface portion 100a, the inner portion 100b, the vicinity of the crystal grain boundary 101, and the like of the positive electrode active material 100 can be quantitatively analyzed. By EDX linear analysis, the concentration distribution and the highest concentration of the additive element X can be analyzed. An analysis method using a thinned sample, such as STEM-EDX, is preferred because the method makes it possible to analyze the concentration distribution in the depth direction from the surface toward the center in a specific region of a particle regardless of the distribution in the front-back direction.

When the positive electrode active material 100 containing magnesium as the additive element XT is subjected to STEM-EDX linear analysis, a peak of the magnesium concentration in the surface portion 100a is preferably exhibited by a region that is 3 nm in depth, further preferably 1 nm in depth, still further preferably 0.5 nm in depth from the surface toward the center of the positive electrode active material 100.

When the positive electrode active material 100 contains magnesium and fluorine as the additive elements X1, the distribution of fluorine preferably overlaps with the distribution of magnesium. Thus, in the STEM-EDX linear analysis or STEM-EELS (Electron Energy Loss Spectroscopy) linear analysis, a peak of the fluorine concentration in the surface portion 100a is preferably exhibited by a region that is 3 nm in depth, further preferably 1 nm in depth, still further preferably 0.5 nm in depth from the surface toward the center of the positive electrode active material 100. It is further preferable that a peak of the fluorine concentration be exhibited slightly closer to the surface side than a peak of the magnesium concentration is, which increases resistance to hydrofluoric acid. For example, it is preferable that a peak of the fluorine concentration be exhibited closer to the surface side than a peak of the magnesium concentration is by 0.5 nm or more, further preferably 1.5 nm or more.

Note that the concentration distribution may differ between the additive elements X. For example, in the case where the positive electrode active material 100 contains aluminum as the additive element X2, the distribution of aluminum is preferably slightly different from that of magnesium and that of fluorine as described above. For example, in the EDX linear analysis, the peak of the magnesium concentration is preferably closer to the surface than the peak of the aluminum concentration is in the surface portion 100a. For example, the peak of the aluminum concentration is preferably exhibited by a region that is greater than or equal to 0.5 nm and less than or equal to 50 nm in depth, further preferably greater than or equal to 5 nm and less than or equal to 30 nm in depth from the surface toward the center of the positive electrode active material 100. Alternatively, the peak of the aluminum concentration is preferably exhibited by a region that is greater than or equal to 0.5 nm and less than or equal to 30 nm in depth from the surface toward the center of the positive electrode active material 100. Further alternatively, the peak of the aluminum concentration is preferably exhibited by a region that is greater than or equal to 5 nm and less than or equal to 50 nm in depth from the surface toward the center of the positive electrode active material 100.

According to results of the EDX linear analysis, where a surface of the positive electrode active material 100 is can be estimated as follows.

A point where the detected amount of the X-ray of an element that uniformly exists in the inner portion 100b of the positive electrode active material 100, e.g., oxygen or the transition metal M such as cobalt, is ½ of the detected amount thereof in the inner portion 100b is assumed as the surface.

Since the positive electrode active material 100 is a composite oxide, the detected amount of the X-ray of oxygen is preferably used to estimate where the surface is. Specifically, an average value Oₐᵥₑ of the detected amount of the X-ray of oxygen in a region of the inner portion 100b where the detected amount of oxygen is stable is calculated first. At this time, in the case where oxygen O_{background} which is probably led from chemical adsorption or the background is detected in a region that is obviously outside the surface, O_{background} is subtracted from the measurement value to obtain the average value Oₐᵥₑ of the detected amount of the X-ray of oxygen. The measurement point where the measurement value which is closest to ½ of the average value Oₐᵥₑ, or ½Oₐᵥₑ, is obtained can be estimated to be the surface of the positive electrode active material.

Where the surface is can also be estimated with the use of the transition metal M contained in the positive electrode active material 100. For example, in the case where 95% or more of the transition metals M is cobalt, the detected amount of cobalt can be used to estimate where the surface is as in the above description. Alternatively, the sum of the detected amounts of the transition metals M can be used for the estimation in a similar manner. The detected amount of the transition metal M is unlikely to be affected by chemical adsorption and is thus suitable for the estimation of where the surface is.

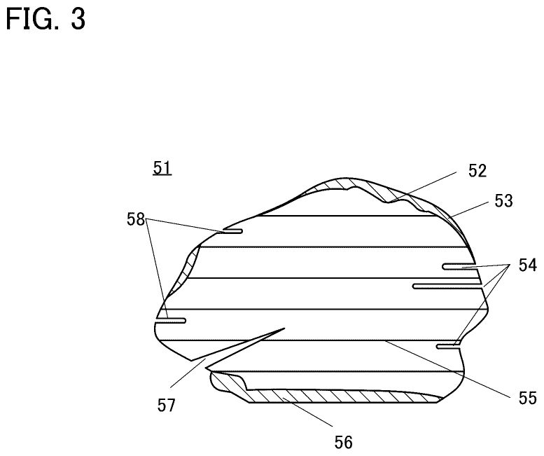

Note that when the positive electrode active material 100 undergoes charging and discharging under conditions with a large charge depth, including charging at 4.5 V or higher (conditions where x in LiₓCoO₂ is small), or in a high-temperature environment (45° C. or higher), a progressive defect (also referred to as a pit) might be generated in the positive electrode active material. In addition, a defect such as a crevice (also referred to as a crack) might be generated by expansion and contraction of the positive electrode active material due to charging and discharging. FIG. 3 shows a schematic cross-sectional view of a positive electrode active material 51. Although pits of the positive electrode active material 51 are illustrated as holes denoted by reference numerals 54 and 58, their opening shapes are not circular but wide groove-like shapes. A source of a pit can be a point defect. Presumably, the crystal structure of LiMO₂ in the vicinity of a portion where a pit is formed is broken and differs from a layered rock-salt crystal structure. The breakage of the crystal structure might inhibit diffusion and release of lithium ions that are carrier ions; thus, a pit is probably a cause of degradation of cycle performance. A crack of the positive electrode active material 51 is denoted by a reference numeral 57. A reference numeral 55 denotes a crystal plane parallel to arrangement of cations, a reference numeral 52 denotes a depression, and reference numerals 53 and 56 denote regions where the additive element X exists.

Typical positive electrode active materials of lithium-ion secondary batteries are LCO (lithium cobalt oxide) and NMC (lithium nickel-manganese-cobalt oxide), which can also be regarded as an alloy containing a plurality of metal elements (cobalt, nickel, and the like). At least one of a plurality of positive electrode active materials has a defect and the defect might change before and after charging and discharging. When used in a secondary battery, a positive electrode active material might undergo a phenomenon such as chemical or electrochemical erosion or degradation of a material due to environmental substances (e.g., electrolyte solution) surrounding the positive electrode active material. This degradation does not occur uniformly in the surface of the positive electrode active material but occurs locally in a concentrated manner, and a defect is formed deeply from the surface toward the inner portion, for example, by repeated charging and discharging of the secondary battery.

Progress of a defect in a positive electrode active material to form a hole can be referred to as pitting corrosion, and the hole generated by this phenomenon is also referred to as a pit in this specification.

In this specification, a crack and a pit are different from each other. Immediately after formation of a positive electrode active material, a crack can exist but a pit does not exist. A pit can also be regarded as a hole formed by extraction of some layers of cobalt and oxygen due to charging and discharging under conditions with a large charge depth (conditions where x in LiₓCoO₂ is small), e.g., conditions where charging is performed at a high voltage of 4.5 V or higher or in a high-temperature environment (45° C. or higher), i.e., a portion from which cobalt has been dissolved. A crack refers to a surface newly generated by application of physical pressure or a crevice generated owing to the crystal grain boundary 101. A crack might be caused by expansion and contraction of a positive electrode active material due to charging and discharging. A pit might be generated from a cavity inside a positive electrode active material and/or a crack.

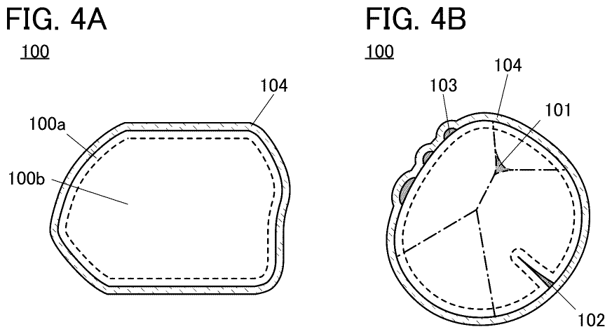

The positive electrode active material 100 may include a coating film in at least part of its surface. FIG. 4A and FIG. 4B show an example of the positive electrode active material 100 including a coating film 104.

The coating film 104 is preferably formed by deposition of a decomposition product of an electrolyte solution due to charging and discharging, for example. A coating film originating from an electrolyte solution, which is formed on the surface of the positive electrode active material 100, is expected to produce an effect of improving charge and discharge cycle performance particularly when charging with a deep charge depth (the state where x in LiₓCoO₂ is small) is repeated. This is because an increase in impedance of the surface of the positive electrode active material is inhibited or dissolution of the transition metal M is inhibited, for example. The coating film 104 preferably contains carbon, oxygen, and fluorine, for example. The coating film can have high quality easily when part of the electrolyte solution contains LiBOB and/or SUN (suberonitrile), for example. Accordingly, the coating film 104 preferably contains at least one of boron, nitrogen, sulfur, and fluorine to possibly have high quality. Note that the coating film 104 does not necessarily cover the entire positive electrode active material 100; when the coating film 104 covers at least part of the positive electrode active material 100, the above effect can be expected in proportion to the covered region.

### [Structure 2 of Positive Electrode Active Material]

### <Conventional Positive Electrode Active Material>

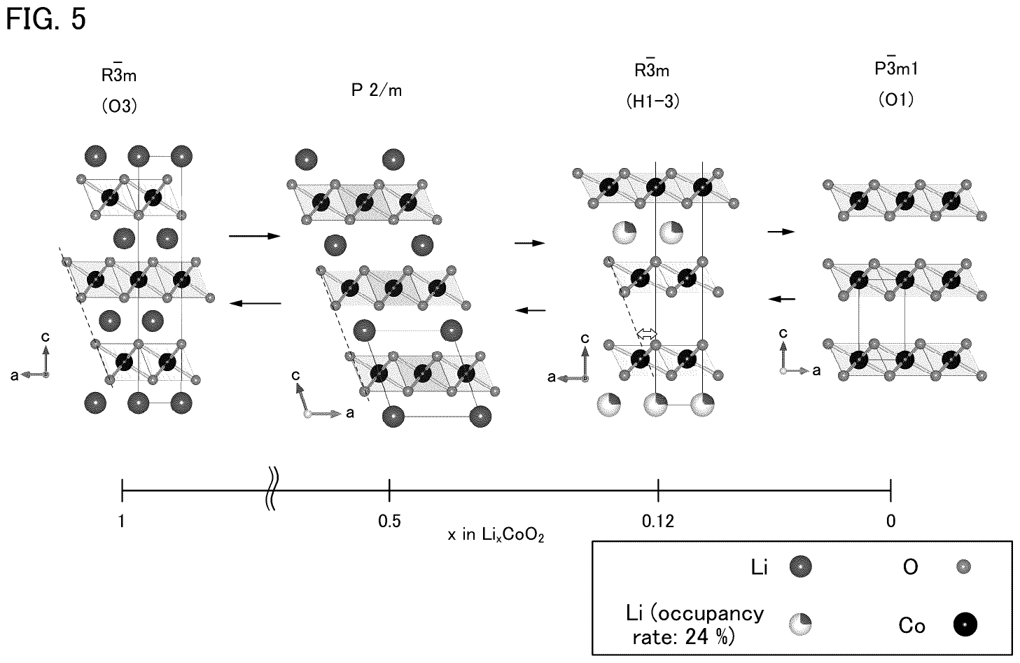

FIG. 5 is a diagram showing crystal structures of lithium cobalt oxide (LiCoO₂) to which fluorine and magnesium are not added in a formation method described later. As described in Non-Patent Document 1, Non-Patent Document 2, and the like, the crystal structure of the lithium cobalt oxide shown in FIG. 5 changes depending on x in LiₓCoO₂.

As shown in FIG. 5, in lithium cobalt oxide with x of 1 (discharged state), there is a region having a crystal structure belonging to the space group R-3m, lithium occupies octahedral sites, and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state.

Lithium cobalt oxide with x of 0 has a crystal structure belonging to the space group P-3m1 and includes one CoO₂ layer in a unit cell. Hence, this crystal structure is referred to as an O1 type crystal structure in some cases.

Lithium cobalt oxide with x of approximately 0.2 has the crystal structure belonging to the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 5, and other drawings, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and 02 (0, 0, 0.11535±0.00045). O1 and 02 are each an oxygen atom. In this manner, the H1-3 type crystal structure is represented by a unit cell including one cobalt atom and two oxygen atoms. Meanwhile, the O3′ type crystal structure of one embodiment of the present invention is preferably represented by a unit cell including one cobalt atom and one oxygen atom, as described later. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material is selected such that the value of GOF (goodness of fit) is smaller in Rietveld analysis of XRD patterns, for example.

When charging at a high voltage of 4.6 V or higher with reference to the redox potential of a lithium metal or charging with a large charge depth with x of 0.2 or less and discharging are repeated, the crystal structure of lithium cobalt oxide changes (i.e., an unbalanced phase change occurs) repeatedly between the H1-3 type crystal structure and the R-3m (O3) structure in a discharged state.

However, there is a large shift in the CoO₂ layers between these two crystal structures. As denoted by the dotted lines and the arrow in FIG. 5, the CoO₂ layer in the H1-3 type crystal structure largely shifts from that in the R-3m (O3) structure. Such a dynamic structural change can adversely affect the stability of the crystal structure.

A difference in volume is also large. The O3 type crystal structure in a discharged state and the H1-3 type crystal structure that contain the same number of cobalt atoms have a difference in volume of 3.0% or more.

In addition, a structure in which CoO₂ layers are arranged continuously, such as P-3m1 (O1), included in the H1-3 type crystal structure is highly likely to be unstable.

Accordingly, when charging that makes x small and discharging are repeated, the crystal structure of lithium cobalt oxide is gradually broken. The broken crystal structure triggers deterioration of the cycle performance. The broken crystal structure has a smaller number of sites where lithium can exist stably and makes it difficult to insert and extract lithium.

### <Positive Electrode Active Material Used for Secondary Battery of One Embodiment of the Present Invention>

In the case where x is less than or equal to 0.2 in the positive electrode active material having a layered rock-salt structure represented by the space group R-3m, an ion of the transition metal M (e.g., cobalt), the additive element X (e.g., magnesium), or the like occupies a site coordinated to six oxygen atoms and the cation arrangement has symmetry similar to that of the spinel structure, in some cases. This structure is referred to as an O3′ type crystal structure (or a pseudo-spinel structure) in this specification and the like. Note that in the O3′ type crystal structure, a light element such as lithium occupies a site coordinated to four oxygen atoms in some cases. Also in that case, the ion arrangement has symmetry similar to that of the spinel structure. The O3′ type crystal structure is a structure that can maintain high stability in spite of extraction of carrier ions.

The O3′ type crystal structure can be regarded as a crystal structure that contains Li between layers randomly but is similar to a CdCl₂ type crystal structure. The crystal structure similar to the CdCl₂ type crystal structure is close to a crystal structure of lithium nickel oxide that is charged until x becomes 0.06 (Li_{0.06}NiO₂).

Anions of a layered rock-salt crystal and anions of a rock-salt crystal form a cubic close-packed structure (face-centered cubic lattice structure). Anions of an O3′ type crystal are presumed to form a cubic close-packed structure. When these crystals are in contact with each other, there is a crystal plane at which orientations of cubic close-packed structures formed of anions are aligned with each other. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, in the layered rock-salt crystal, the O3′ type crystal, and the rock-salt crystal, a state where the orientations of the cubic close-packed structures formed of anions are aligned with each other may be referred to as a state where crystal orientations are substantially aligned with each other.

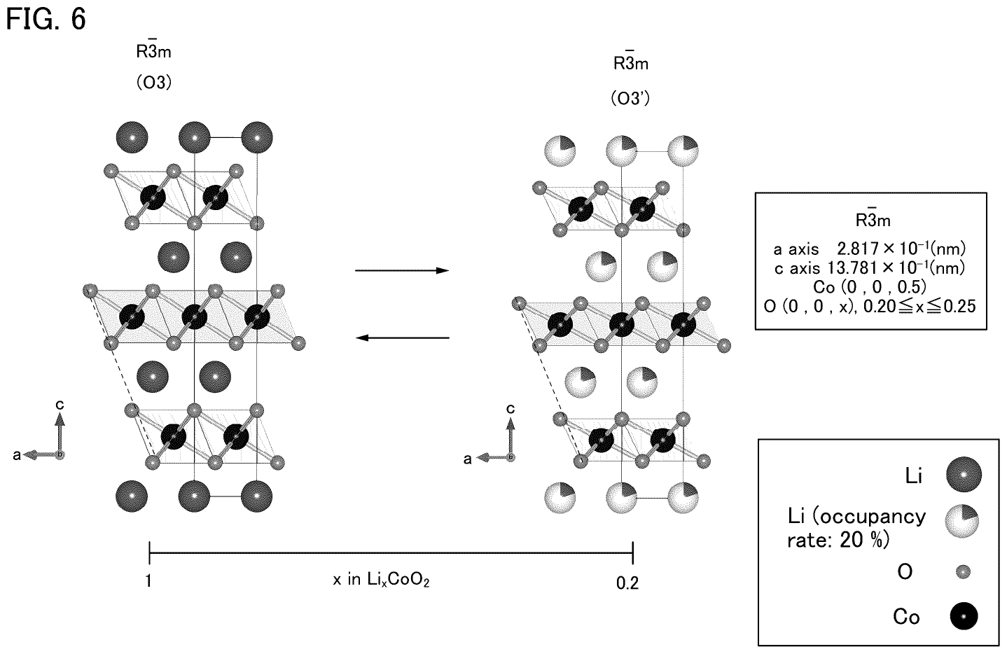

FIG. 6 shows examples of crystal structures of lithium cobalt oxide containing magnesium. The crystal structure with x of 1 (discharged state) in FIG. 6 is R-3m (O3). In addition, the positive electrode active material shown in FIG. 6 in a sufficiently charged state has the O3′ type crystal structure. Although lithium exists in any of lithium sites at an approximately 20% probability in the diagram of the O3′ type crystal structure shown in FIG. 6, the structure is not limited thereto. Lithium may be in only certain parts of the lithium sites. In both the O3 type crystal structure and the O3′ type crystal structure, a slight amount of the additive element X preferably exists between the CoO₂ layers, i.e., in lithium sites. In addition, a slight amount of halogen such as fluorine preferably exists at random in oxygen sites.

In the positive electrode active material shown in FIG. 6, a change in the crystal structure caused by extraction of a large amount of lithium during high-voltage charging is inhibited. As indicated by dotted lines in FIG. 6, for example, CoO₂ layers hardly shift between the crystal structures.

More specifically, the structure of the positive electrode active material of one embodiment of the present invention is highly stable even when a charge voltage is high. For example, the positive electrode active material can maintain the crystal structure belonging to R-3m (O3) at a charge voltage of approximately 4.6 V with reference to the potential of a lithium metal. Even at higher charge voltages, e.g., a voltage of approximately 4.65 V to 4.7 V with reference to the potential of a lithium metal, the positive electrode active material of one embodiment of the present invention can have the O3′ type crystal structure. At a charge voltage increased to be higher than 4.7 V, an H1-3 type crystal may be observed in the positive electrode active material of one embodiment of the present invention. In addition, the positive electrode active material of one embodiment of the present invention can have the O3′ type crystal structure even at a lower charge voltage (e.g., a charge voltage of higher than or equal to 4.5 V and lower than 4.6 V with reference to the potential of a lithium metal) in some cases.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, even in a secondary battery that contains graphite as a negative electrode active material and has a voltage of higher than or equal to 4.3 V and lower than or equal to 4.5 V, for example, the positive electrode active material of one embodiment of the present invention can maintain the crystal structure belonging to R-3m (O3) and moreover, can have the O3′ type crystal structure at higher charge voltages, e.g., at a voltage of the secondary battery of higher than 4.5 V and lower than or equal to 4.6 V. In addition, the positive electrode active material of one embodiment of the present invention can have the O3′ structure at lower charge voltages, e.g., at a voltage of the secondary battery of higher than or equal to 4.2 V and lower than 4.3 V, in some cases.

In the positive electrode active material of one embodiment of the present invention, a difference in the volume per unit cell between the O3 type crystal structure with x of 1 and the O3′ type crystal structure with x of 0.2 is less than or equal to 2.5%, specifically, less than or equal to 2.2%. Note that in the unit cell of the O3′ type crystal structure, the coordinates of cobalt and oxygen can be represented by Co (0, 0, 0.5) and 0 (0, 0, x) within the range of 0.20×0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811, typically c=13.781 (×10⁻¹ nm).

The positive electrode active material whose crystal structure in a charged state is represented by the O3′ type crystal structure has diffraction peaks at 20 of 19.30±0.20° (greater than or equal to 19.10° and less than or equal to 19.50°) and 20 of 45.55±0.10° (greater than or equal to 45.450 and less than or equal to 45.65°) in some cases when the positive electrode active material in the charge state is analyzed by powder X-ray analysis using CuKα1 radiation.

In the layered rock-salt crystal structure of the particle of the positive electrode active material of one embodiment of the present invention in a discharged state or a state where charging and discharging are not performed, the lattice constant of the a-axis is preferably greater than 2.814 (×10⁻¹ nm) and less than 2.817 (×10⁻¹ nm), and the lattice constant of the c-axis is preferably greater than 14.05 (×10⁻¹ nm) and less than 14.07 (×10⁻¹ nm). The state where charging and discharging are not performed may be, for example, the state of a powder before the formation of a positive electrode of a secondary battery.

Alternatively, in the layered rock-salt crystal structure of the positive electrode active material in the discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material in the discharged state or the state where charging and discharging are not performed is subjected to XRD analysis, a first peak is observed at 20 of greater than or equal to 18.50° and less than or equal to 19.30° and a second peak is observed at 20 of greater than or equal to 38.00° and less than or equal to 38.80°, in some cases.

A slight amount of magnesium randomly existing between the CoO₂ layers, i.e., in lithium sites, can suppress a shift in the CoO₂ layers at the time of high voltage charging. Thus, magnesium between the CoO₂ layers makes it easier to obtain the O3′ type crystal structure.

Therefore, magnesium is preferably distributed throughout a particle of the positive electrode active material 100 of one embodiment of the present invention. To distribute magnesium throughout the particle, heat treatment is preferably performed in the formation process of the positive electrode active material 100 of one embodiment of the present invention.

However, heat treatment at an excessively high temperature may cause cation mixing, which increases the possibility of entry of an additive such as magnesium into the cobalt sites. Magnesium in the cobalt sites does not have the effect of maintaining the structure belonging to R-3m at the time when x is small (the charge depth is deep). Furthermore, heat treatment at an excessively high temperature might have an adverse effect; for example, cobalt might be reduced to have a valence of two or lithium might be evaporated.

In view of the above, a fluorine compound is preferably added to lithium cobalt oxide before the heat treatment for distributing magnesium throughout the particle. The addition of the fluorine compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 times and less than 0.04 times, still further preferably approximately 0.02 times the number of atoms of the transition metal M. Alternatively, the number of magnesium atoms is preferably greater than or equal to 0.001 times and less than 0.04 times the number of atoms of the transition metal M. Alternatively, the number of magnesium atoms is preferably greater than or equal to 0.01 times and less than or equal to 0.1 times the number of atoms of the transition metal M. The magnesium concentration described here may be a value obtained by element analysis on the whole particles of the positive electrode active material using ICP-MS or the like, or may be a value based on the ratio of the raw materials mixed in the process of forming the positive electrode active material, for example.

As the magnesium concentration in the positive electrode active material of one embodiment of the present invention increases, the charge and discharge capacity of the positive electrode active material decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel in addition to magnesium, the charge and discharge capacity per weight and per volume can be increased in some cases. When the positive electrode active material of one embodiment of the present invention contains aluminum in addition to magnesium, the charge and discharge capacity per weight and per volume can be increased in some cases. When the positive electrode active material of one embodiment of the present invention contains nickel and aluminum in addition to magnesium, the charge and discharge capacity per weight and per volume can be increased in some cases.

Nickel and aluminum preferably exist in cobalt sites, but part of them may exist in lithium sites. Magnesium preferably exists in lithium sites. Fluorine may be substituted for part of oxygen.

The concentrations of the elements contained in the positive electrode active material of one embodiment of the present invention, such as magnesium, nickel, and aluminum, are described below using the number of atoms.

The number of nickel atoms in the positive electrode active material 100 of one embodiment of the present invention is preferably greater than 0% and less than or equal to 7.5%, further preferably greater than or equal to 0.05% and less than or equal to 4%, still further preferably greater than or equal to 0.1% and less than or equal to 2%, and especially preferably greater than or equal to 0.2% and less than or equal to 1% of the number of cobalt atoms. Alternatively, the number of nickel atoms is preferably greater than 0% and less than or equal to 4% of the number of cobalt atoms. Alternatively, the number of nickel atoms is preferably greater than 0% and less than or equal to 2% of the number of cobalt atoms. Alternatively, the number of nickel atoms is preferably greater than or equal to 0.05% and less than or equal to 7.5% of the number of cobalt atoms. Alternatively, the number of nickel atoms is preferably greater than or equal to 0.05% and less than or equal to 20% of the number of cobalt atoms. Alternatively, the number of nickel atoms is preferably greater than or equal to 0.1% and less than or equal to 7.5% of the number of cobalt atoms. Alternatively, the number of nickel atoms is preferably greater than or equal to 0.1% and less than or equal to 4% of the number of cobalt atoms. The nickel concentration described here may be a value obtained by element analysis on the whole particles of the positive electrode active material using GD-MS, ICP-MS, or the like, or may be a value based on the ratio of the raw materials mixed in the process of forming the positive electrode active material, for example.

When divalent nickel exists in the inner portion 100b, a slight amount of the additive element X having a valence of two and randomly existing in lithium sites, such as magnesium, might be able to exist more stably in the vicinity of the divalent nickel. Thus, even when charging that makes x small (the charge depth deep) and discharging are performed, dissolution of magnesium might be inhibited. Accordingly, charge and discharge cycle performance might be improved. Such a combination of the effect of nickel in the inner portion 100b and the effect of magnesium, aluminum, titanium, fluorine, or the like in the surface portion 100a extremely effectively stabilizes the crystal structure at the time when x is small (the charge depth is deep).

The number of aluminum atoms in the positive electrode active material of one embodiment of the present invention is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% of the number of cobalt atoms. Alternatively, the number of aluminum atoms is preferably greater than or equal to 0.1% and less than or equal to 4% of the number of cobalt atoms. The aluminum concentration described here may be a value obtained by element analysis on the whole particles of the positive electrode active material using GD-MS, ICP-MS, or the like, or may be a value based on the ratio of the raw materials mixed in the process of forming the positive electrode active material, for example.

It is preferable that the positive electrode active material of one embodiment of the present invention further contain phosphorus as the additive element X. The positive electrode active material of one embodiment of the present invention further preferably includes a compound containing phosphorus and oxygen.

When the positive electrode active material of one embodiment of the present invention includes a compound containing phosphorus, a short circuit can be inhibited while a state where x is small (the charge depth is deep) is maintained, in some cases.

When the positive electrode active material of one embodiment of the present invention contains phosphorus, phosphorus may react with hydrogen fluoride generated by the decomposition of the electrolyte solution, which might decrease the hydrogen fluoride concentration in the electrolyte solution.

In the case where the electrolyte solution contains LiPF₆, hydrogen fluoride may be generated by hydrolysis. In some cases, hydrogen fluoride is generated by the reaction of PVDF used as a component of the positive electrode and alkali. The decrease in the hydrogen fluoride concentration in the electrolyte solution can inhibit corrosion of a current collector and/or separation of the coating film 104 in some cases. In addition, a reduction in adhesion properties due to gelling and/or insolubilization of PVDF can be inhibited in some cases.

### <<Surface Portion>>

It is preferable that magnesium be distributed throughout a particle of the positive electrode active material 100 of one embodiment of the present invention, and it is further preferable that the magnesium concentration in the surface portion 100a be higher than the average magnesium concentration in the whole particle. Alternatively, it is preferable that the magnesium concentration in the surface portion 100a be higher than the magnesium concentration in the inner portion 100b.

In the case where the positive electrode active material 100 of one embodiment of the present invention contains the additive element X, for example, one or more metals selected from aluminum, manganese, iron, and chromium, the concentration of the additive element X in the surface portion 100a is preferably higher than the average concentration in the whole particle. Alternatively, the concentration of the metal in the surface portion 100a is preferably higher than that in the inner portion 100b.

The surface portion 100a is in a state where bonds are cut unlike the inner portion 100b whose crystal structure is maintained, and lithium is extracted from the surface during charging; thus, the lithium concentration in the surface portion 100a tends to be lower than that in the inner portion. Therefore, the surface portion 100a tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The fluorine concentration in the surface portion 100a of the positive electrode active material 100 of one embodiment of the present invention is preferably higher than the average concentration in the whole particle. Alternatively, the fluorine concentration in the surface portion 100a is preferably higher than that in the inner portion 100b. When fluorine exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the additive elements X such as magnesium and fluorine are preferably higher than those in the inner portion 100b. The composition preferably has a crystal structure stable at room temperature (25° C.). Accordingly, the surface portion 100a may have a crystal structure different from that of the inner portion 100b. For example, at least part of the surface portion 100a of the positive electrode active material 100 of one embodiment of the present invention may have the rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ type crystal are presumed to form a cubic close-packed structure.

The orientations of crystals in two regions being substantially aligned with each other can be judged, for example, from a TEM (Transmission Electron Microscope) image, a STEM (Scanning Transmission Electron microscope) image, a HAADF-STEM (High-angle Annular Dark Field Scanning TEM) image, an ABF-STEM (Annular Bright-Field Scanning Transmission Electron Microscope) image, an electron diffraction pattern, and an FFT pattern of a TEM image or the like. XRD, neutron diffraction, or the like can also be used for judging.

### <<Grain Boundary>>

It is further preferable that the additive element X contained in the positive electrode active material 100 of one embodiment of the present invention have the above-described distribution and be partly unevenly distributed in the crystal grain boundary 101 and the vicinity thereof.

Specifically, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the magnesium concentration at the crystal grain boundary 101 and the vicinity thereof is, the more effectively the change in the crystal structure can be reduced.

When the magnesium concentration and the fluorine concentration are high at the crystal grain boundary and the vicinity thereof, the magnesium concentration and the fluorine concentration in the vicinity of a surface generated by a crack are also high even when the crack is generated along the crystal grain boundary 101 of the particle of the positive electrode active material 100 of one embodiment of the present invention. Thus, the positive electrode active material including a crack can also have an increased corrosion resistance to hydrofluoric acid.

Note that in this specification and the like, the vicinity of the crystal grain boundary 101 refers to a region of 10 nm from the grain boundary. The crystal grain boundary refers to a plane where atomic arrangement is changed and which can be observed with an electron microscope. Specifically, the crystal grain boundary refers to a portion where the angle formed by repetition of bright lines and dark lines in an electron microscope image exceeds 5° or a portion where a crystal structure cannot be observed in an electron microscope image.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the D50 is preferably greater than or equal to 1 μm and less than or equal to 40 μm. Alternatively, the D50 is preferably greater than or equal to 1 μm and less than or equal to 30 μm. Alternatively, the D50 is preferably greater than or equal to 2 μm and less than or equal to 100 μm. Alternatively, the D50 is preferably greater than or equal to 2 μm and less than or equal to 30 μm. Alternatively, the D50 is preferably greater than or equal to 5 μm and less than or equal to 100 rm. Alternatively, the D50 is preferably greater than or equal to 5 μm and less than or equal to 40 μm.

### <Analysis Method>

Whether or not a positive electrode active material is the positive electrode active material 100 of one embodiment of the present invention, which has the O3′ type crystal structure when x is small (the charge depth is deep), can be judged by analyzing a positive electrode including the positive electrode active material with small x by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example.

As described above, the positive electrode active material 100 of one embodiment of the present invention features in a small change in the crystal structure between a state where x is small (the charge depth is deep) and a discharged state. A material 50% or more of which is occupied by the crystal structure that largely changes between a state where x is small and a discharged state is not preferable because the material cannot withstand charging that makes x small and discharging. It should be noted that the intended crystal structure is not obtained in some cases only by addition of the additive element X. For example, although the positive electrode active material that is lithium cobalt oxide containing magnesium and fluorine is a commonality, the positive electrode active material has the O3′ type crystal structure at 60% or more in some cases, and has the H1-3 type crystal structure at 50% or more in other cases, in the state where x is small. Furthermore, the positive electrode active material has the O3′ type crystal structure at almost 100% at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD and other methods.

However, the crystal structure of a positive electrode active material in a state where x is small (the charge depth is deep) or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<XRD>>

The apparatus and conditions for the XRD measurement are not particularly limited. The measurement can be performed with the apparatus and conditions as described below, for example.
XRD apparatus: D8 ADVANCE produced by Bruker AXS
X-ray source: CuKα radiation
Output: 40 KV, 40 mA
Slit system: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

### <<XPS>>

A region that is approximately 2 nm to 8 nm (normally, less than or equal to 5 nm) from a surface can be analyzed by X-ray photoelectron spectroscopy (XPS). Thus, the concentrations of elements in approximately half the depth of the surface portion 100a can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

When XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms.

In the XPS analysis, monochromatic aluminum Kα can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 μmϕ
Detection depth: approximately 4 to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably at approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the additive elements X that preferably exist in the surface portion 100a in a large amount, such as magnesium and aluminum, measured by XPS or the like are preferably higher than the concentrations measured by ICP-MS (inductively coupled plasma mass spectrometry), GD-MS (glow discharge mass spectrometry), or the like.

### <<EDX>>

One or more selected from the additive elements X contained in the positive electrode active material 100 preferably have a concentration gradient. It is further preferable that the additive elements X in the positive electrode active material 100 exhibit concentration peaks at different depths from a surface depending on the kind. The concentration gradient of the additive element X can be evaluated, for example, by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, the measurement in which a region is measured while scanning the region and evaluated two-dimensionally is referred to as EDX area analysis. The measurement by line scan, which is performed to evaluate the atomic concentration distribution in a positive electrode active material, is referred to as linear analysis. Furthermore, extracting data of a linear region from EDX area analysis is referred to as linear analysis in some cases. The measurement of a region without scanning is referred to as point analysis.

By EDX area analysis (e.g., element mapping), the concentrations of the additive element X in the surface portion 100a, the inner portion 100b, the vicinity of the crystal grain boundary 101, and the like of the positive electrode active material 100 can be semi-quantitatively analyzed. By EDX linear analysis, the concentration distribution and the highest concentration of the additive element X can be analyzed. An analysis method using a thinned sample, such as STEM-EDX, is preferred because the method makes it possible to analyze the concentration distribution in the depth direction from the surface toward the center in a specific region of a positive electrode active material regardless of the distribution in the front-back direction.

Thus, EDX area analysis or EDX point analysis of the positive electrode active material 100 of one embodiment of the present invention preferably reveals that the concentration of each additive element X, in particular, the additive element X in the surface portion 100a is higher than that in the inner portion 100b.

When a cross section is exposed by processing and analyzed by STEM-EDX, the concentrations of magnesium and aluminum in the surface portion 100a are preferably higher than those in the inner portion 100b in the positive electrode active material 100. For example, in the STEM-EDX analysis, the magnesium concentration preferably attenuates, at a depth of 1 nm from a point where the concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. An FIB (Focused Ion Beam) can be used for the processing, for example.

By contrast, it is preferable that nickel, which is one of the transition metals M, not be unevenly distributed in the surface portion 100a but be distributed in the entire positive electrode active material 100. Note that one embodiment of the present invention is not limited thereto in the case where the above-described region where the additive element X is unevenly distributed exists.

### <<ESR>>

As described above, the positive electrode active material of one embodiment of the present invention preferably contains cobalt and nickel as the transition metal M and magnesium as the additive element X. It is preferable that Ni³⁺ be substituted for part of Co³⁺ and Mg²⁺ be substituted for part of Li⁺ accordingly. Accompanying the substitution of Mg²⁺ for Li⁺, the Ni³⁺ might be reduced to be Ni²⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably higher than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by electron spin resonance (ESR), for example.

### <<EPMA>>

Elements can be quantified by EPMA (electron probe microanalysis). In area analysis, distribution of each element can be analyzed.

In EPMA, a region from a surface to a depth of approximately 1 μm is analyzed. Thus, the concentration of each element is sometimes different from measurement results obtained by other analysis methods. For example, when area analysis is performed on the positive electrode active material 100, the concentration of the additive element X existing in the surface portion might be lower than the concentration obtained in XPS. The concentration of the additive element X existing in the surface portion might be higher than the concentration obtained in ICP-MS or a value based on the ratio of the raw materials mixed in the process of forming the positive electrode active material.

EPMA area analysis of a cross section of the positive electrode active material 100 of one embodiment of the present invention preferably reveals a concentration gradient in which the concentration of the additive element X increases from the inner portion toward the surface portion. Specifically, each of magnesium, fluorine, titanium, and silicon preferably has a concentration gradient in which the concentration increases from the inner portion toward the surface as illustrated in FIG. 1B or FIG. 1D. The concentration of aluminum preferably has a peak in a region deeper than the region where the concentration of any of the above elements has a peak, that is, in an inner region, as illustrated in FIG. 1C or FIG. 1E. The aluminum concentration peak may be located in the surface portion or located deeper than the surface portion.

Note that the surface and the surface portion of the positive electrode active material of one embodiment of the present invention do not contain a carbonate, a hydroxy group, or the like which is chemisorbed after formation of the positive electrode active material. Furthermore, an electrolyte solution, a binder, a conductive material, and a compound originating from any of these that are attached to the surface of the positive electrode active material are not contained either. Thus, when the additive elements X contained in the positive electrode active material are quantified, correction may be performed to exclude carbon, hydrogen, excess oxygen, excess fluorine, and the like that might be detected in area analysis such as XPS and EPMA. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element X is not easily dissolved even in that case; thus, the atomic ratio of the additive element X is not affected

### <<Surface Roughness and Specific Surface Area>>

The positive electrode active material 100 of one embodiment of the present invention preferably has a smooth surface with little unevenness. A smooth surface with little unevenness indicates favorable distribution of the additive element X in the surface portion 100a.

A smooth surface with little unevenness can be recognized from, for example, a cross-sectional SEM image or a cross-sectional TEM image of the positive electrode active material 100 or the specific surface area of the positive electrode active material 100.

### [Method 1 for Forming Positive Electrode Active Material]

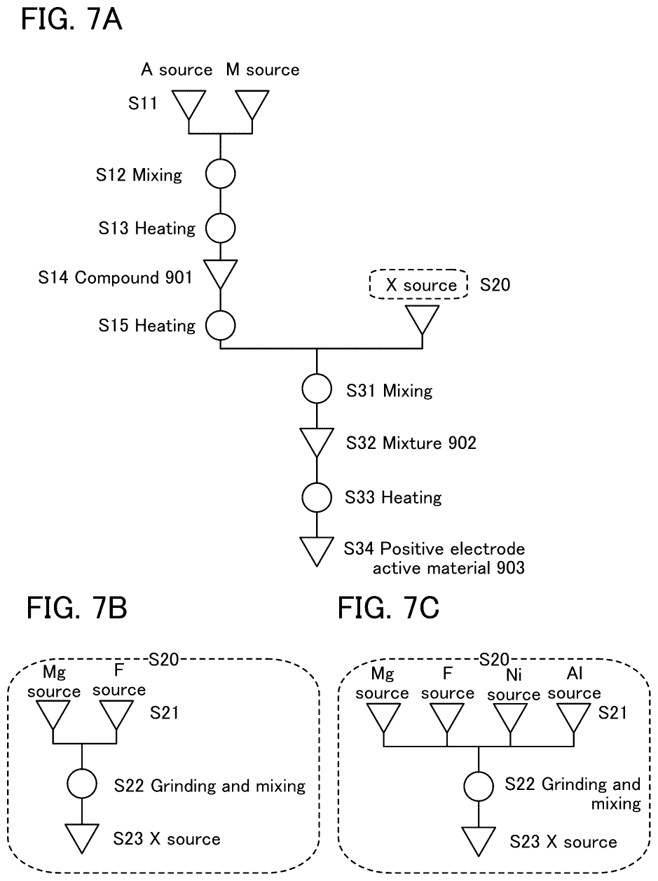

An example of a method for forming a compound containing the element A, the transition metal M, and the additive element X, which is a positive electrode active material of one embodiment of the present invention, will be described below. A formation method example will be described with reference to flowcharts shown in FIG. 7A to FIG. 7C.

In Step S11 in FIG. 7A, a material of the element A and a material of the transition metal Mare prepared.

As an element A source (A source in FIG. 7A), an oxide, a carbonate compound, a halogen compound, or the like containing the element A can be used. When the element A is lithium, lithium carbonate, lithium fluoride, or the like can be used.

As a transition metal M source (M source in FIG. 7A), a compound or the like containing the transition metal M can be used. In the case where the positive electrode active material is an oxide, for example, an oxide, a hydroxide, or the like can be used as the M source. As a cobalt source, cobalt oxide, cobalt hydroxide, or the like can be used.

Next, the element A source and the transition metal M source are mixed. Grinding may be performed in addition to mixing. The grinding and mixing can be performed by a dry method or a wet method.

Next, in Step S13, the materials mixed in the above step are heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the transition metal source. An excessively high temperature might lead to a defect due to evaporation of lithium from the lithium source and/or excessive reduction of the metal used as the transition metal source, for example. The defect is, for example, an oxygen defect which could be induced by a change of trivalent cobalt into divalent cobalt due to excessive reduction, in the case where cobalt is used as the transition metal.

The heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, a method may be employed in which the pressure in the reaction chamber is reduced, the reaction chamber is filled (which may also be referred to as purged) with oxygen, and after that, the exit of the atmosphere from the reaction chamber and the entry of the outside atmosphere are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A sagger (which may be referred to as a container or a crucible) used at the time of the heating is preferably made of aluminum oxide. An aluminum oxide sagger is made of a material that hardly releases impurities. In this embodiment, a sagger made of aluminum oxide with a purity of 99.9% is used. The heating is preferably performed with the sagger covered with a lid. Volatilization of the materials can be prevented.

The heated material is ground as needed and may be made to pass through a sieve. Before collection of the heated material, the material may be moved from the crucible to a mortar. As the mortar, an aluminum oxide mortar can be suitably used. An aluminum oxide mortar is made of a material that hardly releases impurities. Specifically, a mortar made of aluminum oxide with a purity of higher than or equal to 90%, preferably higher than or equal to 99% is used. Note that heating conditions equivalent to those in Step S13 can be employed in a later-described heating step other than Step S13.

Through the above steps, a compound 901 containing the element A and the transition metal M can be formed (Step S14).

Here, a lithium composite oxide represented by a compositional formula LiMO₂ can be obtained, in which lithium is used as the element A, an oxide or a hydroxide of the transition metal M is used as the transition metal M source, and the ratio of the lithium source to the transition metal M source is 1:1. The composite oxide needs to have a crystal structure of a lithium composite oxide represented by LiMO₂ here, but the composition is not strictly limited to Li:M:O=1:1:2.

Next, in Step S15, the compound 901 obtained in Step S14 is heated. The heating in Step S15 is the first heating performed on the compound 901 and thus, this heating is sometimes referred to as the initial heating. Through the initial heating, the surface of the compound 901 becomes smooth. A smooth surface refers to a state where the positive electrode active material has little unevenness and is rounded as a whole and its corner portion is rounded. A smooth surface also refers to a surface to which few foreign matters are attached. Foreign matters are deemed to cause unevenness and are preferably not attached to a surface.

The initial heating is heating performed after the compound 901 is obtained, and the initial heating for making the surface smooth can reduce degradation after charging and discharging in some cases. The initial heating for making the surface smooth does not need a lithium compound source. Alternatively, the initial heating for making the surface smooth does not need an additive element X source. Alternatively, the initial heating for making the surface smooth does not need a flux agent. The initial heating is performed before Step S31 and is sometimes referred to as preheating or pretreatment.

At least one of the lithium source and the transition metal source prepared in Step S11 and the like might contain impurities. The initial heating can reduce impurities in the compound 901 obtained in Step 14.

The heating conditions in this step can be freely set as long as the heating makes the surface of the compound 901 smooth. For example, the heating can be performed under any of the heating conditions selected from those described for Step S13. Additionally, the heating temperature in this step is preferably lower than that in Step S13 so that the crystal structure of the compound 901 is maintained. The heating time in this step is preferably shorter than that in Step S13 so that the crystal structure of the compound 901 is maintained. For example, the heating is preferably performed at a temperature of higher than or equal to 700° C. and lower than or equal to 1000° C., further preferably higher than or equal to 800° C. and lower than or equal to 900° C. for longer than or equal to 2 hours.

The heating in Step S13 might cause a temperature difference between the surface and an inner portion of the compound 901. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the compound 901. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the compound 901 is relieved. This is probably why the surface of the compound 901 becomes smooth through Step S15. This is also rephrased as modification of the surface. In other words, it is deemed that Step S15 reduces the differential shrinkage caused in the compound 901 to make the surface of the compound 901 smooth.

Such differential shrinkage might cause a micro shift in the compound 901 such as a shift in a crystal. To reduce the shift, this step is preferably performed. Performing this step can distribute a shift uniformly in the compound 901. When the shift is distributed uniformly, the surface of the compound 901 might become smooth. This is also referred to as alignment of crystal grains. In other words, it is deemed that Step S15 reduces the shift in a crystal or the like which is caused in the compound 901 to make the surface of the compound 901 smooth.

In a secondary battery including the compound 901 with a smooth surface as a positive electrode active material, degradation by charging and discharging is suppressed and cracking in the positive electrode active material can be prevented.

It can be said that when surface unevenness information in one cross section of the compound 901 is quantified with measurement data, a smooth surface of the compound 901 has at least a surface roughness of less than or equal to 10 nm. The one cross section is, for example, a cross section obtained in observation using a scanning transmission electron microscope (STEM).

Note that a pre-synthesized compound 901 containing lithium, a transition metal, and oxygen may be used in Step S14. In this case, Step S11 to Step S13 can be skipped. When Step S15 is performed on the pre-synthesized compound 901, the compound 901 with a smooth surface can be obtained.

The initial heating might decrease lithium in the compound 901. The additive element X described for Step S20 or the like below can easily enter the compound 901 owing to the decrease in lithium.

Next, in Step S20, the additive element X source is prepared. As the additive element X source (X source in FIG. 7A), a compound containing the additive element X can be used. Here, in the case where a plurality of elements are used as the additive element X, compounds containing the elements may be prepared. Alternatively, one compound containing the plurality of elements can be used. Note that when a halogen compound is used as the additive element X source, a positive electrode active material containing halogen can be obtained, for example.

As shown in FIG. 7B and FIG. 7C, the additive element X source may be ground. In the case where a plurality of compounds are used as the additive element X source, mixing is preferably performed.

Step S20 shown in FIG. 7B includes Step S21 to Step S23. In Step S21, the additive element X is prepared. As the additive element X, the additive element X described in the above embodiment can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or more selected from bromine and beryllium can be used. FIG. 7B shows an example of the case where a magnesium source and a fluorine source are prepared. Note that in Step S21, a lithium source may be separately prepared in addition to the additive element X.

When magnesium is selected as the additive element X, the additive element X source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element X, the additive element X source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at a molar ratio of approximately LiF:MgF₂=65:35, the effect of lowering the melting point is maximized. Meanwhile, when the proportion of lithium fluoride increases, the cycle performance might deteriorate because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that in this specification and the like, the expression “an approximate value of a given value” means greater than 0.9 times and less than 1.1 times the given value, unless otherwise specified.

Next, in Step S22 shown in FIG. 7B, the magnesium source and the fluorine source are ground and mixed. Any of the conditions for the grinding and mixing that are described for Step S12 can be selected to perform this step.

Here, a heating step may be performed after Step S22 as needed. For the heating step, any of the heating conditions described for Step S13 can be selected. The heating time is preferably longer than or equal to 2 hours and the heating temperature is preferably higher than or equal to 800° C. and lower than or equal to 1100° C.

Next, in Step S23 shown in FIG. 7B, the materials ground and mixed in the above step are collected to give the additive element X source (X source). Note that the additive element X source in Step S23 contains a plurality of starting materials and can be referred to as a mixture.

As for the particle diameter of the mixture, the D50 (median diameter) is preferably greater than or equal to 600 nm and less than or equal to 20 μm, further preferably greater than or equal to 1 μm and less than or equal to 10 μm. Also when one kind of material is used as the additive element X source, the D50 (median diameter) is preferably greater than or equal to 600 nm and less than or equal to 20 μm, further preferably greater than or equal to 1 μm and less than or equal to 10 μm.

Such a pulverized mixture (which may contain only one kind of the additive element X) is easily attached to the surface of lithium cobalt oxide uniformly in a later step of mixing with the lithium cobalt oxide. The mixture is preferably attached uniformly to the surface of the lithium cobalt oxide, in which case the additive element X is easily distributed or dispersed uniformly in the surface portion 100a of the composite oxide after heating.

A process different from that in FIG. 7B is described with reference to FIG. 7C. Step S20 shown in FIG. 7C includes Step S21 to Step S23.

In Step S21 shown in FIG. 7C, four kinds of additive element X sources to be added to the lithium cobalt oxide are prepared. That is, FIG. 7C is different from FIG. 7B in the kinds of the additive element X sources. A lithium source may be separately prepared in addition to the additive element X sources.

As the four kinds of the additive element X sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 7B. As the nickel source, nickel oxide, nickel hydroxide, or the like can be used. As the aluminum source, aluminum oxide, aluminum hydroxide, or the like can be used.

Next, Step S22 and Step S23 shown in FIG. 7C are similar to the steps described with reference to FIG. 7B.

Next, in Step S31 shown in FIG. 7A, the compound 901 and the additive element X source (X source) are mixed. The atomic ratio of cobalt Co in the compound 901 to magnesium Mg contained in the additive element X source is preferably Co:Mg=100:y (0.1≤y≤6), further preferably M:Mg=100:y (0.3≤y≤3).

The mixing in Step S31 is preferably performed under milder conditions than the mixing in Step S12, in order not to damage the shape of the compound 901. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

Next, the compound 901 obtained in Step S14 and the additive element X source are mixed in Step S31.

Next, the materials mixed in the above step are collected, whereby a mixture 902 is obtained in Step S32.

Next, in Step S33, the mixture 902 is heated. Any of the heating conditions described for Step S13 can be selected. The heating time is preferably longer than or equal to 2 hours. The heating temperature in Step S33 is preferably lower than the heating temperature in Step S13 in some cases.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature in Step S33 is preferably higher than or equal to 742° C. and lower than 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 800° C. and lower than or equal to 1100° C., further preferably higher than or equal to 830° C. and lower than 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C.

A supplementary explanation of the heating time is provided. The heating time depends on conditions such as the heating temperature and the particle size and composition of LiMO₂ in Step S14. The heating may be preferably performed at a lower temperature or for a shorter time in the case where the particle size is small than in the case where the particle size is large.

In the case where the composite oxide (LiMO₂) in Step S14 in FIG. 7A has a median diameter (D50) of approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the time for lowering the temperature after the heating is preferably longer than or equal to 10 hours and shorter than or equal to 50 hours, for example.

In the case where the composite oxide (LiMO₂) in Step S14 has a median diameter (D50) of approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the time for lowering the temperature after the heating is preferably longer than or equal to 10 hours and shorter than or equal to 50 hours, for example.

Next, the heated material is collected, and a positive electrode active material 903 is obtained (Step S34).

### [Method 2 for Forming Positive Electrode Active Material]

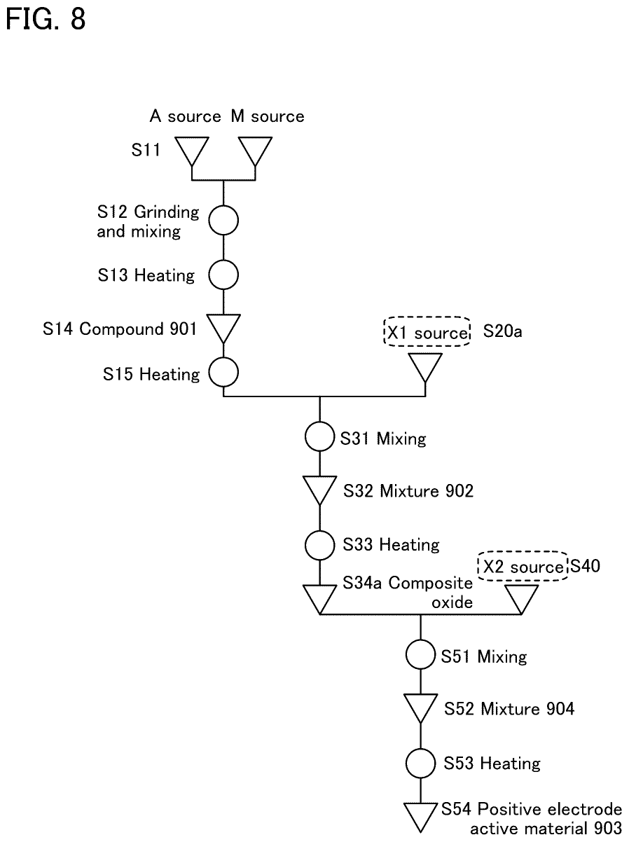

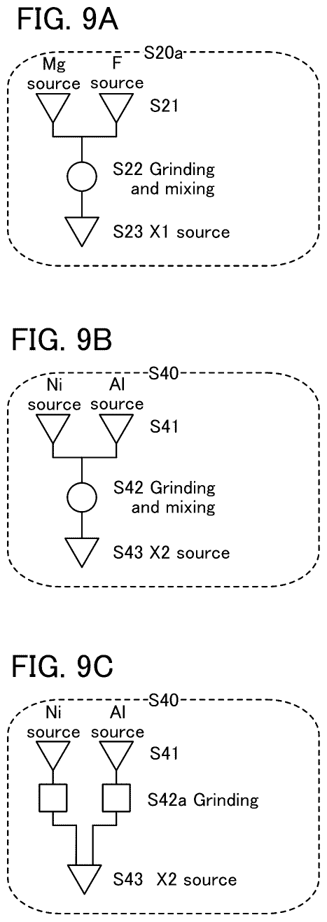

Another example of a method for forming the positive electrode active material that can be used as one embodiment of the present invention (Example 2 of method for forming positive electrode active material) will be described with reference to FIG. 8 to FIG. 9. Although Example 2 of method for forming positive electrode active material is different from Example 1 of method for forming positive electrode active material described above in the number of times of adding the additive element X and a mixing method, for the description except for the above, the description of Example 1 of method for forming positive electrode active material can be referred to.

Steps S11 to S15 in FIG. 8 are performed as in FIG. 7A to prepare the compound 901.

Next, as shown in Step S20a, the additive element X1 is added to the compound 901. Step S20a is described with reference to FIG. 9A.

In Step S21 shown in FIG. 9A, a first additive element X1 source (X1 source) is prepared. The X1 source can be selected from the additive elements X described for Step S21 shown in FIG. 7B. For example, one or more selected from magnesium, fluorine, and calcium can be used as the additive element X1. FIG. 9A shows an example of the case where a magnesium source (Mg source) and a fluorine source (F source) are used as the additive element X1.

Step S21 to Step S23 shown in FIG. 9A can be performed under the same conditions as those in Step S21 to Step S23 shown in FIG. 7B. As a result, the additive element X1 source (X1 source) can be obtained in Step S23.

Steps S31 to S33 shown in FIG. 8 can be performed under the same conditions as those in Steps S31 to S33 shown in FIG. 7A.

Next, the material heated in Step S33 is collected to obtain lithium cobalt oxide containing the additive element X1. Here, this composite oxide is called a second composite oxide to be distinguished from the compound (a first composite oxide) in Step S14.

In Step S40 shown in FIG. 8, a second additive element X2 source is added. Step S40 is described with reference to FIG. 9B and FIG. 9C.

In Step S41 shown in FIG. 9B, the second additive element X2 source (X2 source) is prepared. The X2 source can be selected from the additive elements X described for Step S21 shown in FIG. 7B. For example, one or more selected from nickel, titanium, boron, zirconium, and aluminum can be suitably used as the additive element X2. FIG. 9B shows an example of the case where nickel and aluminum are used as the additive element X2.

Step S41 to Step S43 shown in FIG. 9B can be performed under the same conditions as those in Step S21 to Step S23 shown in FIG. 7B. As a result, the additive element X2 source (X2 source) can be obtained in Step S43.

FIG. 9C showing Step S41 to Step S43 is a variation example of FIG. 9B. A nickel source (Ni source) and an aluminum source (Al source) are prepared in Step S41 shown in FIG. 9C and are separately ground in Step S42a. As a result, a plurality of the second additive element X2 sources (X2 sources) are prepared in Step S43. FIG. 9C is different from FIG. 9B in separately grinding the additive elements X2 in Step S42a.

Next, Step S51 to Step S53 shown in FIG. 8 can be performed under the same conditions as those in Step S31 to Step S34 shown in FIG. 7A. The heating in Step S53 can be performed at a lower temperature and for a shorter time than the heating in Step S33.

Next, in Step S54 shown in FIG. 8, the heated material is collected and then crushed as needed to obtain the positive electrode active material 903. Through the above steps, the positive electrode active material 903 having the features described in this embodiment can be formed.

As shown in FIG. 8 and FIG. 9, in the formation method 2, introduction of the additive element X to the lithium cobalt oxide is divided into introduction of the first additive element X1 and that of the second additive element X2. When the additive elements are separately introduced, the additive elements X can have different profiles in the depth direction. For example, the first additive element X1 can have a profile such that the concentration is higher in the surface portion than in the inner portion, and the second additive element X2 can have a profile such that the concentration is higher in the inner portion than in the surface portion.

### [Positive Electrode Active Material 2]

The positive electrode active material of one embodiment of the present invention is not limited to the materials described above. A mixture of the above-described material and another material may be used as the positive electrode active material of one embodiment of the present invention.

As the positive electrode active material, a composite oxide with a spinel crystal structure can be used, for example. Alternatively, a polyanionic material can be used as the positive electrode active material, for example. Examples of the polyanionic material include a material with an olivine crystal structure and a material with a NASICON structure. Alternatively, a material containing sulfur can be used as the positive electrode active material, for example.

As the material with a spinel crystal structure, for example, a composite oxide represented by LiM₂O₄ can be used. It is preferable to contain Mn as the transition metal M. For example, LiMn₂O₄ can be used. It is preferable to contain Ni in addition to Mn as the transition metal M because the discharge voltage and the energy density of the secondary battery are increased in some cases. It is preferable to add a small amount of lithium nickel oxide (LiNiO₂ or LiNi₁₋ₓMₓO₂ (M=Co, Al, or the like)) to a lithium-containing material with a spinel crystal structure which contains manganese, such as LiMn₂O₄, because the performance of the secondary battery can be improved.

As a polyanionic material, for example, a composite oxide containing oxygen, the element A, the transition metal M, and an element Y can be used. The element A is one or more of Li, Na, and Mg; the transition metal M is one or more of Fe, Mn, Co, Ni, Ti, V, and Nb; and the element Y is one or more of S, P, Mo, W, As, and Si.

As the material with an olivine crystal structure, for example, a composite material (the general formula LiMPO₄ (M is one or more of Fe(II), Mn(II), Co(II), and Ni(II)) can be used. Typical examples of the general formula LiMPO₄ include lithium compounds such as LiFePO₄, LiNiPO₄, LiCoPO₄, LiMnPO₄, LiFeₐNibPO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}COₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

Alternatively, a composite material such as a general formula Li₍₂₋ⱼ₎SiO₄ (M is one or more of Fe(II), Mn(II), Co(II), and Ni(II); 0 j 2) can be used. Typical examples of the general formula Li₍₂₋ⱼ₎MSiO₄ include lithium compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≤1, 0<k<1, and 0<l<1), Li₍₂₋ⱼ₎FeₘNiₙCo_{q}SiO₄, Li₍₂₋ⱼ₎FeₘNiₙMn_{g}SiO₄, Li₍₂₋ⱼ₎NiₘCoₙMn_{q}SiO₄ (m+n+q 1, 0<m<1, 0<n<1, and 0<q<1), and Li₍₂₋ⱼ₎FeᵣNiₛCoₜMnᵤSiO₄ (r+s+t+u 1, 0<r<1, 0<s<1, 0<t<1, and 0<u<1).

Still alternatively, a NASICON compound represented by a general formula AM₂(XO₄)₃ (A=Li, Na, or Mg, M=Fe, Mn, Ti, V, or Nb, X=S, P, Mo, W, As, or Si) can be used. Examples of the NASICON compound include Fe₂(MnO₄)₃, Fe₂(SO₄)₃, and Li₃Fe₂(PO₄)₃. Further alternatively, a compound represented by a general formula Li₂MPO₄F, Li₂MP₂O₇, or Li₅MO₄ (M=Fe or Mn) can be used as the positive electrode active material.

Further alternatively, a perovskite fluoride such as NaFeF₃ and FeF₃, a metal chalcogenide (a sulfide, a selenide, or a telluride) such as TiS₂ and MoS₂, an oxide with an inverse spinel crystal structure such as LiMVO₄, a vanadium oxide (V₂O₅, V₆O₁₃, LiV₃O₈, or the like), a manganese oxide, an organic sulfur compound, or the like may be used as the positive electrode active material.

Alternatively, a borate-based material represented by a general formula LiMBO₃ (M is Fe(II), Mn(II), or Co(II)) may be used as the positive electrode active material.

As a material containing sodium, for example, an oxide containing sodium such as NaFeO₂, Na_{2/3}[Fe_{1/2}Mn_{1/2}]O₂, Na_{2/3}[Ni_{1/3}Mn_{2/3}]O₂, Na₂Fe₂(SO₄)₃, Na₃V₂(PO₄)₃, Na₂FePO₄F, NaVPO₄F, NaMPO₄ (M is Fe(II), Mn(II), Co(II), or Ni(II)), Na₂FePO₄F, or Na₄Co₃(PO₄)₂P₂O₇ may be used as the positive electrode active material.

As the positive electrode active material, a lithium-containing metal sulfide may be used. Examples of the lithium-containing metal sulfide include Li₂TiS₃ and Li₃NbS₄.

### [Electrolyte]

The secondary battery of one embodiment of the present invention preferably includes an electrolyte solution. The electrolyte solution included in the secondary battery of one embodiment of the present invention preferably contains an ionic liquid and a salt containing a metal serving as a carrier ion.

In the case where the metal serving as a carrier ion is lithium, as the salt containing the metal serving as a carrier ion, one of lithium salts such as LiN(FSO₂)₂, LiN(CF₃SO₂)₂, LiN(C₄F₉SO₂) (CF₃SO₂), LiN(C₂F₅SO₂)₂, LiC(FSO₂)₃, LiC(CF₃SO₂)₃, LiC(C₂F₅SO₂)₃, LiCF₃SO₃, LiC₄F₉SO₃, LiAsF₆, LiBF₄, LiAlCl₄, LiSCN, LiBr, LiI, Li₂SO₄, Li₂B₁₀Cl₁₀, Li₂B₁₂Cl₁₂, LiPF₆, and LiClO₄ can be used, or two or more of them can be used in an appropriate combination in an appropriate ratio.

In particular, a metal salt of a fluorosulfonate anion and a metal salt of a fluoroalkylsulfonate anion are preferable: among them, a metal salt of an amide-based anion represented by (CₙF₂ₙ₊₁SO₂)₂N⁻ (n is greater than or equal to 0 and less than or equal to 3) is preferable because of its high stability at high temperatures and high resistance to oxidation and reduction.

An ionic liquid contains a cation and an anion, specifically, an organic cation and an anion. Examples of the organic cation used for the electrolyte solution include aromatic cations such as an imidazolium cation and a pyridinium cation, and aliphatic onium cations such as a quaternary ammonium cation, a tertiary sulfonium cation, and a quaternary phosphonium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The electrolyte solution may contain, in addition to an ionic liquid, an aprotic solvent. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone may be contained, or two or more of these solvents may be contained in an appropriate combination in an appropriate ratio.

Furthermore, an additive such as vinylene carbonate (VC); propane sultone (PS); tert-butylbenzene (TBB); fluoroethylene carbonate (FEC); lithium bis(oxalate)borate (LiBOB); a dinitrile compound such as succinonitrile or adiponitrile; fluorobenzene; cyclohexylbenzene; or biphenyl may be added to the electrolyte solution. The concentration of the material to be added in the whole solvent is, for example, higher than or equal to 0.1 wt % and lower than or equal to 5 wt %.

As an ionic liquid containing imidazolium cations, an ionic liquid represented by General Formula (G1) below can be used, for example. In General Formula (G1), R¹ represents an alkyl group having 1 to 6 carbon atoms or a substituted or unsubstituted aryl group having 6 to 13 carbon atoms and preferably represents an alkyl group having 1 to 4 carbon atoms, R² to R⁴ each independently represent a hydrogen atom or an alkyl group having 1 to 6 carbon atoms or a substituted or unsubstituted aryl group having 6 to 13 carbon atoms and preferably represent an alkyl group having 1 to 4 carbon atoms, and R⁵ represents an alkyl group or a main chain composed of two or more atoms selected from C, O, Si, N, S, and P atoms. A substituent may be introduced into the main chain represented by R⁵. Examples of the substituent to be introduced include an alkyl group and an alkoxy group. The main chain represented by R⁵ may have a carboxy group. The main chain represented by R⁵ may have a carbonyl group.

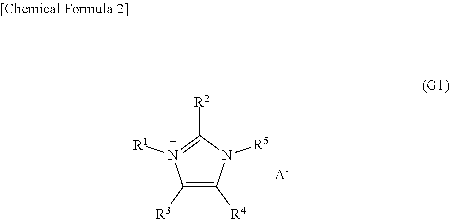

As an ionic liquid containing pyridinium cations, an ionic liquid represented by General Formula (G2) below may be used, for example. In General Formula (G2), R⁶ represents an alkyl group or a main chain composed of two or more atoms selected from C, O, Si, N, S, and P atoms, and R⁷ to R¹¹ each independently represent a hydrogen atom or an alkyl group having 1 to 4 carbon atoms. A substituent may be introduced into the main chain represented by R⁶. Examples of the substituent to be introduced include an alkyl group and an alkoxy group.

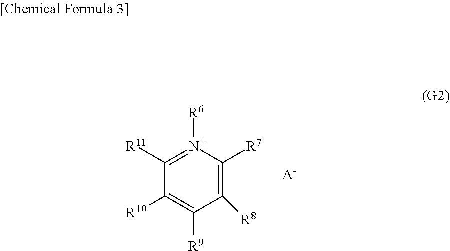

As an ionic liquid containing quaternary ammonium cations, an ionic liquid represented by General Formula (G3), (G4), (G5), or (G6) below can be used, for example.

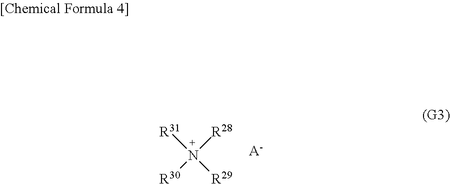

In General Formula (G3), R²⁸ to R³¹ each independently represent an alkyl group having 1 to 20 carbon atoms, a methoxy group, a methoxymethyl group, a methoxyethyl group, or a hydrogen atom.

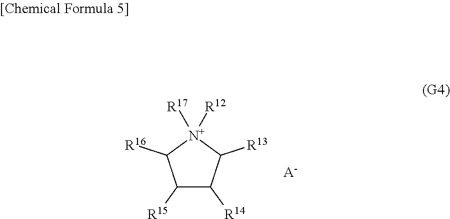

In General Formula (G4), R¹² to R¹⁷ each independently represent an alkyl group having 1 to 20 carbon atoms, a methoxy group, a methoxymethyl group, a methoxyethyl group, or a hydrogen atom.

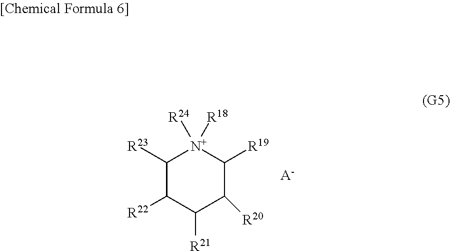

In General Formula (G5), R¹⁸ to R²⁴ each independently represent an alkyl group having 1 to 20 carbon atoms, a methoxy group, a methoxymethyl group, a methoxyethyl group, or a hydrogen atom.

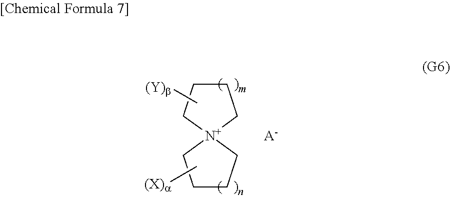

In General Formula (G6), n and m are greater than or equal to 1 and less than or equal to 3. Assume that α is greater than or equal to 0 and less than or equal to 6. When n is 1, α is greater than or equal to 0 and less than or equal to 4. When n is 2, α is greater than or equal to 0 and less than or equal to 5. When n is 3, α is greater than or equal to 0 and less than or equal to 6. Assume that β is greater than or equal to 0 and less than or equal to 6. When m is 1, β is greater than or equal to 0 and less than or equal to 4. When m is 2, β is greater than or equal to 0 and less than or equal to 5. When m is 3, β is greater than or equal to 0 and less than or equal to 6. Note that “α or β is 0” means “unsubstituted”. The case where both α and β are 0 is excluded. Note that X or Y represents a substituent such as a straight-chain or side-chain alkyl group having 1 to 4 carbon atoms, a straight-chain or side-chain alkoxy group having 1 to 4 carbon atoms, or a straight-chain or side-chain alkoxyalkyl group having 1 to 4 carbon atoms.

As an ionic liquid containing tertiary sulfonium cations, an ionic liquid represented by General Formula (G7) below can be used, for example. In General Formula (G7), R²⁵ to R²⁷ each independently represent a hydrogen atom, an alkyl group having 1 to 4 carbon atoms, or a phenyl group. Alternatively, as R²⁵ to R²⁷, a main chain composed of two or more atoms selected from C, O, Si, N, S, and P atoms may be used.

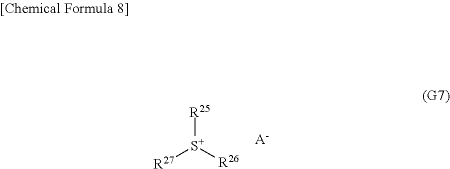

As an ionic liquid containing quaternary phosphonium cations, an ionic liquid represented by General Formula (G8) below can be used, for example. In General Formula (G8), R³² to R³⁵ each independently represent a hydrogen atom, an alkyl group having 1 to 4 carbon atoms, or a phenyl group. Alternatively, as R³² to R³⁵, a main chain composed of two or more atoms selected from C, O, Si, N, S, and P atoms may be used.

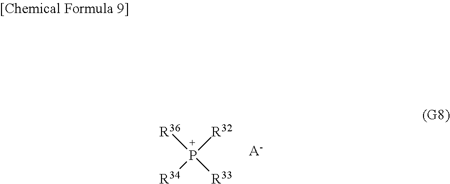

As A⁻ shown in General Formulae (G1) to (G8), one or more of a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion can be used.

As a monovalent amide-based anion, (CₙF₂ₙ₊₁SO₂)₂N⁻ (n=0 to 3) can be used, and as a monovalent cyclic amide-based anion, (CF₂SO₂)₂N⁻ or the like can be used. As a monovalent methide-based anion, (CₙF₂ₙ₊₁SO₂)₃C⁻ (n=0 to 3) can be used, and as a monovalent cyclic methide-based anion, (CF₂SO₂)₂C (CF₃SO₂) or the like can be used. As a fluoroalkyl sulfonic acid anion, (CₘF₂ₘ₊₁SO₃) (m=0 to 4) or the like is given. As a fluoroalkylborate anion, {BFₙ(CₘHₖF₂ₘ₊₁₋ₖ)₄₋ₙ} (n=0 to 3, m=1 to 4, and k=0 to 2 μm) or the like is given. As a fluoroalkylphosphate anion, {PFₙ(CₘHₖF₂ₘ₊₁₋ₖ)₆₋ₙ}⁻ (n=0 to 5, m=1 to 4, and k=0 to 2 μm) or the like is given.

As a monovalent amide-based anion, one or more of a bis(fluorosulfonyl)amide anion and a bis(trifluoromethanesulfonyl)amide anion can be used, for example.

An ionic liquid may contain one or more of a hexafluorophosphate anion and a tetrafluoroborate anion.

Hereinafter, an anion represented by (FSO₂)₂N⁻ is sometimes represented by an FSA anion, and an anion represented by (CF₃SO₂)₂N⁻ is sometimes represented by a TFSA anion.

Specific examples of the cation represented by General Formula (G1) above include Structural Formula (111) to Structural Formula (174).

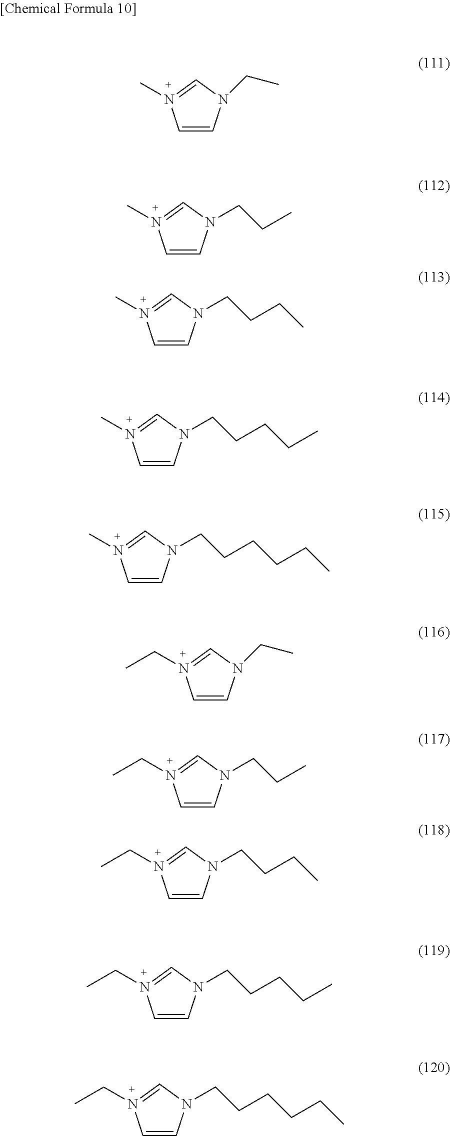

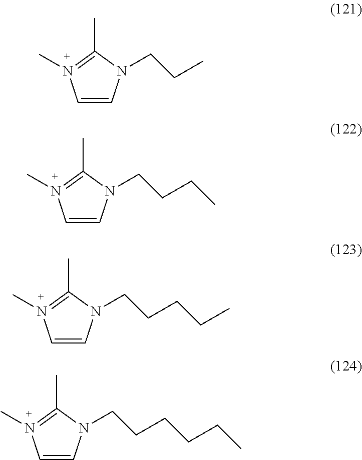

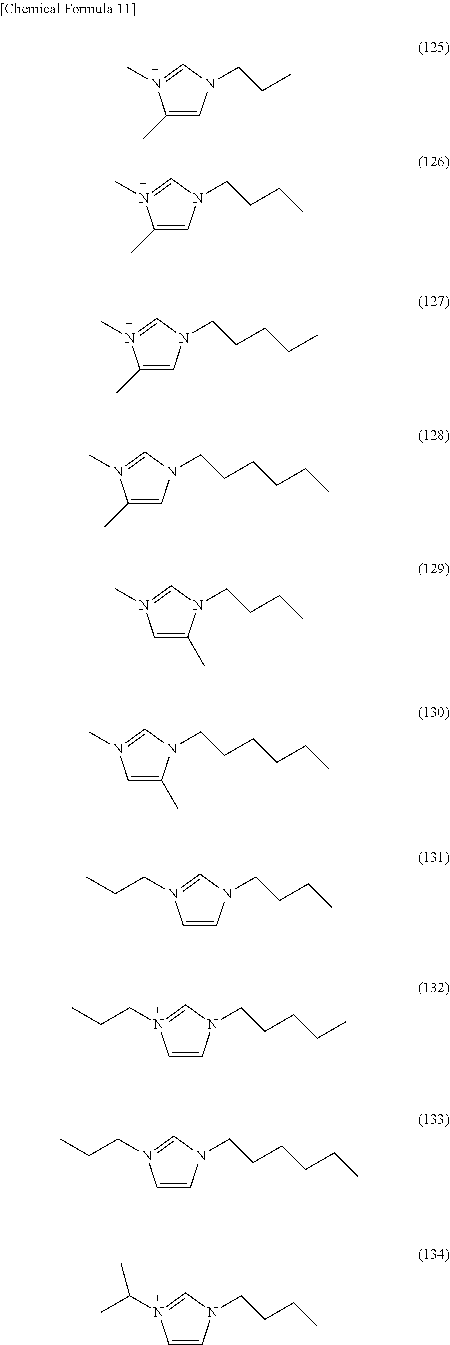

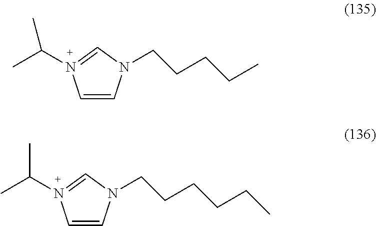

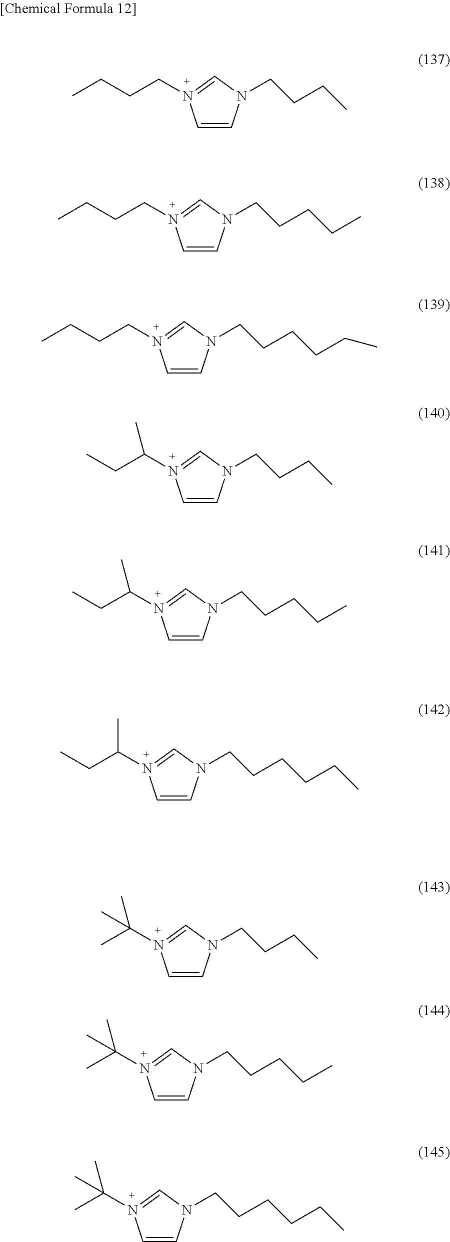

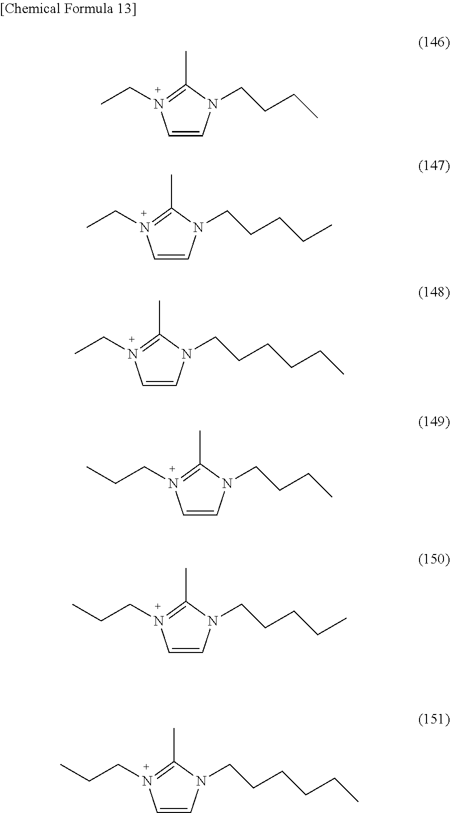

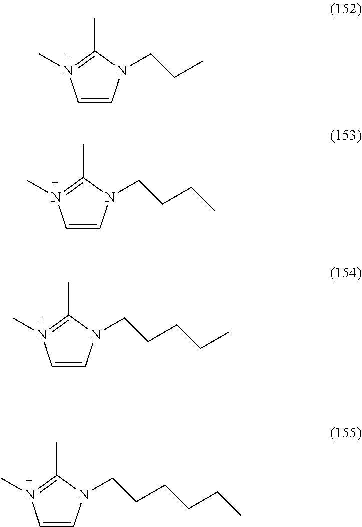

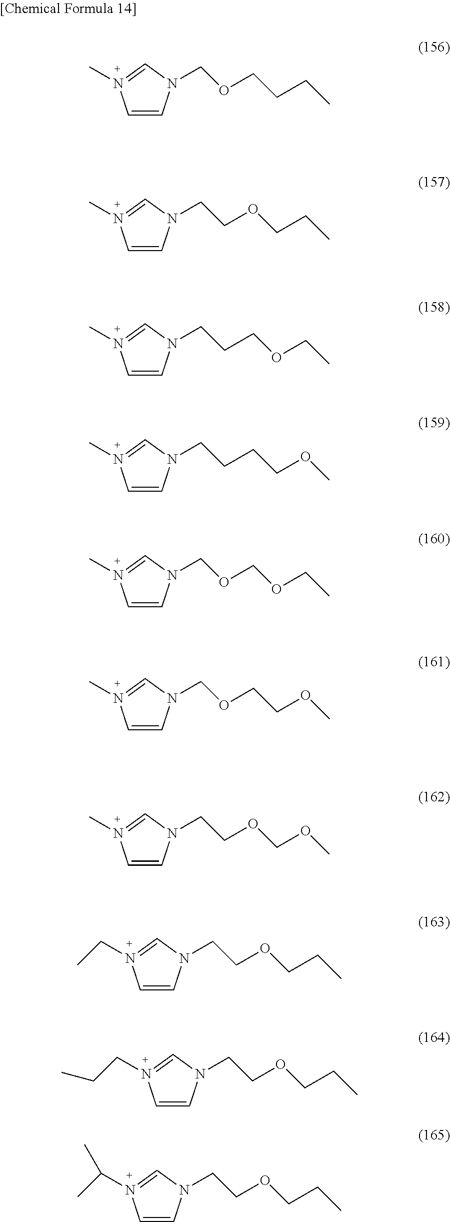

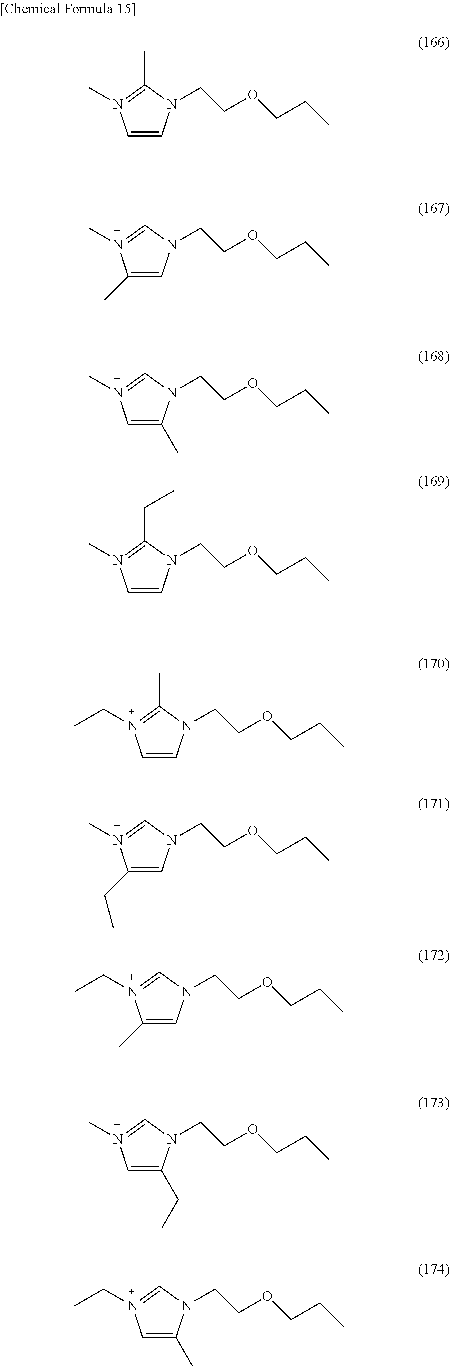

The ionic liquid shown in General Formula (G1) contains an imidazolium cation and an anion represented by A⁻. An ionic liquid containing an imidazolium cation has low viscosity and can be used in a wide temperature range. Moreover, an ionic liquid containing an imidazolium cation has high stability and a wide potential window and thus can be suitably used as an electrolyte of a secondary battery.

A mixture of the ionic liquid shown in General Formula (G1) and a salt such as a lithium salt can be used as an electrolyte of a secondary battery. The imidazolium cation shown in General Formula (G1) has high resistance to oxidation, high resistance to reduction, and a wide potential window and thus is suitable as a solvent used for an electrolyte. Here, the range of potentials in which the electrolysis of an electrolyte does not occur is referred to as a potential window. In particular, the secondary battery of one embodiment of the present invention includes a positive electrode active material that has excellent performance even at a high charge voltage and charge voltage can be increased. Thus, the use of an ionic liquid having a wide potential window and significantly high resistance to, in particular, oxidation can achieve an excellent secondary battery.

In particular, in General Formula (G1), when R¹ represents a methyl group, an ethyl group, or a propyl group; one of R², R³, and R⁴ represents a hydrogen atom or a methyl group and the other two represent hydrogen atoms; and either an anion represented by (FSO₂)₂N⁻ (an FSA anion) or an anion represented by (CF₃SO₂)₂N⁻ (a TFSA anion) or a mixture thereof is used as the anion A⁻, it is possible to achieve an electrolyte that has a wide potential window, has excellent resistance to oxidation, and can be used in a wide temperature range without being solidified even at a temperature at which viscosity lowers.

In particular, a metal salt of a fluorosulfonate anion and a metal salt of a fluoroalkylsulfonate anion are preferable as a salt used for an electrolyte: among them, a metal salt of an amide-based anion represented by (CₙF₂ₙ₊₁SO₂)₂N⁻ (n is greater than or equal to 0 and less than or equal to 3) is preferable because of its high stability at high temperatures and high resistance to oxidation and reduction. In particular, by using either LiN(FSO₂)₂ or LiN(CF₃SO₂)₂ or a mixture thereof, a secondary battery that is highly stable and can operate in a wide temperature range can be achieved.

Examples of the cation in General Formula (G1) in which R¹ represents a methyl group, an ethyl group, or a propyl group; one of R², R³, and R⁴ represents a hydrogen atom or a methyl group; and the other two represent hydrogen atoms include cations represented by Structural Formulae (111) to (124) above, Structural Formulae (131) to (136) above, Structural Formulae (146) to (155) above, and Structural Formulae (156) to (166) and (170) above. One selected from these cations is preferably used. Alternatively, a plurality of cations selected from these cations may be used in combination.

Furthermore, when the sum of carbon atoms and oxygen atoms contained in R¹ and R⁵ is less than or equal to 7 in General Formula (G1), the viscosity of an ionic liquid is lowered and a secondary battery with excellent output characteristics can be achieved. For example, among the above-described cations, a 1-butyl-3-propylimidazolium (BPI) cation represented by Structural Formula (131) above is preferably used.

For example, it is preferable to use a cation in General Formula (G1) in which R¹ represents a methyl group, R² represents a hydrogen atom, and the sum of carbon atoms and oxygen atoms contained in R⁵ is less than or equal to 6. An electrolyte of a secondary battery preferably contains one or more selected from the cations represented by Structural Formulae (111) to (115) and Structural Formulae (156) to (162) above. It is particularly preferable that an electrolyte of a secondary battery contain one or more selected from a 1-ethyl-3-methylimidazolium (EMI) cation represented by Structural Formula (111) above, a 1-butyl-3-methylimidazolium (BMI) cation represented by Structural Formula (113) above, a 1-hexyl-3-methylimidazolium (HMI) cation represented by Structural Formula (115) above, and a 1-methyl-3-(2-propoxyethyl)imidazolium (poEMI) cation represented by Structural Formula (157) above. In particular, an ionic liquid containing the EMI cation is suitable because of its low viscosity and extremely high stability.

By using a mixture of the EMI cation and the BMI cation, for example, an ionic liquid having low viscosity and high stability can be achieved. In the case where a mixture of the EMI cation and the BMI cation is used, for example, the EMI cation: the BMI cation is e:b (molar ratio) where e>b is satisfied; alternatively, e>2b may be satisfied.

A mixture of the ionic liquid shown in General Formula (G1) and one or more selected from ionic liquids shown in General Formulae (G2) to (G8) has low viscosity and can be used in a wide temperature range. Therefore, an ionic liquid having particularly high resistance to oxidation and extremely high stability can be achieved. In that case, for example, it is preferable that the volume of the ionic liquid shown in General Formula (G1) be larger than the volume of one or more selected from the ionic liquids shown in General Formulae (G2) to (G8), and it is further preferable that the volume of the ionic liquid shown in General Formula (G1) be larger than twice the volume of one or more selected from the ionic liquids shown in General Formulae (G2) to (G8).

Specific examples of the cation represented by General Formula (G2) above include Structural Formula (701) to Structural Formula (719).

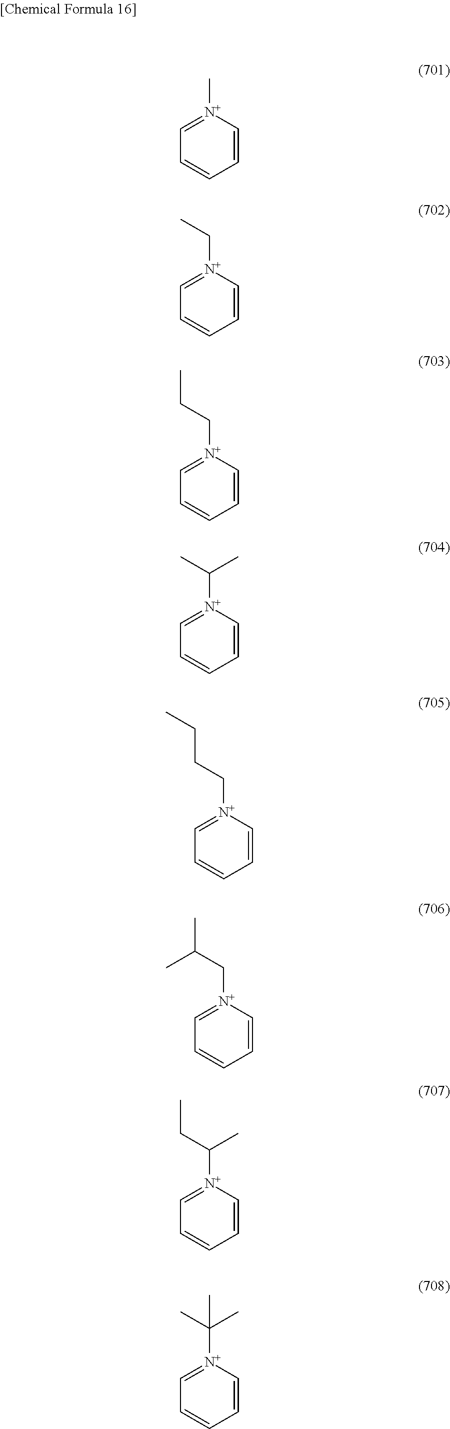

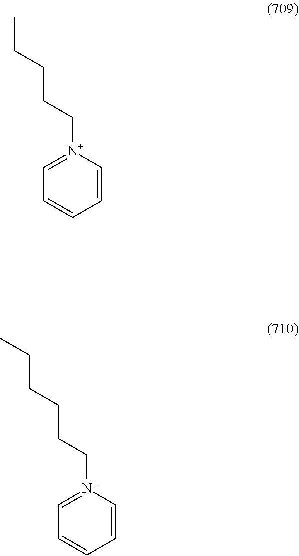

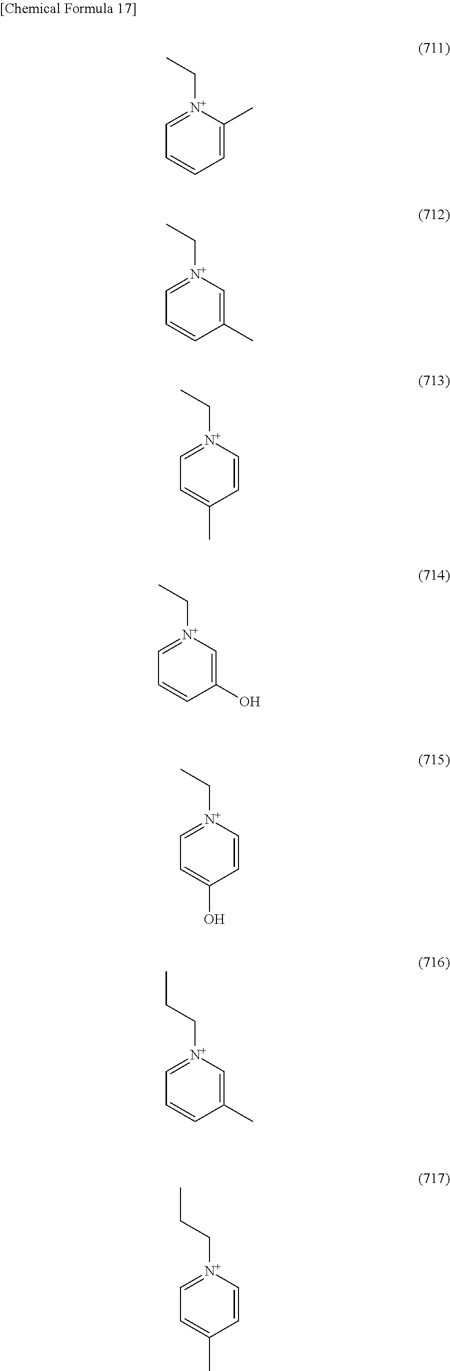

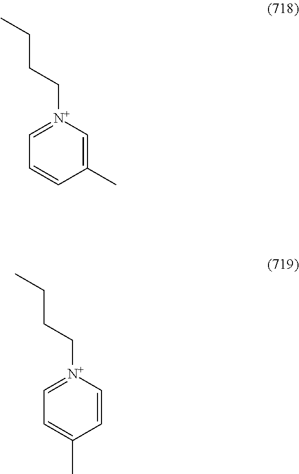

Specific examples of the cation represented by General Formula (G4) above include Structural Formula (501) to Structural Formula (520).

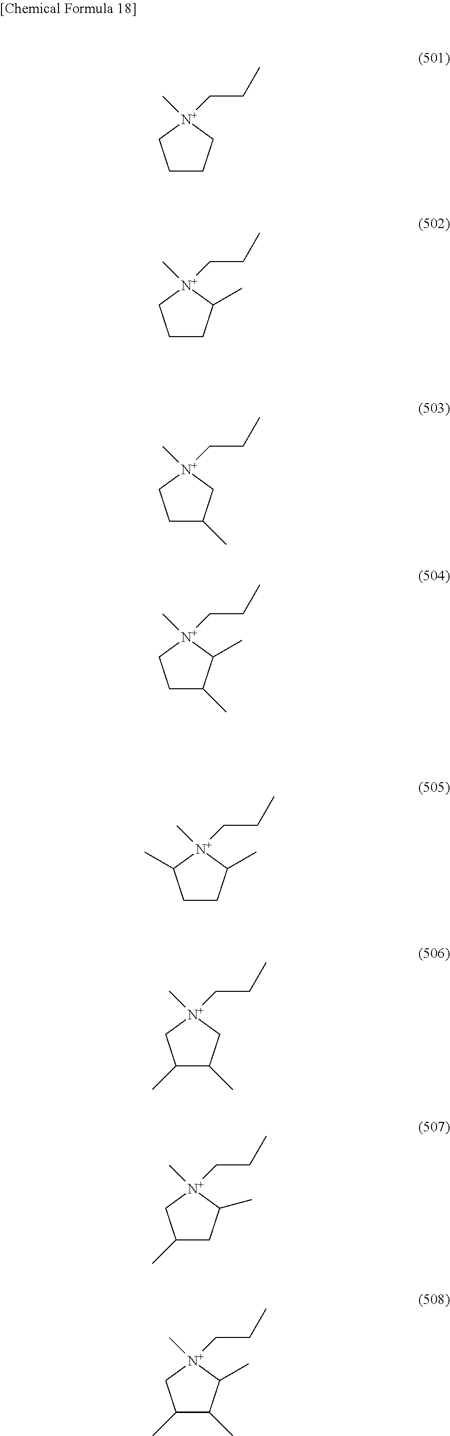

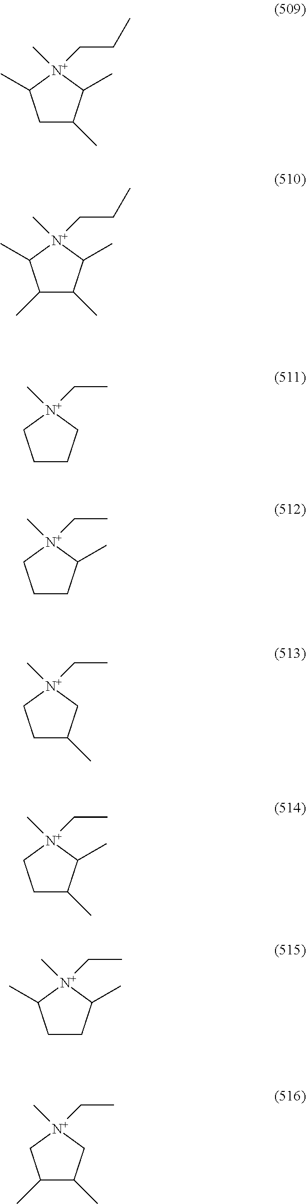

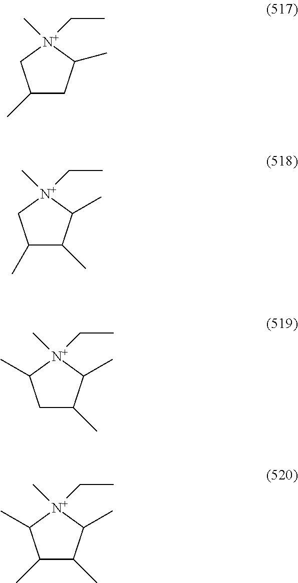

Specific examples of the cation represented by General Formula (G5) above include Structural Formula (601) to Structural Formula (630).

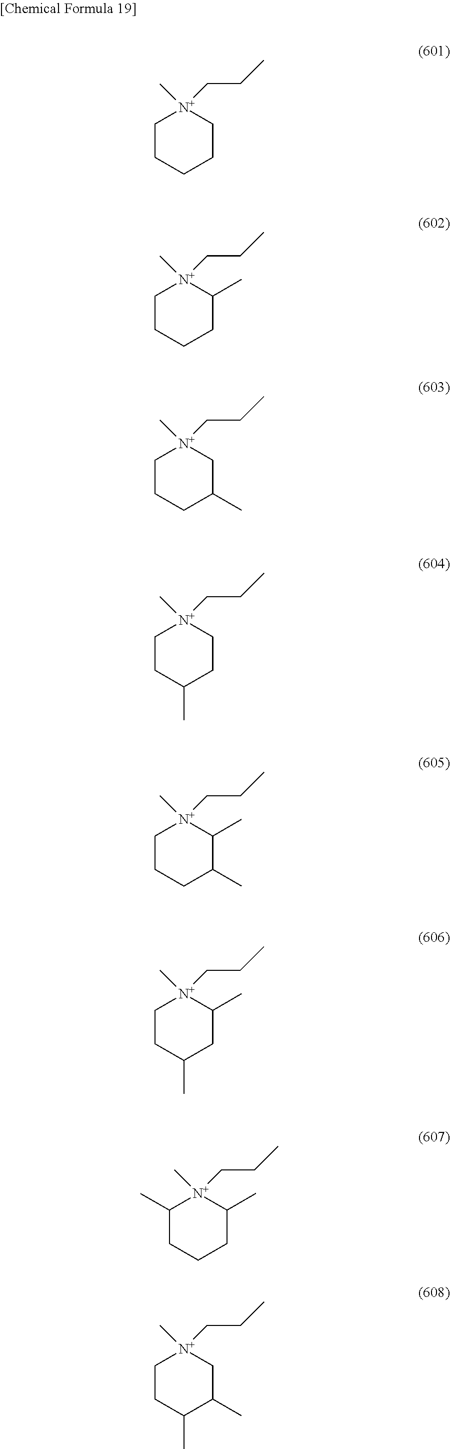

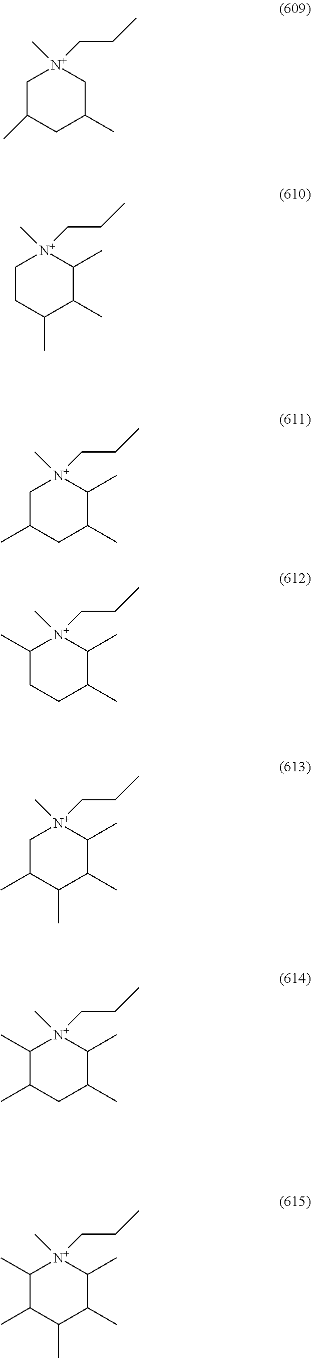

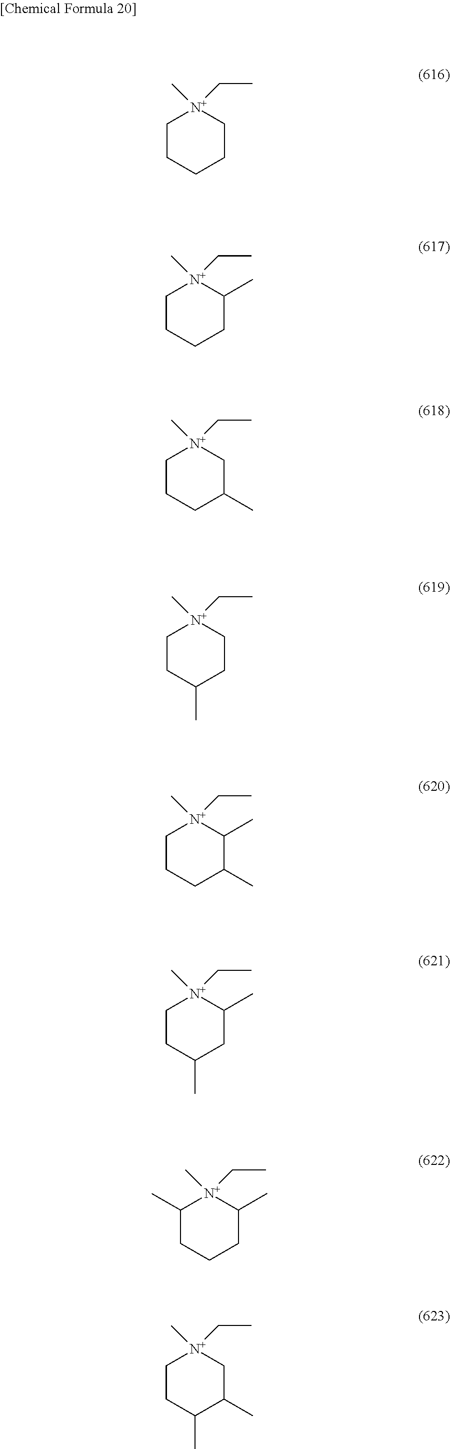

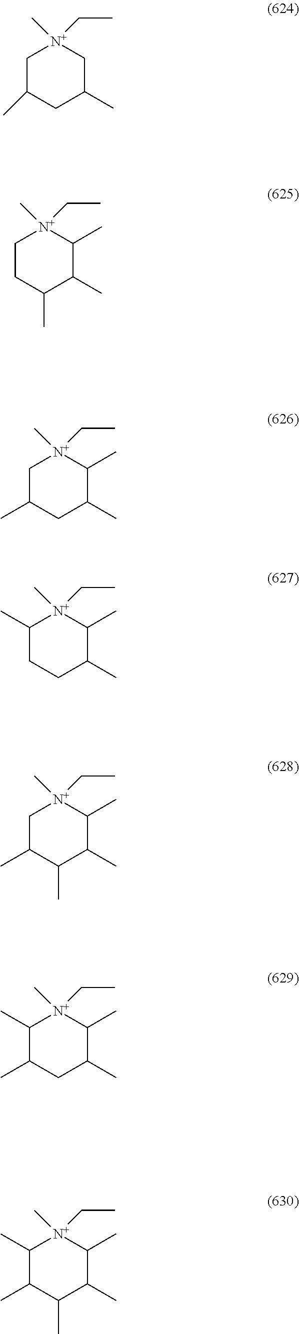

Specific examples of the cation represented by General Formula (G6) above include Structural Formula (301) to Structural Formula (309) and Structural Formula (401) to Structural Formula (419).

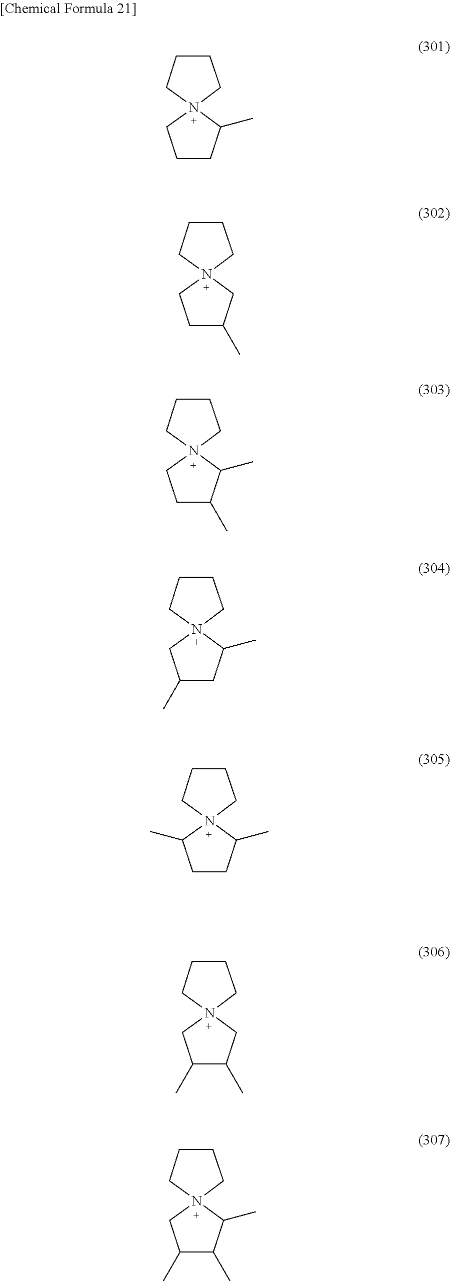

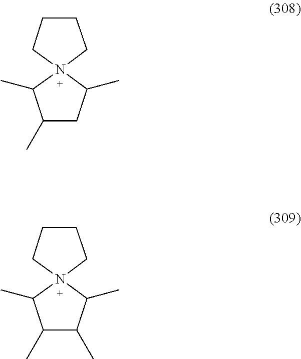

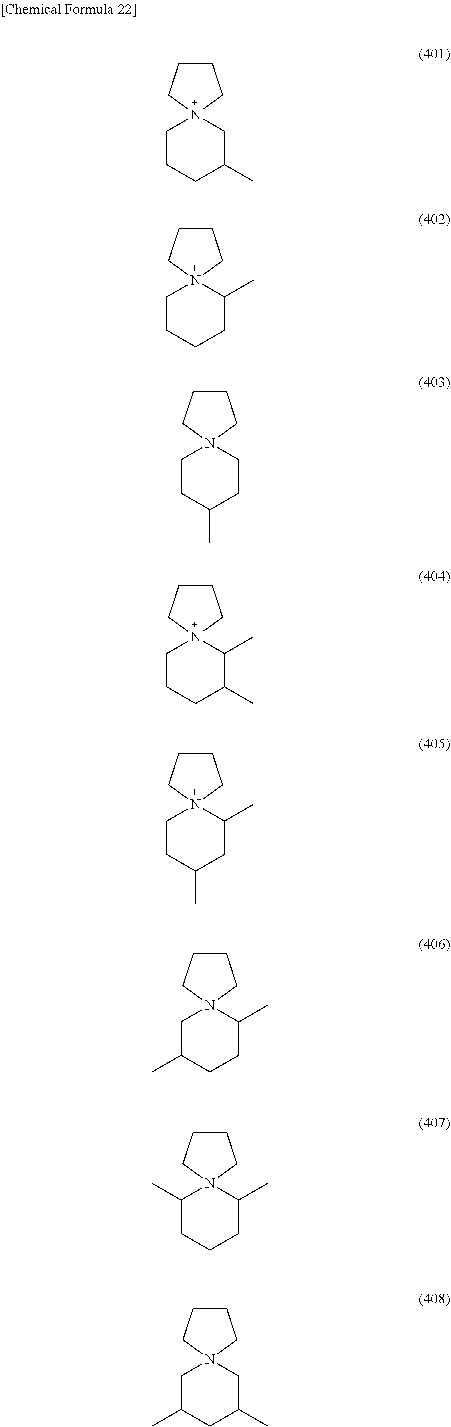

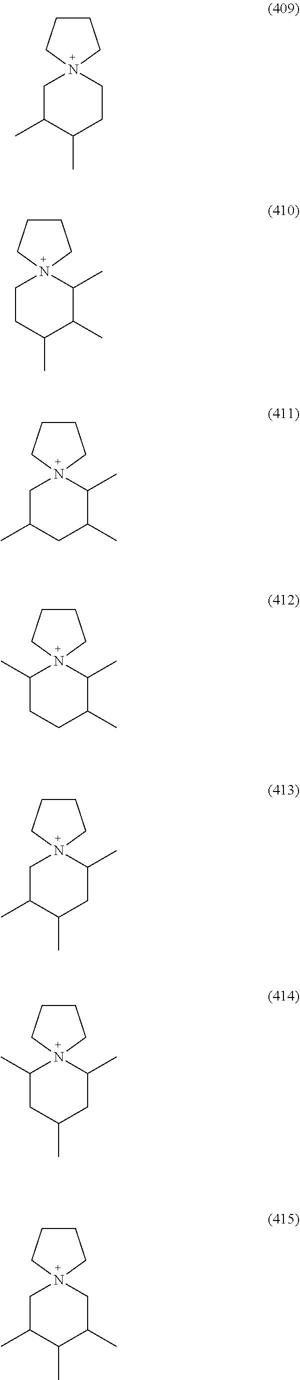

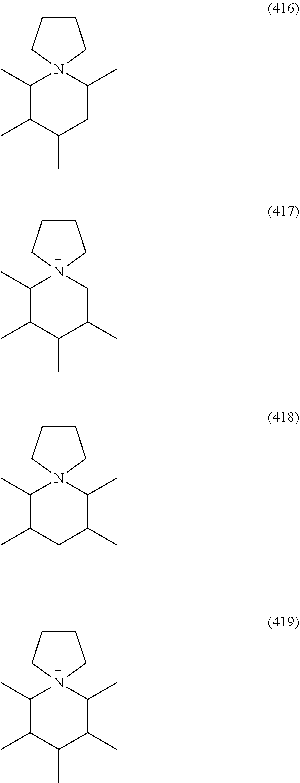

Although Structural Formula (301) to Structural Formula (309) and Structural Formula (401) to Structural Formula (419) each show an example in which m is 1 in General Formula (G6), m may be changed into 2 or 3 in Structural Formula (301) to Structural Formula (309) and Structural Formula (401) to Structural Formula (419).

Specific examples of the cation represented by General Formula (G7) above include Structural Formula (201) to Structural Formula (215).

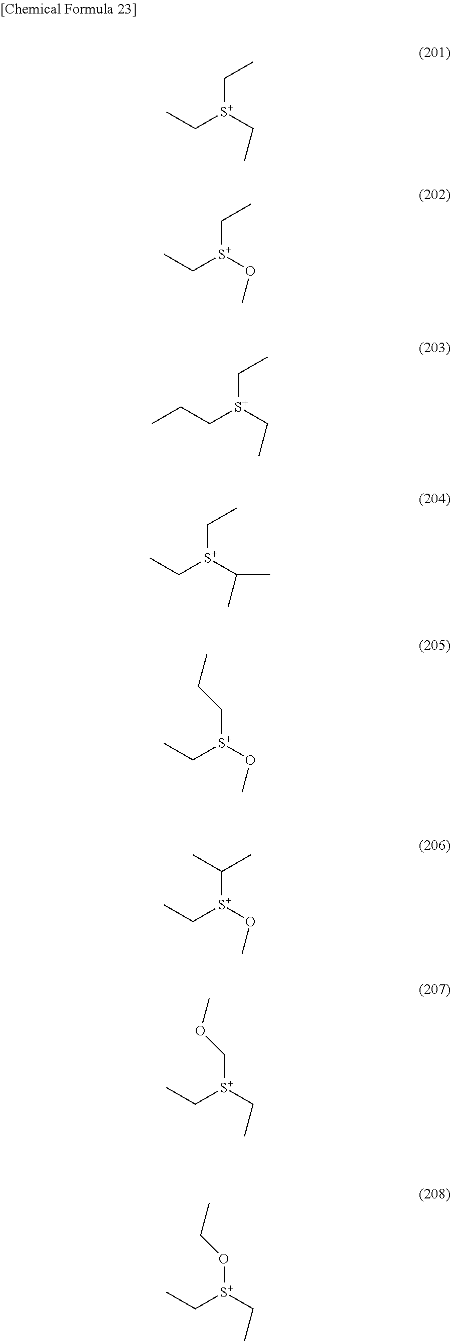

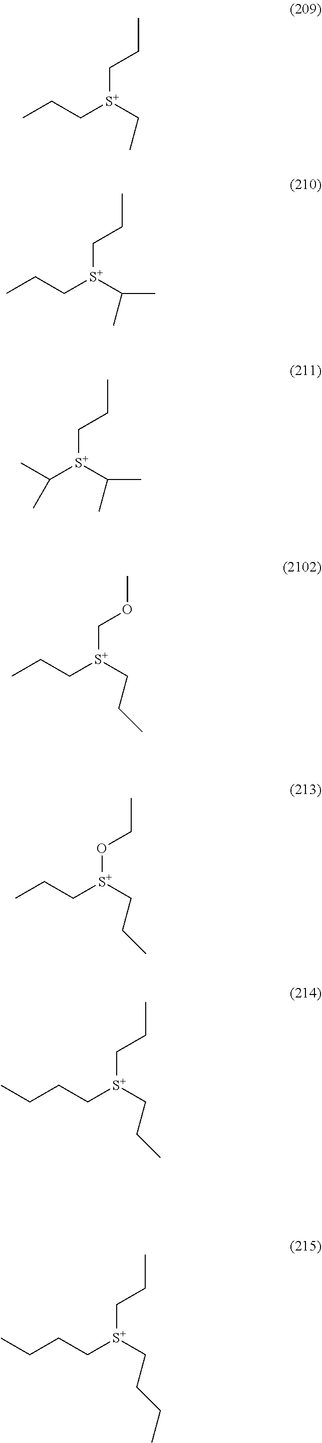

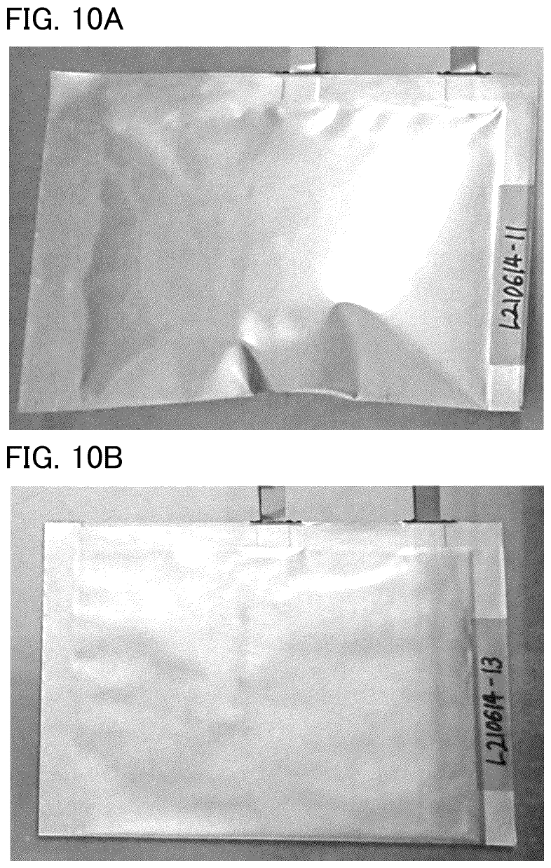

Since the secondary battery of one embodiment of the present invention contains the above-described ionic liquid as the electrolyte solution, a change in the shape of the secondary battery can be inhibited even in a vacuum. For example, FIG. 10A is a photograph showing the appearance of a secondary battery that is fabricated using a general organic electrolyte solution and is put in an environment at −100 kPa or lower (read by a differential pressure gauge). FIG. 10B is a photograph showing the appearance of the secondary battery of one embodiment of the present invention that uses the electrolyte solution containing the ionic liquid and is put in an environment at −100 kPa or lower (read by a differential pressure gauge). The secondary battery fabricated using the general organic electrolyte solution in FIG. 10A is largely changed in shape (expanded). By contrast, a change in the shape of the secondary battery of one embodiment of the present invention using the electrolyte solution containing the ionic liquid in FIG. 10B is extremely small.

### [Deaeration]

In a fabrication process of a secondary battery, a gas remaining inside the secondary battery or a gas contained in an electrolyte solution is preferably deaerated and degassed, in which case a change in the shape of the secondary battery due to a pressure change in an environment where the secondary battery is placed can be inhibited and reaction of a gas component dissolved in the electrolyte solution inside the secondary battery can be inhibited.

As a method for degassing an electrolyte solution, for example, one or more of the following methods can be used: a degassing method in which an electrolyte solution is put in a reduced-pressure environment (reduced-pressure degassing); a degassing method in which ultrasonic vibration is applied to an electrolyte solution (ultrasonic degassing); a degassing method in which ultrasonic vibration is applied to an electrolyte solution in a reduced-pressure environment (reduced-pressure ultrasonic degassing); a degassing method in which three steps of freezing an electrolyte solution (Step 1), reducing the pressure with the electrolyte solution frozen (Step 2), and defrosting the electrolyte solution (Step 3) are repeated (freeze-pump-thaw); and a degassing method in which an inert gas (e.g., argon) is bubbled in an electrolyte solution (bubbling degassing).

The secondary battery of one embodiment of the present invention contains the positive electrode active material of one embodiment of the present invention and an electrolyte solution containing the above-described ionic liquid, whereby a capacity decrease can be inhibited and significantly excellent performance can be achieved even when the secondary battery is repeatedly used at a high charge voltage.

### [Negative Electrode Active Material]

A negative electrode of one embodiment of the present invention includes a negative electrode active material. The negative electrode of one embodiment of the present invention preferably includes a conductive material. The negative electrode of one embodiment of the present invention preferably includes a binder.

As the negative electrode active material, a material that can react with carrier ions of a secondary battery, a material into and from which carrier ions can be inserted and extracted, a material that enables an alloying reaction with a metal serving as a carrier ion, a material that enables melting and precipitation of a metal serving as a carrier ion, or the like is preferably used.

Carbon materials such as graphite, graphitizing carbon, non-graphitizing carbon, carbon nanotube, carbon black, and graphene can be used as the negative electrode active material, for example.

In addition, a material containing one or more elements selected from silicon, tin, gallium, aluminum, germanium, lead, antimony, bismuth, silver, zinc, cadmium, and indium can be used as the negative electrode active material, for example.

An impurity element such as phosphorus, arsenic, boron, aluminum, or gallium may be added to silicon so that silicon is lowered in resistance.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous.

As a compound containing silicon, Li₂SiO₃ and Li₄SiO₄ can be used, for example. Each of Li₂SiO₃ and Li₄SiO₄ may have crystallinity, or may be amorphous.

The analysis of the compound containing silicon can be performed by NMR, XRD, a Raman spectroscopy method, or the like.

Furthermore, an oxide containing one or more elements selected from titanium, niobium, tungsten, and molybdenum can be used as a material that can be used for the negative electrode active material, for example.

As the negative electrode active material, it is possible to use a combination of two or more of the aforementioned metals, materials, compounds, and the like.

The negative electrode active material of one embodiment of the present invention may contain fluorine in a surface portion. When the negative electrode active material contains halogen in its surface portion, a decrease in charge and discharge efficiency can be inhibited. Moreover, it is considered that a reaction with an electrolyte at a surface of the active material is inhibited. In addition, at least part of the surface of the negative electrode active material of one embodiment of the present invention is covered with a region containing halogen in some cases. The region may have a film shape, for example. Fluorine is particularly preferable as halogen.

### <Formation Method Example>

An example of a method for forming a negative electrode active material containing halogen in its surface portion will be described.

The above-described material that can be used for the negative electrode active material and a compound containing halogen are mixed as a first material and a second material, respectively, and heat treatment is performed, whereby the negative electrode active material can be formed.

In addition to the first material and the second material, a material causing eutectic reaction with the second material may be mixed as a third material. The eutectic point of the eutectic reaction is preferably lower than at least one of the melting point of the second material and the melting point of the third material. A decrease in the melting point due to the eutectic reaction brings the feasibility of covering the surface of the first material with the second material and the third material during the heat treatment, which increases the coverage in some cases.

As the second material and the third material, a material including a metal whose ion functions as a carrier ion in the reaction of the secondary battery is used, whereby such a metal can contribute to charging and discharging using its carrier ion, in some cases, when the metal is included in a negative electrode active material.

As the third material, a material containing oxygen and carbon can be used, for example. As the material containing oxygen and carbon, carbonate can be used, for example. Alternatively, as the material containing oxygen and carbon, an organic compound can be used, for example.

Alternatively, as the third material, hydroxide may be used.

Materials such as carbonate and hydroxide are preferable because many of them are inexpensive and have a high level of safety. Furthermore, carbonate, hydroxide, and the like sometimes have a eutectic point with a material containing halogen and are thus preferable.

More specific examples of the second material and the third material are described. When lithium fluoride is used as the second material, the lithium fluoride does not cover the surface of the first material but is aggregated only with itself, in some cases, in heating after being mixed with the first material. In such a case, a material causing a eutectic reaction with lithium fluoride is used as the third material, whereby the coverage of the surface of the first material is improved in some cases.

When the first material is heated, reaction with oxygen in an atmosphere occurs in the heating, whereby an oxide film is formed on the surface in some cases. In the formation of the negative electrode active material of one embodiment of the present invention, eutectic reaction between a material containing halogen and a material containing oxygen and carbon is caused in an annealing process described later, whereby heating at low temperatures can be performed. As a result, oxidation reaction at the surface or the like can be inhibited.

When a carbon material is used as the first material, there is a concern that carbon dioxide is generated by reaction of the carbon material and oxygen in an atmosphere in the heating to cause a reduction in the weight of the first material, damage to the surface of the first material, and the like. In the formation of the negative electrode active material of one embodiment of the present invention, the heating can be performed at low temperatures; thus, a weight reduction, a surface damage, and the like can be inhibited even when the carbon material is used as the first material.

Here, graphite is prepared as the first material. As the graphite, flake graphite, spherical natural graphite, MCMB, or the like can be used. The surface of graphite may be covered with a low-crystalline carbon material.

As the second material, a material containing halogen is prepared. As the material containing halogen, a halogen compound containing a metal C can be used. As the metal C, one or more selected from lithium, magnesium, aluminum, sodium, potassium, calcium, barium, lanthanum, cerium, chromium, manganese, iron, cobalt, nickel, zinc, zirconium, titanium, vanadium, and niobium can be used, for example. As the halogen compound, for example, a fluoride or a chloride can be used. The halogen contained in the material containing halogen is represented by an element Z.

Here, lithium fluoride is prepared as an example.

A material containing oxygen and carbon is prepared as the third material. As the material containing oxygen and carbon, a carbonate containing a metal D can be used, for example. As the metal D, one or more selected from lithium, magnesium, aluminum, sodium, potassium, calcium, barium, lanthanum, cerium, chromium, manganese, iron, cobalt, and nickel can be used, for example.

Here, lithium carbonate is prepared as an example.

The first material, the second material, and the third material are mixed to obtain a mixture.

The second material and the third material are preferably mixed to have a ratio such that (the second material):(the third material)=a1:(1−a1) [unit: mol.] where al is preferably greater than 0.2 and less than 0.9, further preferably greater than or equal to 0.3 and less than or equal to 0.8.

Furthermore, the first material and the second material are preferably mixed to have a ratio such that (the first material):(the second material)=1:b1 [unit: mol.] where b1 is preferably greater than or equal to 0.001 and less than or equal to 0.2.

Next, the annealing process is performed, whereby the negative electrode active material of one embodiment of the present invention is obtained.

It is preferable that the annealing process be performed in a reduction atmosphere, in which case the oxidation of the surface of the first material and the reaction of the first material with oxygen can be inhibited. The reduction atmosphere may be a nitrogen atmosphere or a rare gas atmosphere, for example. Furthermore, two or more types of gases selected from nitrogen and a rare gas may be mixed and used. The heating may be performed under reduced pressure.

In the case where the melting point of the second material is represented by M₂ [K], the heating temperature is preferably higher than (M₂−550) [K] and lower than (M₂+50) [K], further preferably higher than or equal to (M₂−400) [K] and lower than or equal to (M₂) [K], for example.

Moreover, in a compound, solid-phase diffusion occurs easily at a temperature higher than or equal to the Tamman temperature. The Tamman temperature of an oxide, for example, is 0.757 times the melting point. Thus, the heating temperature is preferably higher than or equal to 0.757 times the eutectic point or higher than its vicinity, for example.

In the case of lithium fluoride that is atypical example of the material containing halogen, the amount of evaporation increases rapidly at a temperature higher than or equal to the melting point. Thus, the heating temperature is preferably lower than or equal to the melting point of the material containing halogen, for example.

In the case where the eutectic point of the second material and the third material is represented by M₂₃ [K], the heating temperature is, for example, preferably higher than (M₂₃×0.7) 30 [K] and lower than (M₂+50) [K], preferably higher than or equal to (M₂₃×0.75) [K] and lower than or equal to (M₂+20) [K], preferably higher than or equal to (M₂₃×0.75) [K] and lower than or equal to (M₂+20) [K], preferably higher than M₂₃ [K] and lower than (M₂+10) [K], further preferably higher than or equal to (M₂₃×0.8) [K] and lower than or equal to M₂ [K], further preferably higher than or equal to (M₂₃) [K] and lower than or equal to M₂ [K].

In the case where lithium fluoride is used as the second material and lithium carbonate is used as the third material, the heating temperature is, for example, preferably higher than 350° C. and lower than 900° C., further preferably higher than or equal to 390° C. and lower than or equal to 850° C., still further preferably higher than or equal to 520° C. and lower than or equal to 910° C., still further preferably higher than or equal to 570° C. and lower than or equal to 860° C., yet still further preferably higher than or equal to 610° C. and lower than or equal to 860° C.

The heating time is preferably longer than or equal to 1 hour and shorter than or equal to 60 hours, further preferably longer than or equal to 3 hours and shorter than or equal to 20 hours, for example.

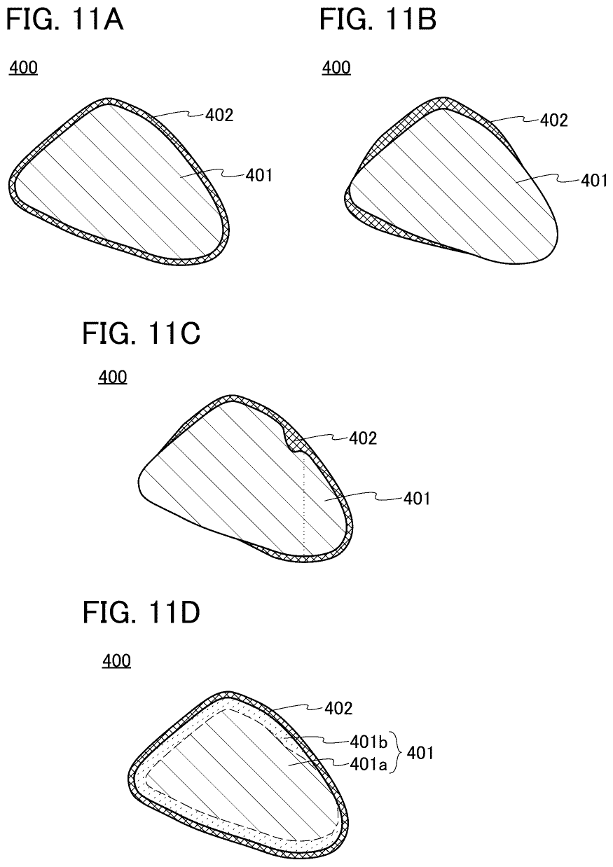

FIG. 11A, FIG. 11B, FIG. 11C, and FIG. 11D each illustrate an example of a cross section of a negative electrode active material 400.

The cross section of the negative electrode active material 400 is exposed by processing, whereby observation and analysis of the cross section can be performed.

The negative electrode active material 400 illustrated in FIG. 11A includes a region 401 and a region 402. The region 402 is positioned on an outer side of the region 401. The region 402 is preferably in contact with the surface of the region 401.

At least part of the region 402 preferably includes the surface of the negative electrode active material 400.

The region 401 is, for example, a region including an inner portion of the negative electrode active material 400.

The region 401 contains the first material described above. The region 402 contains the element Z, oxygen, carbon, the metal C, and the metal D, for example. The element Z is, for example, fluorine or chlorine. The region 402 does not contain some of elements of the element Z, oxygen, carbon, the metal C, and the metal D, in some cases. Alternatively, in the region 402, some of the elements of the element Z, oxygen, carbon, the metal C, and the metal D have low concentration and are not detected by analysis in some cases.

The region 402 is called a surface portion of the negative electrode active material 400 or the like, in some cases.

The negative electrode active material 400 can have a variety of forms such as one particle, a group of a plurality of particles, and a thin film.

The region 401 may be a particle of the first material. Alternatively, the region 401 may be a group of a plurality of particles of the first material. Alternatively, the region 401 may be a thin film of the first material.

The region 402 may be part of a particle. For example, the region 402 may be a surface portion of the particle. Alternatively, the region 402 may be part of a thin film. For example, the region 402 may be an upper layer portion of a thin film.

The region 402 may be a coating layer formed on the surface of the particle.

The region 402 may be a region including a bond of a constituent element of the first material and the element Z. For example, in the region 402 or the interface between the region 401 and the region 402, the surface of the first material may be modified with the element Z or a functional group containing the element Z. Thus, in the negative electrode active material of one embodiment of the present invention, the bond of a constituent element of the first material and the element Z is observed in some cases. As an example, in the case where the first material is graphite and the element Z is fluorine, a C—F bond is, for example, observed in some cases. As another example, in the case where the first material contains silicon and the element Z is fluorine, a Si—F bond is, for example, observed in some cases.

For example, in the case where graphite is used as the first material, the region 401 is a graphite particle, and the region 402 is a coating layer of the graphite particle. As another example, in the case where graphite is used as the first material, the region 401 is a region including an inner portion of a graphite particle, and the region 402 is a surface portion of the graphite particle.

The region 402 includes, for example, a bond of the element Z and carbon. The region 402 includes, for example, a bond of the element Z and the metal C. The region 402 includes, for example, a carbonate group.

When the negative electrode active material 400 is analyzed by X-ray photoelectron spectroscopy (XPS), the element Z is preferably detected, in which case the concentration of the detected element Z is preferably higher than or equal to 1 atomic %. In this case, the concentration of the element Z can be calculated on the assumption that the total of concentrations of carbon, oxygen, the metal C, the metal D, and the element Z is 100%, for example. Alternatively, the calculation may be performed on the assumption that the value obtained by adding the nitrogen concentration to the concentrations of the above elements is set as 100%. The concentration of the element Z is, for example, lower than or equal to 60 atomic %, or lower than or equal to 30 atomic %.

When the negative electrode active material 400 is analyzed by XPS, a peak attributed to the bond of the element Z and carbon is preferably detected. A peak attributed to the bond of the element Z and the metal C may be detected.

In the case where the element Z is fluorine and the metal C is lithium, in the F is spectrum by XPS, a peak indicating the carbon-fluorine bond (hereinafter, a peak F2) is observed in the vicinity of 688 eV (e.g., its peak position is observed in an energy range higher than 686.5 eV and lower than 689.5 eV), and a peak indicating the lithium-fluorine bond (hereinafter, a peak F1) is observed in the vicinity of 685 eV (e.g., its peak position is observed in an energy range higher than 683.5 eV and lower than 686.5 eV). The intensity of the peak F2 is preferably higher than 0.1 times the intensity of the peak F1 and lower than 10 times the intensity of the peak F1. For example, the intensity of the peak F2 is higher than or equal to 0.3 times the intensity of the peak F₁ and lower than or equal to 3 times the intensity of the peak F1.

When the negative electrode active material 400 is analyzed by XPS, a peak corresponding to carbonate or a carbonate group is preferably observed. In the C1s spectrum by XPS, the peak corresponding to carbonate or a carbonate group is observed in the vicinity of 290 eV (e.g., its peak position is observed in an energy range higher than 288.5 eV and lower than 291.5 eV).

In XRD analysis of the negative electrode active material 400, a spectrum derived from Li₂O represented by a space group Fm-3 μm is observed in some cases.

In the example illustrated in FIG. 11B, the region 401 includes a region not covered with the region 402. In the example illustrated in FIG. 11C, the region 402 covering a region depressed at the surface of the region 401 has a large thickness.

In the negative electrode active material 400 illustrated in FIG. 11D, the region 401 includes a region 401a and a region 401b. The region 401a is a region including the inner portion of the region 401, and the region 401b is positioned on an outer side of the region 401a. In addition, the region 401b is preferably in contact with the region 402.

The region 401b is a surface portion of the region 401.

The region 401b contains one or more elements of the element Z, oxygen, carbon, the metal C, and the metal D contained in the region 402. In the region 401b, the elements contained in the region 402, such as the element Z, oxygen, carbon, the metal C, and the metal D, may have a concentration gradient such that the concentration decreases gradually from the surface or the vicinity of the surface to the inner portion.

The concentration of the element Z contained in the region 401b is higher than the concentration of the element Z contained in the region 401a. The concentration of the element Z contained in the region 401b is preferably lower than the concentration of the element Z contained in the region 402.

The concentration of oxygen contained in the region 401b is higher than the concentration of oxygen contained in the region 401a in some cases. The concentration of oxygen contained in the region 401b is lower than the concentration of oxygen contained in the region 402 in some cases.

When the negative electrode active material of one embodiment of the present invention is measured by energy dispersive X-ray spectroscopy using a scanning electron microscope, it is preferable that the element Z be detected. For example, the concentration of the element Z is preferably higher than or equal to 10 atomic % and lower than or equal to 70 atomic % on the assumption that the total of the concentrations of the element Z and oxygen is 100 atomic %.

The region 402 has a region whose thickness is smaller than or equal to 50 nm, preferably larger than or equal to 1 nm and smaller than or equal to 35 nm, further preferably larger than or equal to 5 nm and smaller than or equal to 20 nm, for example.

The region 401b has a region whose thickness is smaller than or equal to 50 nm, preferably larger than or equal to 1 nm and smaller than or equal to 35 nm, further preferably larger than or equal to 5 nm and smaller than or equal to 20 nm, for example.

In the case where fluorine is used as the element Z and lithium is used as the metal C and a metal A2, the region 402 may include a region covered with a region containing lithium fluoride and a region covered with a region containing lithium carbonate, with respect to the region 401. The region 402 does not obstruct the insertion and extraction of lithium and accordingly enables an excellent secondary battery to be achieved without degradation of output characteristics or the like of the secondary battery.

This embodiment can be combined with the description of any of the other embodiments as appropriate.

### Embodiment 2

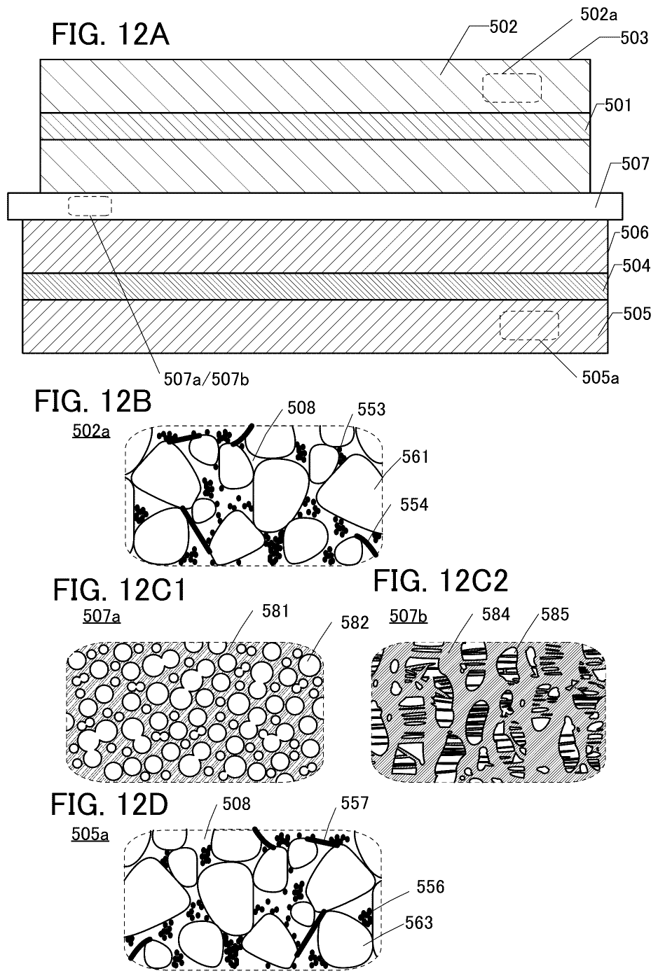

In this embodiment, an example of a secondary battery of one embodiment of the present invention will be described with reference to FIG. 12. The secondary battery includes an exterior body (not illustrated), a positive electrode 503, a negative electrode 506, a separator 507, and an electrolyte 508 in which a lithium salt or the like is dissolved. The separator 507 is provided between the positive electrode 503 and the negative electrode 506.

The positive electrode of one embodiment of the present invention includes a positive electrode active material layer. The positive electrode active material layer contains a positive electrode active material. The positive electrode active material layer may include a conductive material, a binder, and the like. The positive electrode of one embodiment of the present invention preferably includes a current collector, and the positive electrode active material layer is preferably provided over the current collector.

In FIG. 12A, the positive electrode 503 includes a positive electrode active material layer 502 and a positive electrode current collector 501. FIG. 12B shows a schematic view of a region 502a surrounded by the dashed line in FIG. 12A. The positive electrode active material layer 502 includes a positive electrode active material 561, a conductive material, and a binder. FIG. 12B illustrates an example of using acetylene black 553 and graphene 554 as conductive materials.

The negative electrode of one embodiment of the present invention includes a negative electrode active material layer. The negative electrode active material layer contains a negative electrode active material. The negative electrode active material layer may include a conductive agent, a binder, and the like. The negative electrode of one embodiment of the present invention preferably includes a current collector, and the negative electrode active material layer is preferably provided over the current collector.

The negative electrode 506 includes a negative electrode active material layer 505 and a negative electrode current collector 504. The negative electrode active material layer 505 includes a negative electrode active material 563, a conductive material, and a binder. FIG. 12D illustrates an example of using acetylene black 556 and graphene 557 as conductive materials.

As the conductive material, a carbon material, a metal material, a conductive ceramic material, or the like can be used. Alternatively, a fiber material may be used as the conductive material. The content of the conductive material to the total amount of the active material layer is preferably greater than or equal to 1 wt % and less than or equal to 10 wt %, further preferably greater than or equal to 1 wt % and less than or equal to 5 wt %.

A network for electric conduction can be formed in the active material layer by the conductive material. The conductive material also allows maintaining of a path for electric conduction between the active materials. The addition of the conductive material to the active material layer increases the electric conductivity of the active material layer.

As the conductive material, a graphene compound can be used. Moreover, natural graphite, artificial graphite such as mesocarbon microbeads, carbon fiber, or the like can be used as the conductive material.

As carbon fiber, carbon fiber such as mesophase pitch-based carbon fiber or isotropic pitch-based carbon fiber can be used, for example. As the carbon fiber, carbon nanofiber, carbon nanotube, or the like can be used. Carbon nanotube can be formed by, for example, a vapor deposition method. Other examples of the conductive material include carbon materials such as carbon black (e.g., acetylene black (AB)), graphite (black lead) particles, graphene, and fullerene. Alternatively, one or more selected from metal powder and metal fiber of copper, nickel, aluminum, silver, gold, or the like, a conductive ceramic material, and the like can be used.

### [Graphene Compound]

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. A graphene compound is preferably bent. A graphene compound may be rounded like carbon nanofiber.

As the conductive material, it is possible to use a combination of the above-described materials.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

In the longitudinal cross section of the active material layer, the sheet-like graphene compounds are dispersed substantially uniformly in a region inside the active material layer. The plurality of graphene compounds are formed to partly coat a plurality of particles of the active material or adhere to the surfaces of the plurality of particles of the active material, so that the graphene compounds make surface contact with the particles of the active material.

Here, the plurality of graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume and the electrode weight. That is, the charge and discharge capacity of the secondary battery can be increased.

Here, it is preferable that graphene oxide be used as the graphene compound and mixed with an active material to form a layer to be the active material layer and then reduction be performed. That is, the formed active material layer preferably contains reduced graphene oxide. When graphene oxide with extremely high dispersibility in a polar solvent is used to form the graphene compounds, the graphene compounds can be substantially uniformly dispersed in a region inside the active material layer. The solvent is removed by volatilization from a dispersion medium containing the uniformly dispersed graphene oxide to reduce the graphene oxide; hence, the graphene compounds remaining in the active material layer partly overlap with each other and are dispersed such that surface contact is made, thereby forming a three-dimensional conductive path. Note that graphene oxide may be reduced by heat treatment or with the use of a reducing agent, for example. Unlike a particulate conductive material such as acetylene black, which makes point contact with an active material, the graphene compound is capable of making low-resistance surface contact; accordingly, the electric conduction in the electrode can be improved with a smaller amount of the graphene compound than that of a normal conductive material. This can increase the proportion of the active material in the active material layer. Thus, the discharge capacity of the secondary battery can be increased.

### [Binder]

As the binder, for example, a rubber material such as styrene-butadiene rubber (SBR), styrene-isoprene-styrene rubber, acrylonitrile-butadiene rubber, butadiene rubber, or an ethylene-propylene-diene copolymer is preferably used. Alternatively, fluororubber can be used as the binder.

As the binder, for example, water-soluble polymers are preferably used. As the water-soluble polymers, a polysaccharide can be used, for example. As the polysaccharide, one or more selected from starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above-described rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), an ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, one or more selected from the above-mentioned polysaccharides, for instance, starch and cellulose derivatives such as carboxymethyl cellulose (CMC), methyl cellulose, ethyl cellulose, hydroxypropyl cellulose, diacetyl cellulose, and regenerated cellulose can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of an electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film be capable of conducting lithium ions while suppressing electric conduction.

The active material layer can be formed in the following manner: an active material, a binder, a conductive material, and a solvent are mixed to form slurry, the slurry is formed over a current collector, and the solvent is volatilized.

A solvent used for the slurry is preferably a polar solvent. For example, water, methanol, ethanol, acetone, tetrahydrofuran (THF), dimethylformamide (DMF), N-methylpyrrolidone (NMP), dimethyl sulfoxide (DMSO), or a mixed solution of two or more of the above can be used.

### [Current Collector]

For each of the positive electrode current collector and the negative electrode current collector, it is possible to use a material which has high conductivity and is not alloyed with carrier ions of lithium or the like, e.g., a metal such as stainless steel, gold, platinum, zinc, iron, copper, aluminum, or titanium, an alloy thereof, or the like. It is also possible to use an aluminum alloy to which an element that improves heat resistance, such as silicon, titanium, neodymium, scandium, or molybdenum, is added. Alternatively, a metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The thickness of the current collector is preferably larger than or equal to 10 μm and smaller than or equal to 30 μm.

Note that a material that is not alloyed with carrier ions of lithium or the like is preferably used for the negative electrode current collector.

As each of the current collectors, a titanium compound may be stacked over the above-described metal element. As a titanium compound, for example, it is possible to use one selected from titanium nitride, titanium oxide, titanium nitride in which oxygen is substituted for part of nitrogen, titanium oxide in which nitrogen is substituted for part of oxygen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

As each of the graphene 554 and the graphene 557, graphene or a graphene compound can be used.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. A graphene compound is preferably bent. A graphene compound may be rounded like carbon nanofiber.

In the positive electrode or the negative electrode of one embodiment of the present invention, graphene or a graphene compound can function as a conductive material. A plurality of sheets of graphene or graphene compounds form a three-dimensional conductive path in the positive electrode or the negative electrode and can increase the conductivity of the positive electrode or the negative electrode. Because the graphene or graphene compounds can cling to the particles in the positive electrode or the negative electrode, the breakage of the particles in the positive electrode or the negative electrode can be inhibited and the strength of the positive electrode or the negative electrode can be increased. The graphene or graphene compound has a thin sheet-like shape and can form the excellent conductive path even though occupying a small volume in the positive electrode or the negative electrode, whereby the volume of the active material in the positive electrode or the negative electrode can be increased. Therefore, the capacity of the secondary battery can be increased.

### [Separator]

The separator 507 can be formed using paper, nonwoven fabric, glass fiber, ceramics, or the like. Alternatively, the separator 507 can be formed using nylon (polyamide), vinylon (polyvinyl alcohol-based fiber), polyester, acrylic, polyolefin, polyurethane, polypropylene, polyethylene, or the like. The separator is preferably formed to have an envelope-like shape to wrap one of the positive electrode and the negative electrode.

For the separator 507, for example, a polymer film including polypropylene, polyethylene, polyimide, or the like can be used. Owing to its high wettability with respect to an ionic liquid, polyimide may be further preferable as a material of the separator 507.

A polymer film including polypropylene, polyethylene, or the like can be formed by a dry method or a wet method. The dry method is a method in which a polymer film including polypropylene, polyethylene, polyimide, or the like is stretched while being heated so that a space is formed between crystals, whereby a minute hole is formed. The wet method is a method in which a resin to which a solvent is mixed in advance is processed into a film and then the solvent is extracted, whereby a hole is formed. FIG. 12C1 shows an enlarged view of a region 507a as an example of the separator 507 (formed by the wet method). This example shows a structure in which a plurality of holes 582 are formed in a polymer film 581. FIG. 12C2 shows an enlarged view of a region 507b as another example of the separator 507 (formed by the dry method). This example shows a structure in which a plurality of holes 585 are formed in a polymer film 584.

After charging and discharging, the diameter of the hole in the separator may differ between a surface portion of a surface that faces the positive electrode and a surface portion of a surface that faces the negative electrode. In this specification and the like, a surface portion of the separator is preferably a region that is less than or equal to 5 μm, further preferably less than or equal to 3 μm from the surface, for example.

The separator may have a multilayer structure. For example, a structure in which two kinds of polymer materials are stacked may be employed.

For example, it is possible to employ a structure in which a polymer film including polypropylene, polyethylene, polyimide, or the like is coated with a ceramic-based material, a fluorine-based material, a polyamide-based material, a mixture thereof, or the like. Alternatively, for example, it is possible to employ a structure in which nonwoven fabric is coated with a ceramic-based material, a fluorine-based material, a polyamide-based material, a mixture thereof, or the like. Owing to its high wettability with respect to an ionic liquid, polyimide may be further preferable as a material used for coating.

Examples of the fluorine-based material include PVDF and polytetrafluoroethylene.

Examples of the polyamide-based material include nylon and aramid (meta-based aramid and para-based aramid).

### [Exterior Body]

For the exterior body included in the secondary battery, one or more selected from a resin material and metal materials such as aluminum, stainless steel, and titanium can be used, for example. A film-like exterior body can also be used. As the film, for example, it is possible to use a film having a three-layer structure in which a highly flexible metal thin film of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a highly flexible (bendable) battery, for example, an aluminum laminated film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

When a film-like exterior body is used as the exterior body of the secondary battery, a bendable secondary battery can be obtained. Accordingly, the secondary battery can be used while being bent.

In the case where the secondary battery is provided in an electronic device or the like, the exterior body of the secondary battery provided along a housing included in the electronic device changes its shape in accordance with expansion and contraction of the housing due to a temperature change, whereby a reduction in airtightness of the exterior body of the secondary battery can sometimes be inhibited.

Since the shape of the secondary battery can be changed, the secondary battery can be provided even in a limited space in the electronic device.

The thickness of the film-like exterior body is preferably smaller than or equal to 2 mm, further preferably smaller than or equal to 1 mm, still further preferably smaller than or equal to 500 μm, yet further preferably smaller than or equal to 300 am, yet still further preferably smaller than or equal to 200 μm, yet still further preferably smaller than or equal to 100 μm, yet still further preferably smaller than or equal to 70 μm. The thickness of the metal thin film included in the film-like exterior body is preferably smaller than or equal to 1 mm, further preferably smaller than or equal to 500 μm, still further preferably smaller than or equal to 300 μm, yet further preferably smaller than or equal to 200 μm, yet still further preferably smaller than or equal to 100 μm, yet still further preferably smaller than or equal to 70 μm, yet still further preferably smaller than or equal to 50 μm, yet still further preferably smaller than or equal to 30 μm, yet still further preferably smaller than or equal to 20 μm.

Since the film-like exterior body is thin, the volume of the secondary battery can be small. Accordingly, the area occupied by the secondary battery in the electronic device or the like can be small.

### <Projection and Depression of Exterior Body>

Here, the exterior body may have projections and depressions. For example, a film may be provided with projections. Examples of the film provided with projections include an embossed film and an accordion-folded film.

A metal film is easily embossed. Projections formed by embossing increase the surface area of the exterior body exposed to the outside air, for example, increase the ratio of the surface area to the area seen from above, leading to an excellent heat dissipation effect. In the projections formed on the front surface (or the back surface) of the film by embossing, an enclosed space whose inner volume is variable is formed with the film serving as part of a wall of a sealing structure. This enclosed space can be said to be formed because the projections of the film have an accordion structure. Note that embossing, which is a kind of pressing, is not necessarily employed and any method that allows formation of a relief on part of the film may be employed.

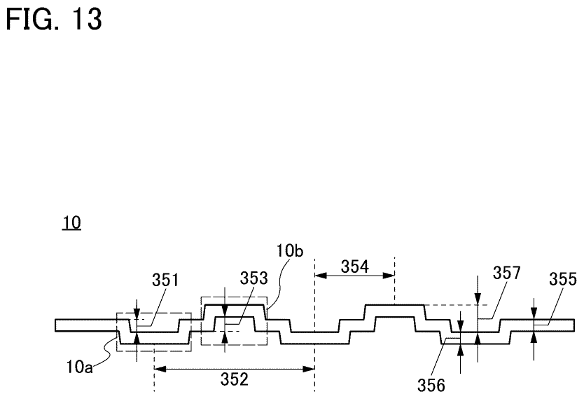

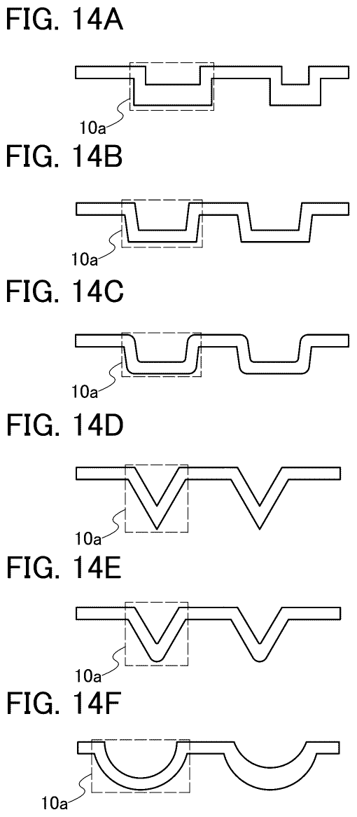

Next, the cross-sectional shapes of projections will be described with reference to FIG. 13 and FIG. 14.

As illustrated in FIG. 13, a projection 10a whose top portion points in a first direction and a projection 10b whose top portion points in a second direction are alternately arranged in a film 10. Here, the first direction is on one surface whereas the second direction is on the other surface. Note that the top portion in the first direction sometimes refers to the local maximum point in the case where the first direction is the positive direction. Similarly, the top portion in the second direction sometimes refers to the local maximum point in the case where the second direction is the positive direction.

The cross-sectional shape of each of the projection 10a and the projection 10b can be a hollow semicircular shape, a hollow semi-oval shape, a hollow polygonal shape, or a hollow irregular shape. In the case of a hollow polygonal shape, it is preferable that the polygon have more than six corners, in which case stress concentration at the corners can be reduced.

FIG. 13 illustrates a depth 351 of the projection 10a, a pitch 352 of the projection 10a, a depth 353 of the projection 10b, a distance 354 between the projection 10a and the projection 10b, a film thickness 355 of the film 10, and a bottom thickness 356 of the projection 10a. Here, a height 357 is the difference between the maximum height and the minimum height of the film surface.

Next, FIG. 14A to FIG. 14F illustrate various examples of the film 10 having the projection 10a.

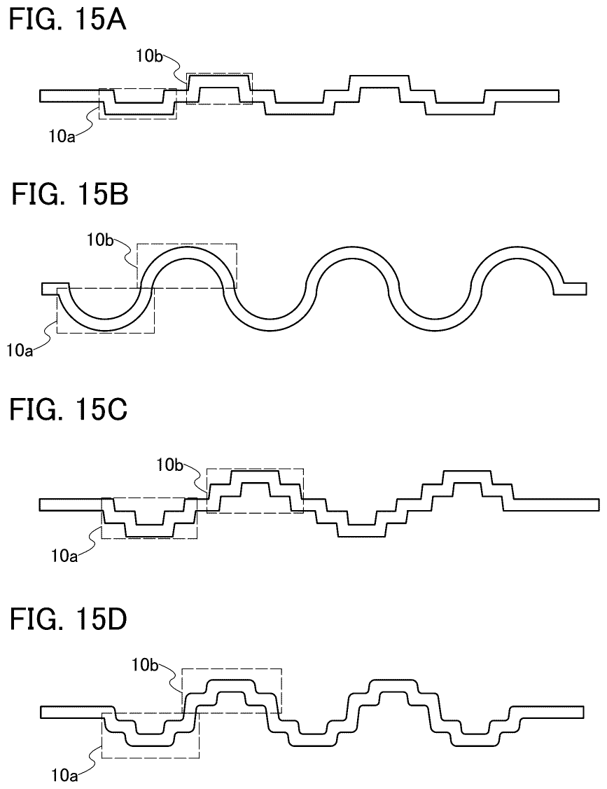

FIG. 15A to FIG. 15D illustrate various examples of the film 10 having the projection 10a and the projection 10b.

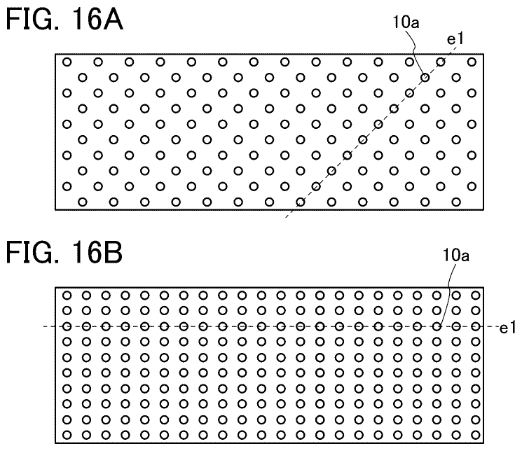

Next, the top surface shapes of projections will be described with reference to FIG. 16 to FIG. 19.

In a film illustrated in FIG. 16A, the projections 10a whose top portions are on one surface are arranged regularly. Here, a dashed line e1 indicating the direction in which the projections 10a are arranged is slanted to the sides of the film.

In a film illustrated in FIG. 16B, the projections 10a whose top portions are on one surface are arranged regularly. Here, the dashed line e1 indicating the direction in which the projections 10a are arranged is parallel to the long side of the film.

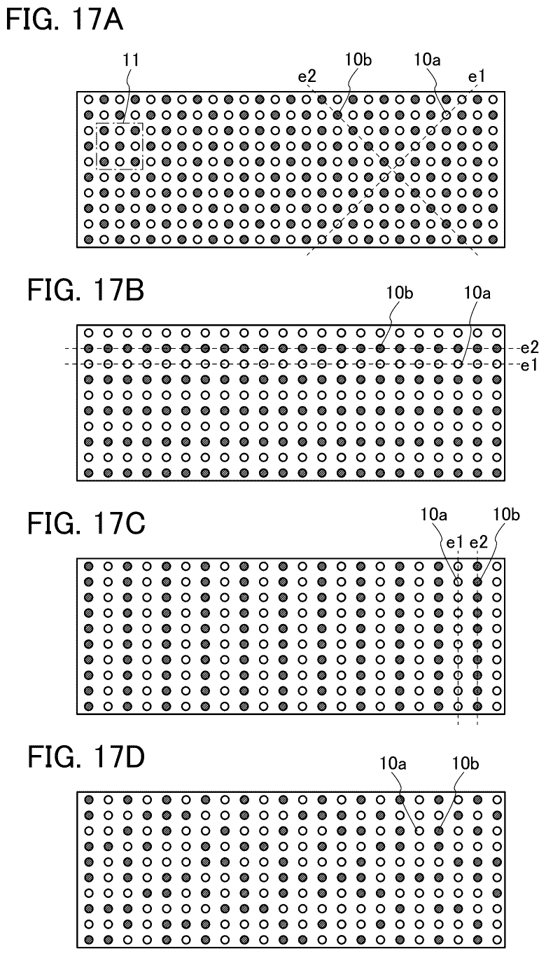

In a film illustrated in FIG. 17A, the projections 10a whose top portions are on one surface and the projections 10b whose top portions are on the other surface are arranged regularly. Here, the dashed line e1 indicating the direction in which the projections 10a are arranged and a dashed line e2 indicating the direction in which the projections 10b are arranged are slanted to the sides of the film, and the dashed line e1 and the dashed line e2 cross each other.

In a film illustrated in FIG. 17B, the projections 10a whose top portions are on one surface and the projections 10b whose top portions are on the other surface are arranged regularly. Here, the dashed line e1 indicating the direction in which the projections 10a are arranged and the dashed line e2 indicating the direction in which the projections 10b are arranged are parallel to the long side of the film.

In a film illustrated in FIG. 17C, the projections 10a whose top portions are on one surface and the projections 10b whose top portions are on the other surface are arranged regularly. Here, the dashed line e1 indicating the direction in which the projections 10a are arranged and the dashed line e2 indicating the direction in which the projections 10b are arranged are parallel to the short side of the film.

In a film illustrated in FIG. 17D, the projections 10a whose top portions are on one surface and the projections 10b whose top portions are on the other surface are arranged randomly.

Although the top surface shape of each of the projections illustrated in FIG. 16 and FIG. 17 is a circle, it is not limited to a circle. For example, the top surface shape may be a polygon or an irregular shape.

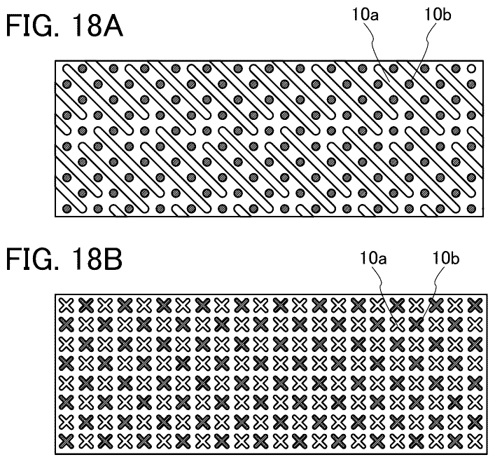

The projections 10a whose top portions are on one surface and the projections 10b whose top portions are on the other surface may have the same top surface shape as in the films illustrated in FIG. 17. Alternatively, the projections 10a whose top portions are on one surface and the projections 10b whose top portions are on the other surface may have different top surface shapes as illustrated in FIG. 18A.

In a film illustrated in FIG. 18A, the projections 10a have linear top surface shapes, and the projections 10b have circular top surface shapes. Note that each of the top surface shapes of the projections 10a may be a straight-line shape, a curve shape, a wave shape, a zigzag shape, or an irregular shape. Each of the top surface shapes of the projections 10b may be a polygon or an irregular shape.

Alternatively, the top surface shapes of the projections 10a and 10b may be cross shapes as illustrated in FIG. 18B.

With the top surface shapes illustrated in FIG. 16 to FIG. 18, stress due to bending in at least two directions can be relieved.

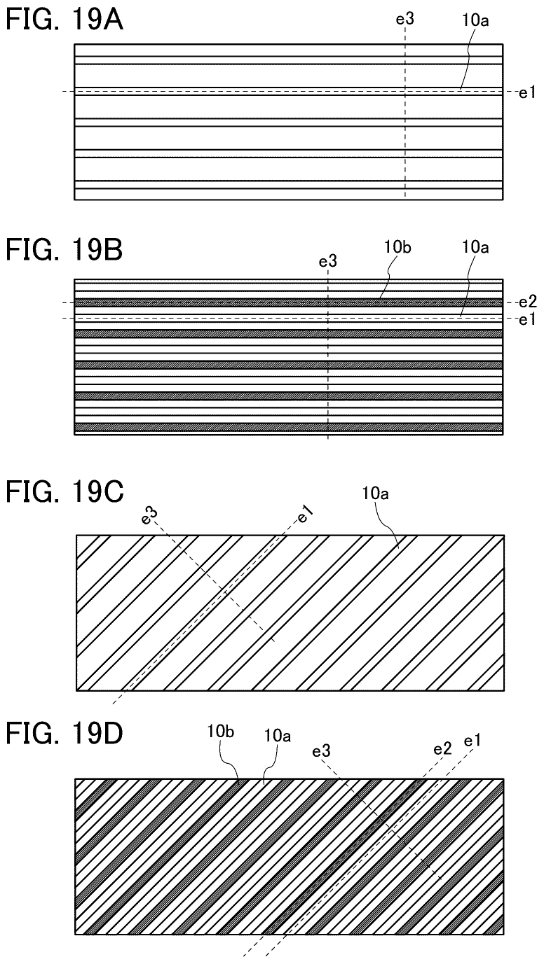

FIG. 19 illustrates examples of projections with linear top surface shapes. Note that the shapes illustrated in FIG. 19 are referred to as accordion structures in some cases. Cross sections taken along a dashed line e3 in FIG. 19A to FIG. 19D can be any of the cross sections illustrated in FIG. 13 to FIG. 15.

In a film illustrated in FIG. 19A, the linear projections 10a whose top portions are on one surface are arranged. Here, the dashed line e1 indicating the direction of the linear projections 10a is parallel to the sides of the film. In a film illustrated in FIG. 19B, the linear projections 10a whose top portions are on one surface and the linear projections 10b whose top portions are on the other surface are arranged alternately. Here, the dashed line e1 indicating the direction of the linear projections 10a and the dashed line e2 indicating the direction of the linear projections 10b are parallel to the sides of the film.

In a film illustrated in FIG. 19C, the linear projections 10a whose top portions are on one surface are arranged. Here, the dashed line e1 indicating the direction of the linear projections 10a is slanted to the sides of the film. In a film illustrated in FIG. 19D, the linear projections 10a whose top portions are on one surface and the linear projections 10b whose top portions are on the other surface are arranged alternately. Here, the dashed line e1 indicating the direction of the linear projections 10a and the dashed line e2 indicating the direction of the linear projections 10b are slanted to the sides of the film.

The exterior body of one embodiment of the present invention includes a plurality of projections and the depth of each of the projections is preferably less than or equal to 1 mm, further preferably greater than or equal to 0.15 mm and less than 0.8 mm, still further preferably greater than or equal to 0.3 mm and less than or equal to 0.7 mm.

The density of the projections per area is, for example, preferably greater than or equal to 0.02/mm² and less than or equal to 2/mm², further preferably greater than or equal to 0.05/mm² and less than or equal to 1/mm², still further preferably greater than or equal to 0.1/mm² and less than or equal to 0.5/mm².

This embodiment can be used in appropriate combination with any of the other embodiments.

### Embodiment 3

In this embodiment, an example of a secondary battery and an example of a method for fabricating the secondary battery will be described.

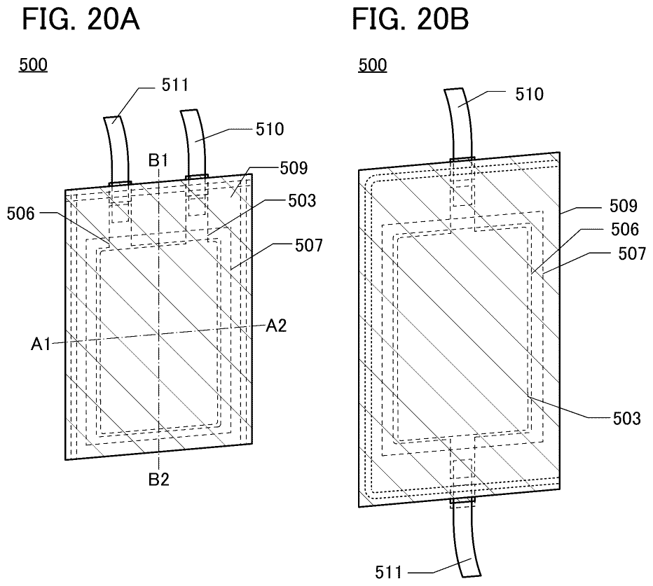

A secondary battery 500 illustrated in each of FIG. 20A and FIG. 20B includes the positive electrode 503, the negative electrode 506, the separator 507, an exterior body 509, a positive electrode lead electrode 510, and a negative electrode lead electrode 511.

In the secondary battery 500 illustrated in each of FIG. 20A and FIG. 20B, a sealing region is provided on three sides.

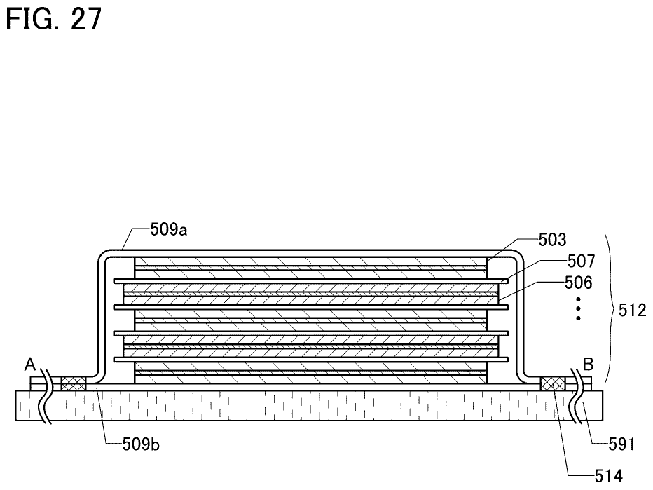

Note that as a cross-sectional structure of the laminated secondary battery illustrated in FIG. 20A or the like, for example, it is possible to employ a structure in which a stack including the positive electrodes, the separators, and the negative electrodes is surrounded by exterior bodies. As the cross-sectional structure of the laminated secondary battery illustrated in FIG. 20A or the like, for example, it is possible to employ a structure illustrated in FIG. 27 described later.

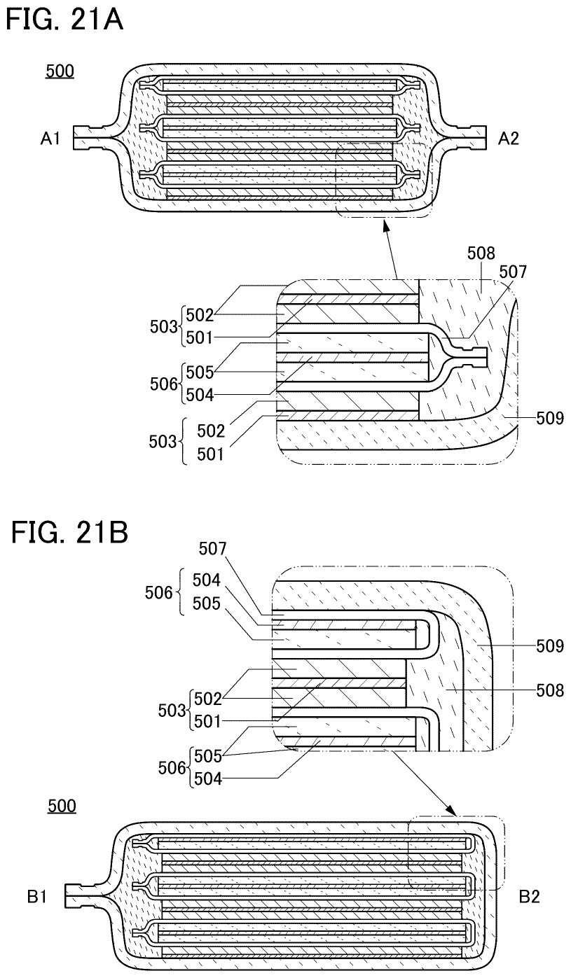

FIG. 21A illustrates an example of a cross-sectional view along the dashed-dotted line A1-A2 in FIG. 20A, and FIG. 21B illustrates an example of a cross-sectional view along the dashed-dotted line B1-B2.

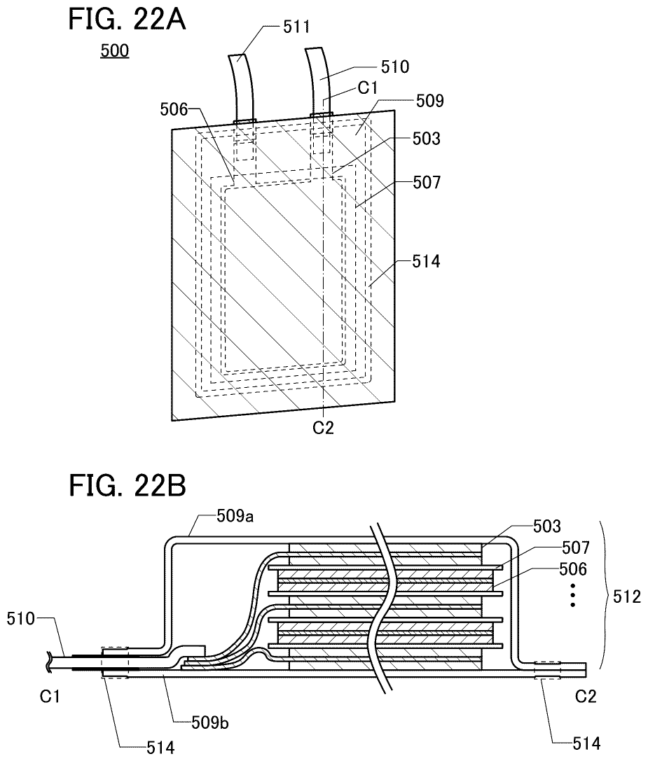

As illustrated in FIG. 22A, a region 514 sealing the exterior body 509 may be provided on the four sides of the secondary battery 500.

FIG. 22B illustrates an example of a cross-sectional view along the dashed-dotted line C1-C2 in FIG. 22A. For easy viewing of the drawings, the sizes are not accurately expressed in some cases in a plurality of corresponding drawings.

### <Method 1 for Fabricating Laminated Secondary Battery>

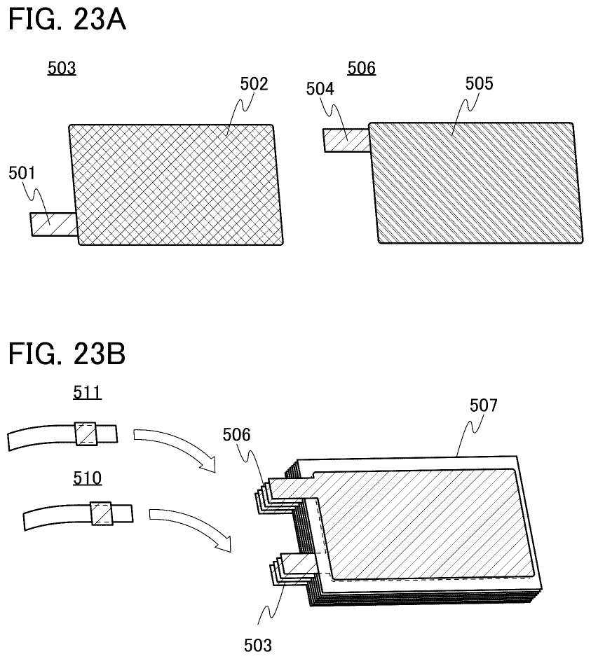

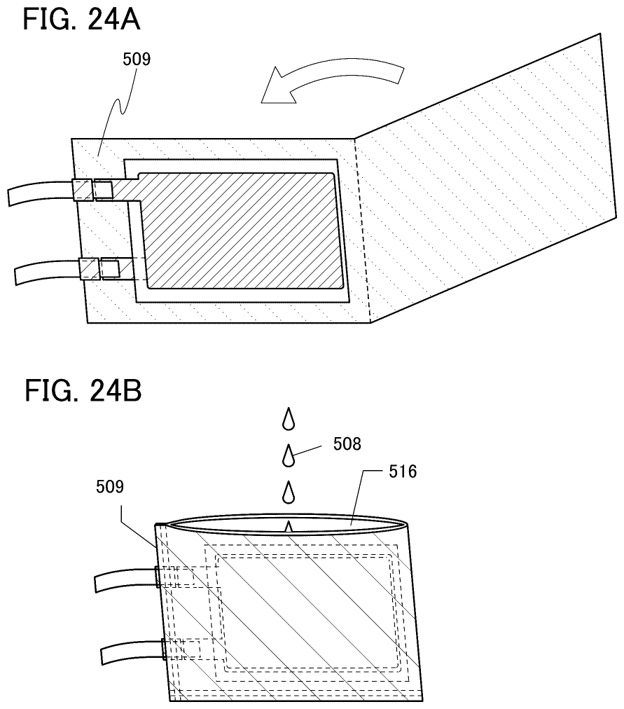

Here, an example of a method for fabricating the laminated secondary battery whose external view is shown in FIG. 20A, FIG. 20B, and the like will be described with reference to FIG. 23A and FIG. 23B and FIG. 24A and FIG. 24B.

First, the positive electrode 503, the negative electrode 506, and the separator 507 are prepared. FIG. 23A illustrates examples of the positive electrode 503 and the negative electrode 506. The positive electrode 503 includes the positive electrode active material layer 502 over the positive electrode current collector 501. The positive electrode 503 preferably includes a tab region where the positive electrode current collector 501 is exposed. The negative electrode 506 includes the negative electrode active material layer 505 over the negative electrode current collector 504. The negative electrode 506 preferably includes a tab region where the negative electrode current collector 504 is exposed.

Next, the negative electrode 506, the separator 507, and the positive electrode 503 are stacked. FIG. 23B illustrates the negative electrodes 506, the separators 507, and the positive electrodes 503 that are stacked. Here, an example in which 5 negative electrodes and 4 positive electrodes are used is illustrated. This component can also be referred to as a stack including the negative electrodes, the separators, and the positive electrodes.

Then, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 511 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line as illustrated in FIG. 24A. Then, the outer edges of the exterior body 509 are bonded to each other. The bonding is performed by thermocompression bonding, for example. At this time, an unbonded region (hereinafter, referred to as an inlet 516) is provided for part (or one side) of the exterior body 509 so that the electrolyte 508 can be introduced later.

Next, as illustrated in FIG. 24B, the electrolyte 508 is introduced into the exterior body 509 from the inlet 516 of the exterior body 509. The electrolyte 508 is preferably introduced in a reduced-pressure atmosphere or in an inert atmosphere. Lastly, the inlet 516 is bonded. In the above manner, the laminated secondary battery 500 can be fabricated.

In the above, the positive electrode lead electrode 510 and the negative electrode lead electrode 511 are drawn from the same side to the outside of the exterior body, so that the secondary battery 500 illustrated in FIG. 20A is fabricated. The secondary battery 500 illustrated in FIG. 20B can also be fabricated by drawing the positive electrode lead electrode 510 and the negative electrode lead electrode 511 from opposite sides to the outside of the exterior body.

### <Method 2 for Fabricating Laminated Secondary Battery>

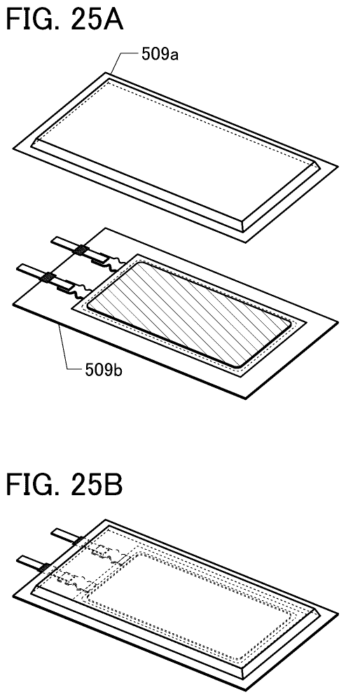

The secondary battery 500 illustrated in FIG. 22A can be fabricated in the following manner as illustrated in FIG. 25A: an exterior body 509a and an exterior body 509b overlap with each other, a stack including a plurality of the positive electrodes 503, a plurality of the separators 507, and a plurality of the negative electrodes 506 is provided between the exterior body 509a and the exterior body 509b, and the four sides of the exterior body 509a and the exterior body 509b that overlap with each other are sealed. When the exterior body 509a has a depression, the stack can be stored in a projection. FIG. 25B is a perspective view of the secondary battery 500.

As a method for introducing the electrolyte and a method for sealing the exterior bodies, for example, three sides among the four sides of the exterior body 509a and the exterior body 509b are sealed, the electrolyte is introduced, and then the remaining one side is sealed. Alternatively, as described later, the four sides of the exterior body 509a and the exterior body 509b can be sealed after the injection of the electrolyte. For example, a solution containing an ionic liquid and a salt containing carrier ions is used as the electrolyte, and the electrolyte is introduced by dripping the solution.

After the introduction of the electrolyte, impregnation treatment for facilitating impregnation of pores of the electrodes and the separators with the electrolyte may be performed. As the impregnation treatment, decompression treatment (also referred to as evacuation to a vacuum) is preferably performed, and the decompression treatment may be performed a plurality of times. In the case where an electrolyte containing an ionic liquid is used as the electrolyte, the environmental pressure (a pressure value read by a differential pressure gauge) in the decompression treatment can be lower than or equal to −60 kPa.

The environmental pressure in the decompression treatment is preferably lower than or equal to −80 kPa or lower than or equal to −100 kPa. The sealing of the exterior bodies can be performed at the same environmental pressure as the decompression treatment. Alternatively, the sealing may be performed at the environmental pressure different from that in the decompression treatment; for example, the decompression treatment can be performed at an environmental pressure of −100 kPa and the sealing of the exterior bodies can be performed in a pressure environment of −80 kPa.

In the case where stainless steel is used for a metal thin film of the exterior body used for the secondary battery 500 illustrated in FIG. 20A, FIG. 20B, and FIG. 22A, the strength of the exterior body can be higher than that in the case of using aluminum. However, stainless steel is a hard material and thus does not easily follow the shapes of the lead electrodes in some cases, which sometimes makes it difficult to bond the lead electrodes and the exterior body without any space. In such a case, for example, a resin layer is preferably formed thickly around the lead electrodes. A thermal welding resin layer can be used as the resin layer. Alternatively, an ultraviolet curable resin, a thermosetting resin, or the like may be used as the resin layer.

### <Method 3 for Fabricating Laminated Secondary Battery>

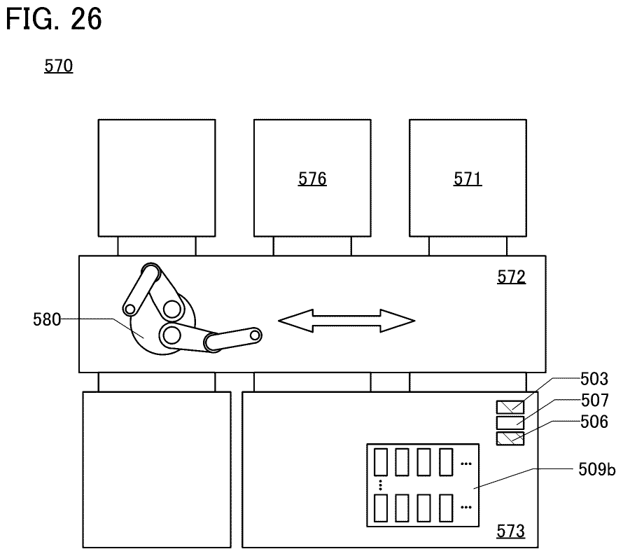

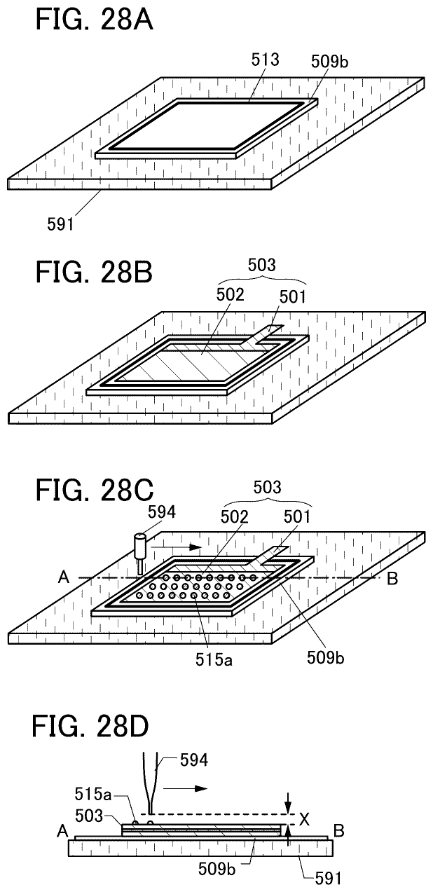

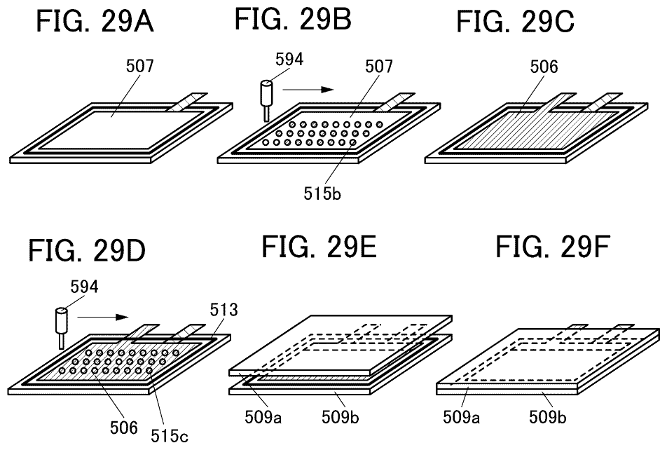

Another example of the method for fabricating the laminated secondary battery 500 whose external view is illustrated in FIG. 22A will be described with reference to FIG. 26, FIG. 27, FIG. 28A to FIG. 28D, and FIG. 29A to FIG. 29F. The secondary battery 500 illustrated in FIG. 25 includes the positive electrode 503, the negative electrode 506, the separator 507, the exterior body 509, the positive electrode lead electrode 510, and the negative electrode lead electrode 511. The exterior body 509 is sealed in the region 514.

The laminated secondary battery 500 can be fabricated using a manufacturing apparatus illustrated in FIG. 26, for example. A manufacturing apparatus 570 illustrated in FIG. 26 includes a component introduction chamber 571, a transfer chamber 572, a processing chamber 573, and a component extraction chamber 576. A structure can be employed in which each chamber is connected to a variety of exhaust mechanisms depending on usage. Alternatively, a structure can be employed in which each chamber is connected to a variety of gas supply mechanisms depending on usage. An inert gas is preferably supplied into the manufacturing apparatus 570 to inhibit entry of impurities into the manufacturing apparatus 570. Note that a gas that has been highly purified by a gas purifier before introduction into the manufacturing apparatus 570 is preferably used as the gas supplied into the manufacturing apparatus 570. The component introduction chamber 571 is a chamber for introducing the positive electrode, the separator, the negative electrode, the exterior body, and the like into the chambers such as the transfer chamber 572 and the processing chamber 573 in the manufacturing apparatus 570. The transfer chamber 572 includes a transfer mechanism 580. The processing chamber 573 includes a stage and an electrolyte dripping mechanism. The component extraction chamber 576 is a chamber for extracting the fabricated secondary battery to the outside of the manufacturing apparatus 570.

A procedure for fabricating the laminated secondary battery 500 is as follows.

First, the exterior body 509b is placed over a stage 591 in the processing chamber 573, a frame-like resin layer 513 is formed over the exterior body 509b, and then the positive electrode 503 is placed over the exterior body 509b (FIG. 28A and FIG. 28B). Next, an electrolyte 515a is dripped on the positive electrode 503 from a nozzle 594 (FIG. 28C and FIG. 28D). FIG. 28D is a cross-sectional view taken along the dashed-dotted line A-B in FIG. 28C. Note that to avoid complexity of the drawing, the stage 591 is not illustrated in some cases. As a dripping method, any one of a dispensing method, a spraying method, an inkjet method, and the like can be used, for example. In addition, an ODF (One Drop Fill) method can be used for dripping the electrolyte.

With movement of the nozzle 594, the electrolyte 515a can be dripped on the entire surface of the positive electrode 503. Alternatively, with movement of the stage 591, the electrolyte 515a may be dripped on the entire surface of the positive electrode 503.

It is preferable to drip the electrolyte from a position whose shortest distance from a surface where the electrolyte is dripped is greater than 0 mm and less than or equal to 1 mm.

The viscosity of the electrolyte dripped from the nozzle or the like is preferably adjusted as appropriate. When the viscosity of the whole electrolyte falls within the range of 0.3 mPa·s to 1000 mPa·s at room temperature (25° C.), the electrolyte can be dripped from the nozzle. After the electrolyte is dripped, the impregnation treatment described in Method 2 for fabricating laminated secondary battery may be performed.

Note that the electrolyte may be dripped all at a time or in a plurality of steps. In the case where the electrolyte is dripped in a plurality of steps, the impregnation treatment can be performed between the plurality of dripping steps. For example, the dripping steps and the decompression steps can be repeated a plurality of times.

Since the viscosity of the electrolyte changes depending on the temperature of the electrolyte, the temperature of the electrolyte to be dripped is preferably adjusted as appropriate. The temperature of the electrolyte is preferably higher than or equal to the melting point and lower than or equal to the boiling point and flash point of the electrolyte.

Then, the separator 507 is placed over the positive electrode 503 to overlap with the entire surface of the positive electrode 503 (FIG. 29A). Next, an electrolyte 515b is dripped on the separator 507 using the nozzle 594 (FIG. 29B). Then, the negative electrode 506 is placed over the separator 507 (FIG. 29C). The negative electrode 506 is placed to overlap with the separator 507 so that it does not protrude from the separator 507 in a top view. Next, an electrolyte 515c is dripped on the negative electrode 506 using the nozzle 594 (FIG. 29D). After that, the stacks including the positive electrodes 503, the separators 507, and the negative electrodes 506 are further stacked, so that a stack 512 illustrated in FIG. 27 can be formed. Next, the positive electrodes 503, the separators 507, and the negative electrodes 506 are sealed with the exterior body 509a and the exterior body 509b (FIG. 29E and FIG. 29F).

In FIG. 27, the positive electrode and the negative electrode are placed such that the separator is sandwiched between the positive electrode active material layer and the negative electrode active material layer. Note that in the secondary battery of one embodiment of the present invention, a region where the positive electrode active material layer and the negative electrode active material layer do not face each other is preferably small or not provided. In the case where the electrolyte contains an ionic liquid and a region where the negative electrode active material layer and the positive electrode active material layer do not face each other is provided, the charge and discharge efficiency of the secondary battery might decrease. Thus, in the secondary battery of one embodiment of the present invention, an end portion of the positive electrode active material layer and an end portion of the negative electrode active material layer are preferably aligned with each other to the utmost, for example. Therefore, the areas of the positive electrode active material layer and the negative electrode active material layer are preferably equal to each other when seen from above. Alternatively, the end portion of the positive electrode active material layer is preferably located inward from the end portion of the negative electrode active material layer.

Multiple formation can be performed by placing a plurality of the stacks 512 on the exterior body 509b. The stacks 512 are each sealed with the exterior bodies 509a and 509b in the region 514 such that the active material layers are surrounded, and then the stacks 512 are divided outside the regions 514, whereby a plurality of secondary batteries can be individually separated.

In sealing, first, the frame-like resin layer 513 is formed over the exterior body 509b. Then, at least part of the resin layer 513 is irradiated with light under reduced pressure, so that at least part of the resin layer 513 is cured. Next, the sealing is performed in the region 514 by thermocompression bonding or welding under atmospheric pressure. Alternatively, it is possible that the sealing by light irradiation is not performed and only the sealing by thermocompression bonding or welding is performed.

Although FIG. 25 illustrates an example in which four sides of the exterior body 509 are sealed (sometimes referred to as four-side sealing), three sides may be sealed (sometimes referred to as three-side sealing) as illustrated in FIG. 20A and FIG. 20B.

Through the above process, the laminated secondary battery 500 can be fabricated.

### <Another Secondary Battery 1 and Fabrication Method Thereof>

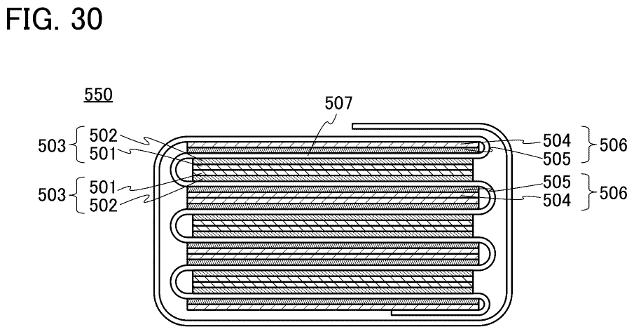

FIG. 30 illustrates an example of a cross-sectional view of a stack of one embodiment of the present invention. A stack 550 illustrated in FIG. 30 is formed by placing one folded separator between the positive electrodes and the negative electrodes.

In the stack 550, one separator 507 is folded a plurality of times to be sandwiched between the positive electrode active material layers 502 and the negative electrode active material layers 505. Since six positive electrodes 503 and six negative electrodes 506 are stacked in FIG. 30, the separator 507 is folded at least five times. The separator 507 is provided to be sandwiched between the positive electrode active material layers 502 and the negative electrode active material layers 505 and to have an extending portion folded such that the plurality of positive electrodes 503 and the plurality of negative electrodes 506 may be bound together with a tape or the like.

After the positive electrode 503 is placed, an electrolyte can be dripped on the positive electrode 503 in the method for fabricating the secondary battery of one embodiment of the present invention. Similarly, after the negative electrode 506 is placed, an electrolyte can be dripped on the negative electrode 506. In the method for fabricating the secondary battery of one embodiment of the present invention, an electrolyte can be dripped on the separator 507 before the separator is folded or after the folded separator 507 overlaps with the negative electrode 506 or the positive electrode 503. When an electrolyte is dripped on at least one of the negative electrode 506, the separator 507, and the positive electrode 503, the negative electrode 506, the separator 507, or the positive electrode 503 can be impregnated with the electrolyte.

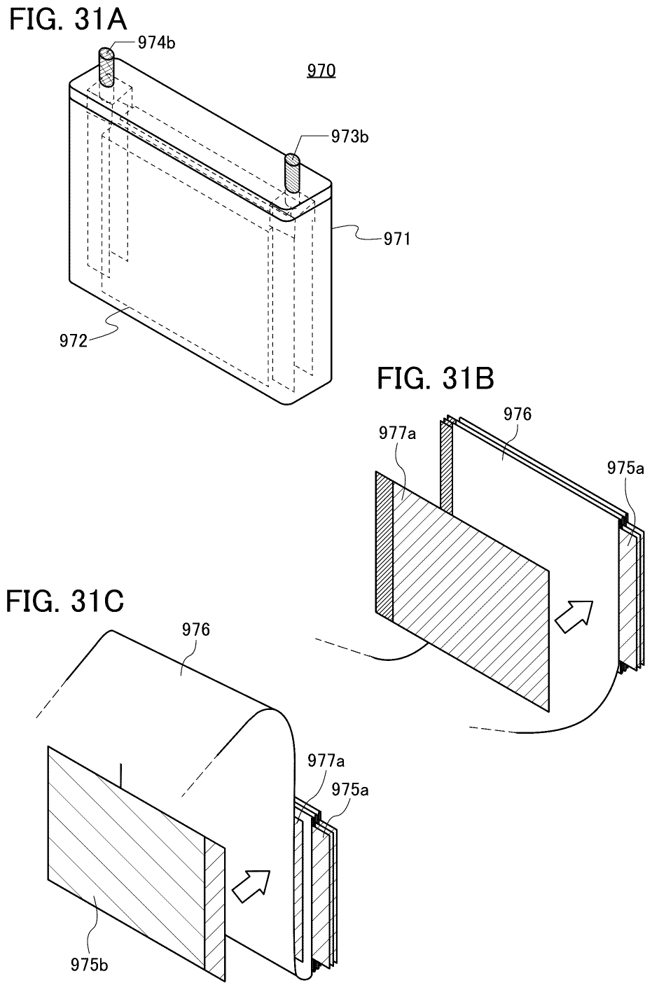

A secondary battery 970 illustrated in FIG. 31A includes a stack 972 inside a housing 971. A terminal 973b and a terminal 974b are electrically connected to the stack 972. At least part of the terminal 973b and at least part of the terminal 974b are exposed to the outside of the housing 971.

The stack 972 can have a stacked-layer structure of a positive electrode, a negative electrode, and a separator. Alternatively, the stack 972 can have a structure in which a positive electrode, a negative electrode, and a separator are wound, for example.

As the stack 972, the stack having the structure illustrated in FIG. 30 in which the separator is folded can be used, for example.

An example of a method for forming the stack 972 will be described with reference to FIG. 31B and FIG. 31C.

First, as illustrated in FIG. 31B, a belt-like separator 976 overlaps with a positive electrode 975a, and a negative electrode 977a overlaps with the positive electrode 975a with the separator 976 therebetween. After that, the separator 976 is folded to overlap with the negative electrode 977a. Next, as illustrated in FIG. 31C, a positive electrode 975b overlaps with the negative electrode 977a with the separator 976 therebetween. In this manner, the positive electrodes and the negative electrodes are sequentially placed with the folded separator therebetween, whereby the stack 972 can be formed. A structure including the stack formed in the above manner is sometimes referred to as a “zigzag structure”.

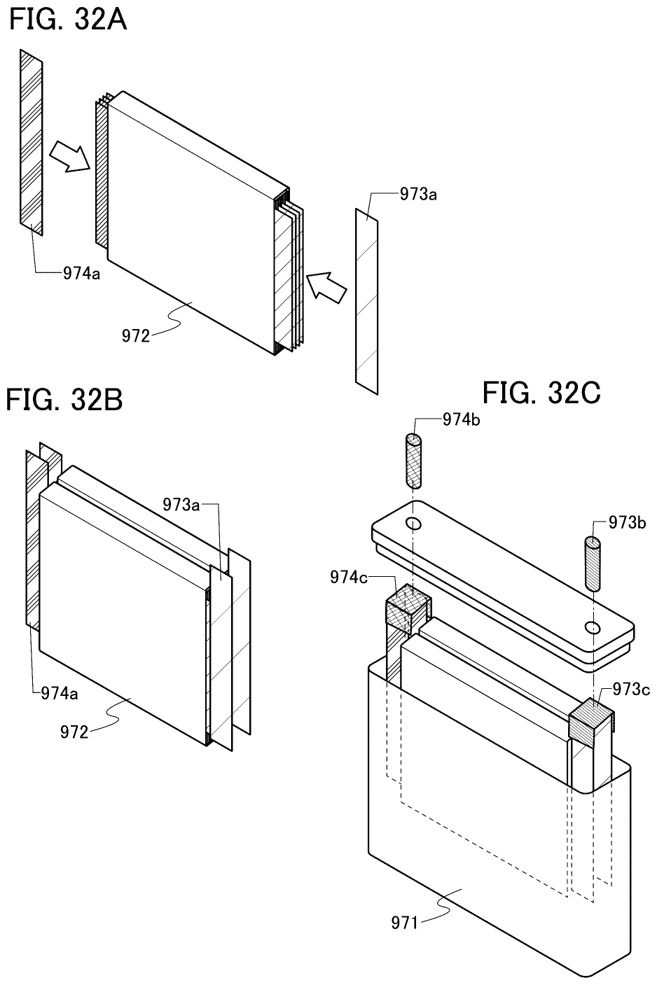

Next, an example of a method for fabricating the secondary battery 970 will be described with reference to FIG. 32A to FIG. 32C.

First, as illustrated in FIG. 32A, a positive electrode lead electrode 973a is electrically connected to the positive electrodes included in the stack 972. Specifically, for example, the positive electrodes included in the stack 972 are provided with tab regions, and the tab regions and the positive electrode lead electrode 973a can be electrically connected to each other by welding or the like. In addition, a negative electrode lead electrode 974a is electrically connected to the negative electrodes included in the stack 972.

One stack 972 may be placed inside the housing 971 or a plurality of the stacks 972 may be placed inside the housing 971. FIG. 32B illustrates an example of preparing two stacks 972.

Next, as illustrated in FIG. 32C, the prepared stacks 972 are stored in the housing 971, and the terminal 973b and the terminal 974b are inserted to seal the housing 971. It is preferable to electrically connect a conductor 973c to each of the positive electrode lead electrodes 973a included in the plurality of stacks 972. In addition, it is preferable to electrically connect a conductor 974c to each of the negative electrode lead electrodes 974a included in the plurality of stacks 972. The terminal 973b and the terminal 974b are electrically connected to the conductor 973c and the conductor 974c, respectively. Note that the conductor 973c may include a conductive region and an insulating region. In addition, the conductor 974c may include a conductive region and an insulating region.

For the housing 971, a metal material (e.g., aluminum) can be used. In the case where a metal material is used for the housing 971, the surface is preferably coated with a resin or the like. Alternatively, a resin material can be used for the housing 971.

The housing 971 is preferably provided with a safety valve, an overcurrent protection element, or the like. A safety valve is a valve for releasing a gas, in order to prevent the battery from exploding, when the pressure inside the housing 971 reaches a predetermined pressure.

### <Another Secondary Battery 2 and Fabrication Method Thereof>

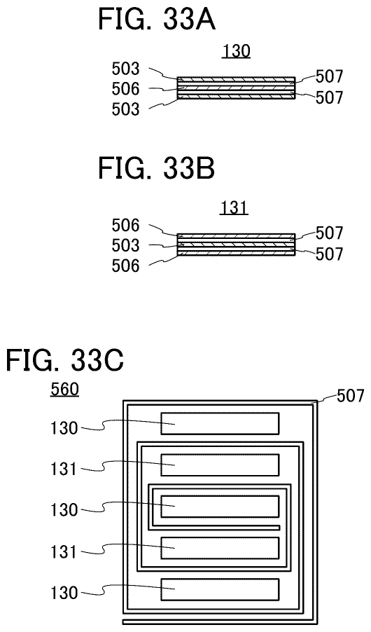

FIG. 33C illustrates an example of a cross-sectional view of a secondary battery of another embodiment of the present invention. A secondary battery 560 illustrated in FIG. 33C is fabricated using stacks 130 illustrated in FIG. 33A and stacks 131 illustrated in FIG. 33B. In FIG. 33C, the stacks 130, the stacks 131, and the separator 507 are selectively illustrated for the sake of clarity of the drawing.

As illustrated in FIG. 33A, in the stack 130, the positive electrode 503 including the positive electrode active material layers on both surfaces of the positive electrode current collector, the separator 507, the negative electrode 506 including the negative electrode active material layers on both surfaces of the negative electrode current collector, the separator 507, and the positive electrode 503 including the positive electrode active material layers on both surfaces of the positive electrode current collector are stacked in this order.

As illustrated in FIG. 33B, in the stack 131, the negative electrode 506 including the negative electrode active material layers on both surfaces of the negative electrode current collector, the separator 507, the positive electrode 503 including the positive electrode active material layers on both surfaces of the positive electrode current collector, the separator 507, and the negative electrode 506 including the negative electrode active material layers on both surfaces of the negative electrode current collector are stacked in this order.

The method for fabricating the secondary battery of one embodiment of the present invention can be utilized for forming the stacks. Specifically, in order to form the stacks, an electrolyte is dripped on at least one of the negative electrode 506, the separator 507, and the positive electrode 503 at the time of stacking the negative electrode 506, the separator 507, and the positive electrode 503. Dripping a plurality of drops of the electrolyte enables the negative electrode 506, the separator 507, or the positive electrode 503 to be impregnated with the electrolyte.

As illustrated in FIG. 33C, the plurality of stacks 130 and the plurality of stacks 131 are covered with the wound separator 507.

After the stacks 130 are placed, an electrolyte can be dripped on the stacks 130 in the method for fabricating the secondary battery of one embodiment of the present invention. Similarly, after the stacks 131 are placed, an electrolyte can be dripped on the stacks 131. Moreover, an electrolyte can be dripped on the separator 507 before the separator 507 is folded or after the folded separator 507 overlaps with the stacks. Dripping a plurality of drops of the electrolyte enables the stacks 130, the stacks 131, or the separator 507 to be impregnated with the electrolyte.

### <Another Secondary Battery 3 and Fabrication Method Thereof>

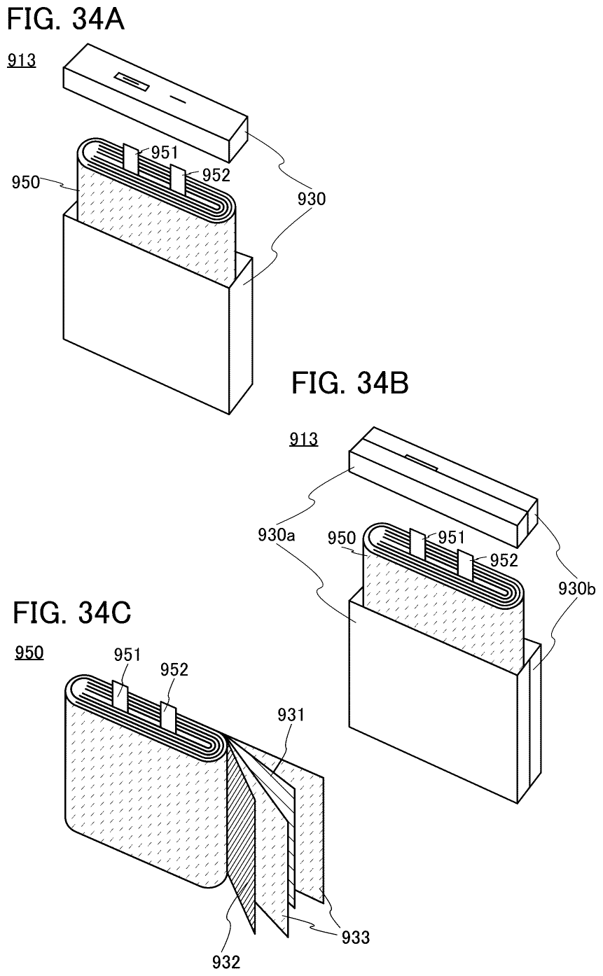

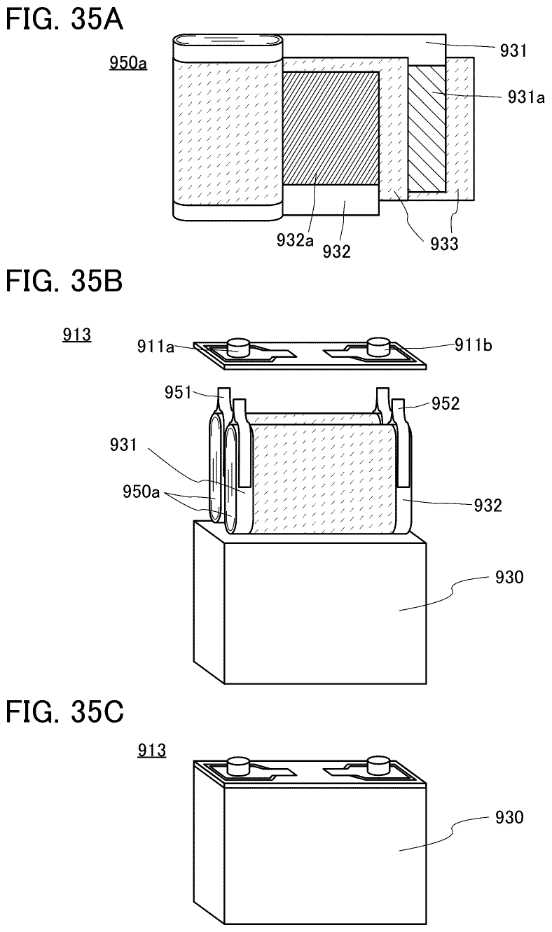

A secondary battery of another embodiment of the present invention will be described with reference to FIG. 34 and FIG. 35. The secondary battery described here can be referred to as a wound secondary battery or the like.

A secondary battery 913 illustrated in FIG. 34A includes a wound body 950 provided with a terminal 951 and a terminal 952 inside a housing 930. The wound body 950 is immersed in an electrolyte inside the housing 930. The terminal 952 is in contact with the housing 930. The use of an insulator or the like inhibits contact between the terminal 951 and the housing 930. Note that in FIG. 34A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 34B, the housing 930 illustrated in FIG. 34A may be formed using a plurality of materials. For example, in the secondary battery 913 illustrated in FIG. 34B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

Furthermore, FIG. 34C illustrates the structure of the wound body 950. The wound body 950 includes a negative electrode 931, a positive electrode 932, and separators 933. The wound body 950 is a wound body obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

At the time of stacking the negative electrode 931, the separator 933, and the positive electrode 932 in the method for fabricating the secondary battery of one embodiment of the present invention, an electrolyte is dripped on at least one of the negative electrode 931, the separator 933, and the positive electrode 932. That is, an electrolyte is preferably dripped before the sheet of the stack is wound. Dripping a plurality of drops of the electrolyte enables the negative electrode 931, the separator 933, or the positive electrode 932 to be impregnated with the electrolyte.

As illustrated in FIG. 35, the secondary battery 913 may include a wound body 950a. The wound body 950a illustrated in FIG. 35A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 35B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 35C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is temporarily released when the internal pressure of the housing 930 exceeds a predetermined internal pressure.

As illustrated in FIG. 35B, the secondary battery 913 may include a plurality of the wound bodies 950a. The use of the plurality of wound bodies 950a enables the secondary battery 913 to have higher charge and discharge capacity.

### <Bendable Secondary Battery>

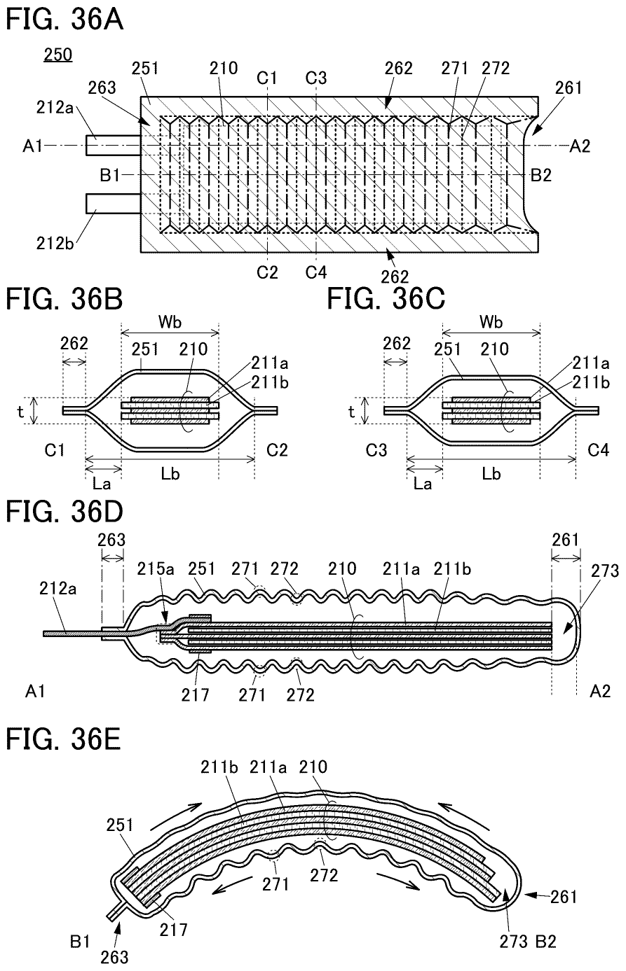

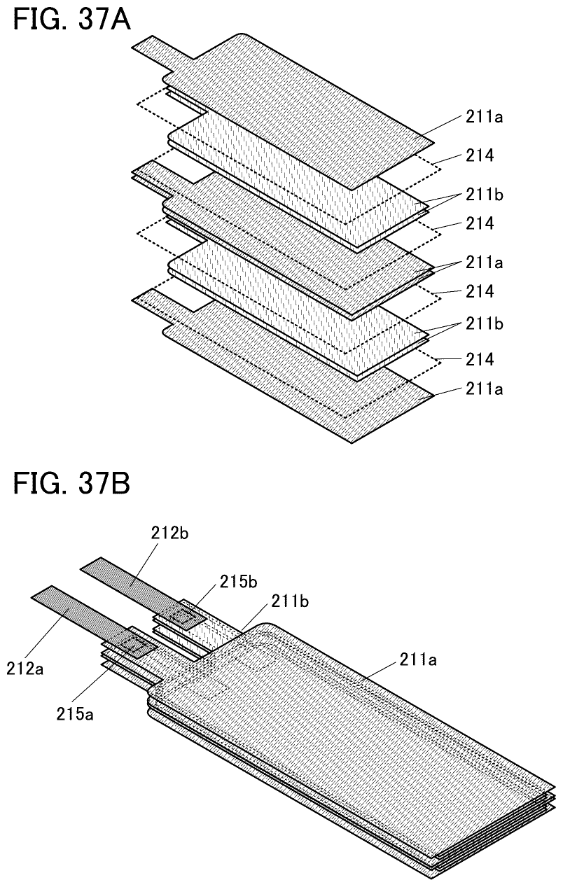

Next, an example of a bendable secondary battery will be described with reference to FIG. 36 and FIG. 37.

FIG. 36A is a schematic top view of a bendable secondary battery 250. FIG. 36B, FIG. 36C, and FIG. 36D are schematic cross-sectional views along the cutting line C1-C2, the cutting line C3-C4, and the cutting line A1-A2, respectively, in FIG. 36A. The secondary battery 250 includes an exterior body 251 and an electrode stack 210 held in the exterior body 251. The electrode stack 210 includes at least a positive electrode 211a and a negative electrode 211b. The positive electrode 211a and the negative electrode 211b are collectively referred to as the electrode stack 210. A lead 212a electrically connected to the positive electrode 211a and a lead 212b electrically connected to the negative electrode 211b extend to the outside of the exterior body 251. In the electrode stack 210, a separator is preferably placed between the positive electrode 211a and the negative electrode 211b. Alternatively, a solid electrolyte layer may be placed between the positive electrode 211a and the negative electrode 211b. The solid electrolyte layer preferably has flexibility. The solid electrolyte layer is preferably flexible. In addition to the positive electrode 211a and the negative electrode 211b, an electrolyte (not illustrated) is enclosed in a region surrounded by the exterior body 251. As the electrolyte, a gel electrolyte can also be used.

The positive electrode 211a and the negative electrode 211b included in the secondary battery 250 are described with reference to FIG. 37. FIG. 37A is a perspective view illustrating the stacking order of the positive electrode 211a, the negative electrode 211b, and a separator 214. FIG. 37B is a perspective view illustrating the lead 212a and the lead 212b in addition to the positive electrode 211a and the negative electrode 211b.

As illustrated in FIG. 37A, the secondary battery 250 includes a plurality of the strip-shaped positive electrodes 211a, a plurality of the strip-shaped negative electrodes 211b, and a plurality of the separators 214. The positive electrode 211a and the negative electrode 211b each include a projected tab portion and a portion other than the tab. A positive electrode active material layer is formed on one surface of the positive electrode 211a other than the tab, and a negative electrode active material layer is formed on one surface of the negative electrode 211b other than the tab.

The positive electrodes 211a and the negative electrodes 211b are stacked such that surfaces of the positive electrodes 211a on each of which the positive electrode active material layer is not formed are in contact with each other and that surfaces of the negative electrodes 211b on each of which the negative electrode active material is not formed are in contact with each other.

Furthermore, the separator 214 is provided between the surface of the positive electrode 211a on which the positive electrode active material is formed and the surface of the negative electrode 211b on which the negative electrode active material is formed. In FIG. 37A and FIG. 37B, the separator 214 is shown by a dotted line for easy viewing.

Moreover, as illustrated in FIG. 37B, the plurality of positive electrodes 211a are electrically connected to the lead 212a in a bonding portion 215a. The plurality of negative electrodes 211b are electrically connected to the lead 212b in a bonding portion 215b.

Next, the exterior body 251 will be described with reference to FIG. 36B to FIG. 36E.

The exterior body 251 has a film-like shape and is folded in half so as to sandwich the positive electrodes 211a and the negative electrodes 211b. The exterior body 251 includes a folded portion 261, a pair of seal portions 262, and a seal portion 263. The pair of seal portions 262 is provided with the positive electrodes 211a and the negative electrodes 211b positioned therebetween and thus can also be referred to as side seals. The seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. The seal portions 262 and the seal portion 263 of the exterior body 251 are preferably flat.

FIG. 36B illustrates a cross section along the part overlapping with the crest line 271, and FIG. 36C illustrates a cross section along the part overlapping with the trough line 272. FIG. 36B and FIG. 36C correspond to cross sections of the secondary battery 250, the positive electrodes 211a, and the negative electrodes 211b in the width direction.

Here, the distance between end portions of the positive electrode 211a and the negative electrode 211b in the width direction and the seal portion 262, that is, the distance between the end portions of the positive electrode 211a and the negative electrode 211b and the seal portion 262 is referred to as a distance La. When the secondary battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, the metal film might be corroded by the electrolyte solution. Therefore, the distance La is preferably set as long as possible. However, if the distance La is too long, the volume of the secondary battery 250 is increased.

Furthermore, the distance La between the positive electrode 211a and the negative electrode 211b, and the seal portion 262 is preferably increased as the total thickness of the positive electrode 211a and the negative electrode 211b that are stacked is increased.

Specifically, when the total thickness of the stacked positive electrodes 211a, negative electrodes 211b, and separators 214 (not illustrated) is t, the distance La is preferably 0.8 times or more and 3.0 times or less, further preferably 0.9 times or more and 2.5 times or less, still further preferably 1.0 times or more and 2.0 times or less as large as the thickness t. Alternatively, the distance La is preferably 0.8 times or more and 2.5 times or less as large as the thickness t. Alternatively, the distance La is preferably 0.8 times or more and 2.0 times or less as large as the thickness t. Alternatively, the distance La is preferably 0.9 times or more and 3.0 times or less as large as the thickness t. Alternatively, the distance La is preferably 0.9 times or more and 2.0 times or less as large as the thickness t. Alternatively, the distance La is preferably 1.0 times or more and 3.0 times or less as large as the thickness t. Alternatively, the distance La is preferably 1.0 times or more and 2.5 times or less as large as the thickness t. When the distance La is in the above range, a compact battery highly reliable for bending can be obtained.

Furthermore, when the distance between the pair of seal portions 262 is referred to as a distance Lb, it is preferable that the distance Lb be sufficiently longer than the widths of the positive electrode 211a and the negative electrode 211b (here, a width Wb of the negative electrode 211b). Thus, even if the positive electrode 211a and the negative electrode 211b come into contact with the exterior body 251 when deformation such as repeated bending of the secondary battery 250 is conducted, parts of the positive electrode 211a and the negative electrode 211b can be shifted in the width direction; thus, the positive electrode 211a and the negative electrode 211b can be effectively prevented from being rubbed against the exterior body 251.

For example, the difference between the distance Lb, which is the distance between the pair of seal portions 262, and the width Wb of the negative electrode 211b is preferably 1.6 times or more and 6.0 times or less, further preferably 1.8 times or more and 5.0 times or less, still further preferably 2.0 times or more and 4.0 times or less as large as the thickness t of the positive electrode 211a and the negative electrode 211b. Alternatively, the difference is preferably 1.6 times or more and 5.0 times or less as large as the thickness t. Alternatively, the difference is preferably 1.6 times or more and 4.0 times or less as large as the thickness t. Alternatively, the difference is preferably 1.8 times or more and 6.0 times or less as large as the thickness t. Alternatively, the difference is preferably 1.8 times or more and 4.0 times or less as large as the thickness t. Alternatively, the difference is preferably 2.0 times or more and 6.0 times or less as large as the thickness t. Alternatively, the difference is preferably 2.0 times or more and 5.0 times or less as large as the thickness t.

Here, a satisfies 0.8 or more and 3.0 or less, preferably 0.9 or more and 2.5 or less, further preferably 1.0 or more and 2.0 or less. Alternatively, a satisfies 0.8 or more and 2.5 or less. Alternatively, a satisfies 0.8 or more and 2.0 or less. Alternatively, a satisfies 0.9 or more and 3.0 or less. Alternatively, a satisfies 0.9 or more and 2.0 or less. Alternatively, a satisfies 1.0 or more and 3.0 or less. Alternatively, a satisfies 1.0 or more and 2.5 or less.

FIG. 36D illustrates a cross section including the lead 212a and corresponds to a cross section of the secondary battery 250, the positive electrode 211a, and the negative electrode 211b in the length direction. As illustrated in FIG. 36D, a space 273 is preferably provided between the end portions of the positive electrode 211a and the negative electrode 211b in the length direction and the exterior body 251 in the folded portion 261.

FIG. 36E is a schematic cross-sectional view of the secondary battery 250 in a state of being bent. FIG. 36E corresponds to a cross section along the cutting line B1-B2 in FIG. 36A.

When the secondary battery 250 is bent, a part of the exterior body 251 positioned on the outer side in bending is unbent and the other part positioned on the inner side changes its shape as it shrinks. More specifically, the part of the exterior body 251 positioned on the outer side changes its shape such that the wave amplitude becomes smaller and the length of the wave period becomes larger. By contrast, the part of the exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself of the exterior body 251 does not need to expand or contract. Thus, the secondary battery 250 can be bent with weak force without damage to the exterior body 251.

As illustrated in FIG. 36E, when the secondary battery 250 is bent, the positive electrode 211a and the negative electrode 211b are shifted relatively. At this time, ends of the stacked positive electrodes 211a and negative electrodes 211b on the seal portion 263 side are fixed by a fixing member 217; thus, the positive electrodes 211a and the negative electrodes 211b are shifted such that the shift amount becomes larger at a position closer to the folded portion 261. Therefore, stress applied to the positive electrode 211a and the negative electrode 211b is relieved, and the positive electrode 211a and the negative electrode 211b themselves do not need to expand or contract. Consequently, the secondary battery 250 can be bent without damage to the positive electrode 211a and the negative electrode 211b.

The space 273 is included between the positive electrode 211a and the negative electrode 211b, and the exterior body 251, whereby the positive electrode 211a and the negative electrode 211b can be shifted relatively while the positive electrode 211a and the negative electrode 211b located on an inner side in bending do not come into contact with the exterior body 251.

Note that the exterior body 251 may have a region where the trough line 272 is in contact with the electrode stack 210.

In the secondary battery 250 illustrated in FIG. 36 and FIG. 37, the exterior body is unlikely to be damaged and the positive electrode 211a and the negative electrode 211b are unlikely to be damaged, for example, and the battery performance is unlikely to deteriorate even when the secondary battery 250 is repeatedly bent and unbent. When the positive electrode active material described in the above embodiment is used in the positive electrode 211a included in the secondary battery 250, a battery with better cycle performance can be obtained.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charging and discharging of the all-solid-state battery can be suppressed, and the reliability of the all-solid-state battery can be improved.

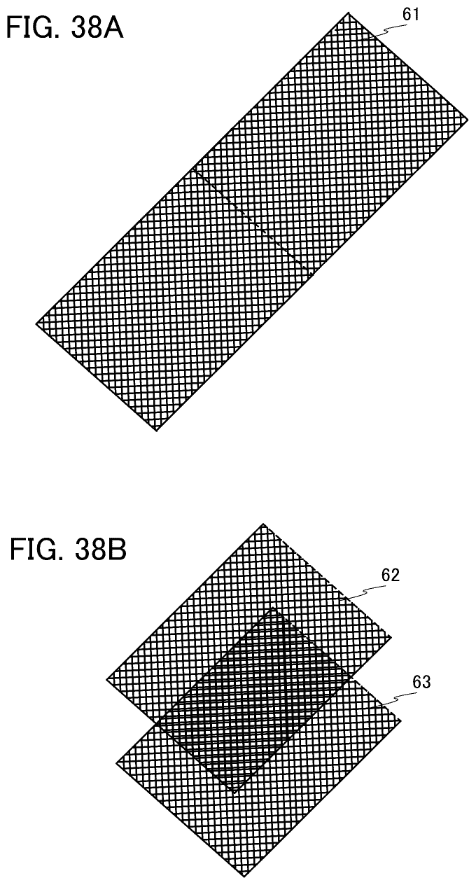

FIG. 38A and FIG. 38B are bird's eye views illustrating the completed shapes obtained by performing the embossing illustrated in FIG. 17A to FIG. 17D and FIG. 19B twice with different orientations of a film 90. Specifically, corrugated embossing is performed on the film 90 in the first direction, and then corrugated embossing is performed on the film 90 in the second direction that is rotated 90° with respect to the first direction, whereby a film 61 having an embossed shape (that can be referred to as an alternating wave shape) illustrated in FIG. 38A and FIG. 38B can be obtained. Note that when a secondary battery is fabricated using one film 61, the film 61 having an alternating wave shape has an external shape illustrated in FIG. 38A and can be used by being folded in two along a dashed line portion. When a secondary battery is fabricated using two films (a film 62 and a film 63), the plurality of films (the film 62 and the film 63) each having an alternating wave shape have an external shape illustrated in FIG. 38B, and the film 62 and the film 63 overlap with each other to be used.

Since processing is performed using the embossing rolls in the aforementioned manner, an apparatus can be small. Furthermore, a film before being cut can be processed, achieving excellent productivity. Note that a film processing method is not limited to processing using embossing rolls; a film may be processed by pressing a pair of embossing plates having a surface with unevenness against the film. In that case, one of the embossing plates may be flat and the film may be processed in a plurality of steps.

In the above-described structure example of the secondary battery, the example is described in which the exterior body on one surface of the secondary battery and the exterior body on the other surface thereof have the same embossed shape; however, the structure of the secondary battery of one embodiment of the present invention is not limited thereto. For example, a secondary battery one surface of which is provided with an exterior body having an embossed shape and the other surface of which is provided with an exterior body not having an embossed shape can be used. Alternatively, the exterior body on one surface of the secondary battery and the exterior body on the other surface thereof may have different embossed shapes.

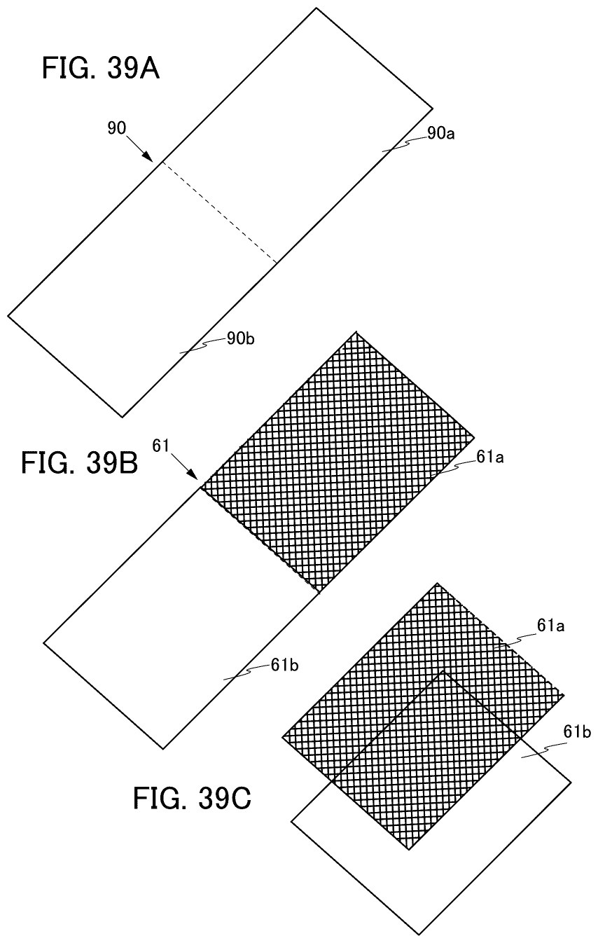

A secondary battery one surface of which is provided with an exterior body having an embossed shape and the other surface of which is provided with an exterior body not having an embossed shape will be described with reference to FIG. 39 to FIG. 41.

First, a sheet made of a flexible material is prepared. As the sheet, a stack in which an adhesive layer (also referred to as a heat-seal layer) is provided on one or both surfaces of a metal film is used. As the adhesive layer, a heat-seal resin film containing polypropylene, polyethylene, or the like is used. In this embodiment, a metal sheet in which the surface of aluminum foil is provided with a nylon resin and the back surface of the aluminum foil is provided with a stack of an acid-proof polypropylene film and a polypropylene film is used as the sheet. This sheet is cut to prepare the film 90 illustrated in FIG. 39A.

Then, part of the film 90 (a film 90a) is embossed and a film 90b is not embossed. As a result, the film 61 illustrated in FIG. 39B is formed. As illustrated in FIG. 39B, projections and depressions are formed to provide a film 61a a surface of which is provided with a visually recognizable pattern and a film 61b a surface of which is not provided with projections and depressions. There is a boundary between the film 61a provided with projections and depressions and the film 61b not provided with projections and depressions. In FIG. 39B, the film 61a is an embossed portion of the film 61, and the film 61b is a non-embossed portion. Note that embossing for the film 61a may be performed to provide the same projections and depressions on the entire surface, or may be performed to provide two or more types of different projections and depressions depending on the portions of the film 61a. In the case of providing two or more types of different projections and depressions, a boundary is formed between any two different types of projections and depressions.

Alternatively, the entire film 90 in FIG. 39A may be embossed to form the film 61 as illustrated in FIG. 38A. Note that embossing for the film 61 may be performed to provide the same projections and depressions on the entire surface, or may be performed to provide two or more types of different projections and depressions depending on the portions of the film 61. In the case of providing two or more types of different projections and depressions, a boundary is formed between any two different types of projections and depressions. Alternatively, as illustrated in FIG. 39C, the film 61a whose surface has projections and depressions and the film 61b whose surface does not have projections and depressions may be prepared.

Although an example in which the sheet is cut and then embossing is performed is described here, there is no particular limitation on the order; embossing may be performed before cutting the sheet and then the sheet is cut so as to be in the state illustrated in FIG. 39B. Alternatively, the sheet may be cut after thermocompression bonding is performed with the sheet folded.

In this embodiment, projections and depressions are provided on both surfaces of part of the film 90 (the film 90a) so that the film 61 having patterns is formed, and the film 61 is folded at the center such that two end portions overlap with each other, and is sealed on three sides with an adhesive layer. Here, the film 61 is referred to as an exterior body 81.

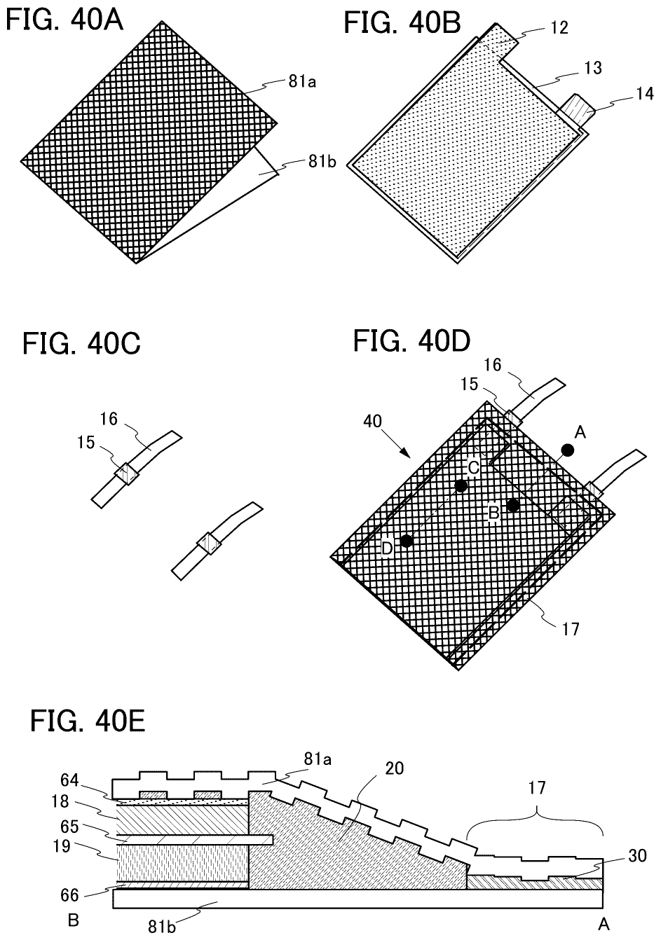

Next, the exterior body 81 is folded along a dotted line in FIG. 39B to be in the state illustrated in FIG. 40A.

A stack including a positive electrode current collector 64 on the surface of which a positive electrode active material layer 18 is partly formed, a separator 65, and a negative electrode current collector 66 on the surface of which a negative electrode active material layer 19 is partly formed is prepared as illustrated in FIG. 40B to constitute a secondary battery. Here, for simple description, an example is described in which one stack including the positive electrode current collector 64 provided with the positive electrode active material layer 18, the separator 65, and the negative electrode current collector 66 provided with the negative electrode active material layer 19 is held in an exterior body; however, to increase the capacity of a secondary battery, a plurality of the stacks may be stacked and held in an exterior body.

Then, two lead electrodes 16 including sealing layers 15 illustrated in FIG. 40C are prepared. The lead electrodes 16 are each also referred to as a lead terminal and provided to lead a positive electrode or a negative electrode of a secondary battery to the outside of an exterior film. Aluminum and nickel-plated copper are used for a positive electrode lead and a negative electrode lead, respectively.

Then, the positive electrode lead is electrically connected to a protruding portion of the positive electrode current collector 64 by ultrasonic welding or the like. The negative electrode lead is electrically connected to a protruding portion of the negative electrode current collector 66 by ultrasonic welding or the like.

Then, two sides of the exterior body 81 are sealed by thermocompression bonding, and one side is left open for introduction of an electrolyte solution (hereinafter, the shape of a film in this state also referred to as a bag-like shape). In thermocompression bonding, the sealing layers 15 provided over the lead electrodes are also melted, thereby fixing the lead electrodes and the exterior body 81 to each other. After that, in reduced pressure or an inert atmosphere, a desired amount of electrolyte solution is dripped into the exterior body 81 having a bag-like shape. Lastly, the outer edge of the exterior body 81 that has not been subjected to thermocompression bonding and is left open is sealed by thermocompression bonding.

In this manner, a secondary battery 40 illustrated in FIG. 40D can be fabricated.

In the obtained secondary battery 40, the surface of the film 90 serving as an exterior body has a pattern of projections and depressions. A region between a dotted line and an edge in FIG. 40D is a thermocompression-bonded region 17, and its surface also has a pattern of projections and depressions. Although the projections and depressions in the thermocompression-bonded region 17 are smaller than those in a center portion, they can relieve stress applied when the secondary battery is bent.

FIG. 40E illustrates an example of a cross section taken along the dashed-dotted line A-B in FIG. 40D.

As illustrated in FIG. 40E, projections and depressions of an exterior body 81a are different between a region overlapping with the positive electrode current collector 64 and the thermocompression-bonded region 17. As illustrated in FIG. 40E, a stack including the positive electrode current collector 64, the positive electrode active material layer 18, the separator 65, the negative electrode active material layer 19, and the negative electrode current collector 66 in this order is sandwiched between the facing portions of the folded exterior body 81, an end portion is sealed with an adhesive layer 30, and the other space inside the folded exterior body 81 includes an electrolyte solution 20.

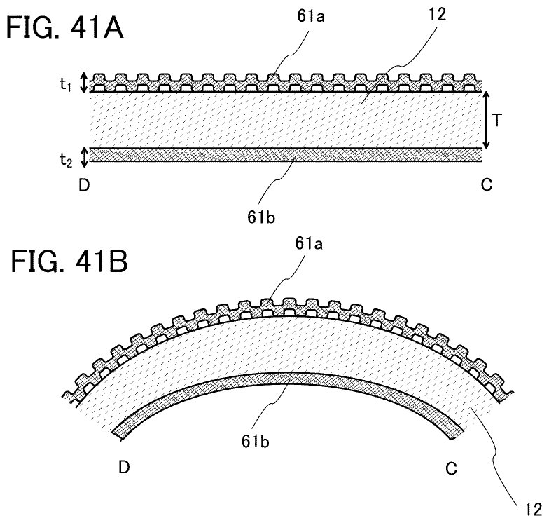

The proportion of the volume of the battery portion to the total volume of the secondary battery is preferably greater than or equal to 50%. FIG. 41A and FIG. 41B show cross-sectional views of the secondary battery in FIG. 40D taken along the line C-D. FIG. 41A illustrates a stack 12 in the battery, the embossed film 61a that covers the top surface of the battery, and the non-embossed film 61b and the embossed film 61b that cover the bottom surface of the battery. For simplification of the drawings, the electrolyte solution and the stacked-layer structure of the positive electrode current collector provided with the positive electrode active material layer, the separator, the negative electrode current collector provided with the negative electrode active material layer, and the like are collectively illustrated as the stack 12 in the battery. Note that T represents the thickness of the stack 12 in the battery, t₁ represents the sum of the embossing depth and the thickness of the embossed film 61a that covers the top surface of the battery, and t₂ represents the sum of the thickness of the non-embossed film 61b and the embossing depth and the thickness of the embossed film 61b that cover the bottom surface of the battery. At this time, the total thickness of the secondary battery is T+t₁+t₂. Thus, T>t₁+t₂ needs to be satisfied to make the proportion of the volume of the stack 12 portion in the battery to the total volume of the secondary battery greater than or equal to 50%.

The adhesive layer 30, which is only partly illustrated in FIG. 40E, is formed in the following manner: a layer made of polypropylene is provided on the surface of the layer on the side where the film is attached, and only a thermocompression-bonded portion becomes the adhesive layer 30.

FIG. 40E illustrates an example in which the bottom side of the exterior body 81 is fixed and pressure bonding is performed. In this case, the top side is greatly bent and a step is formed; thus, when a plurality of the above-described stacks, e.g., eight or more stacks, are provided between the facing portions of the folded exterior body 81, the step is large and stress might be excessively applied to the top side of the exterior body 81a. Furthermore, the edge of the top side of the film might be greatly misaligned with the edge of the bottom side of the film. In that case, to prevent misalignment of the edges, a step may be provided on the bottom side of the film and pressure bonding may be performed at the center so that stress is equalized.

In the case where the misalignment is large, there is a region where part of the edge of one film does not overlap with the other film. To correct the misalignment of the edges of the top and bottom sides of the film, such a region may be cut off.

### [Example of Method for Fabricating Secondary Battery]

An example of a fabrication method particularly when a secondary battery is used as a battery 80 will be described below. Note that points similar to those described above are not described in some cases.

Here, a method in which the film-like exterior body 81 having a wave shape is folded in half so that two end portions overlap with each other and three sides are sealed using an adhesive layer is employed.

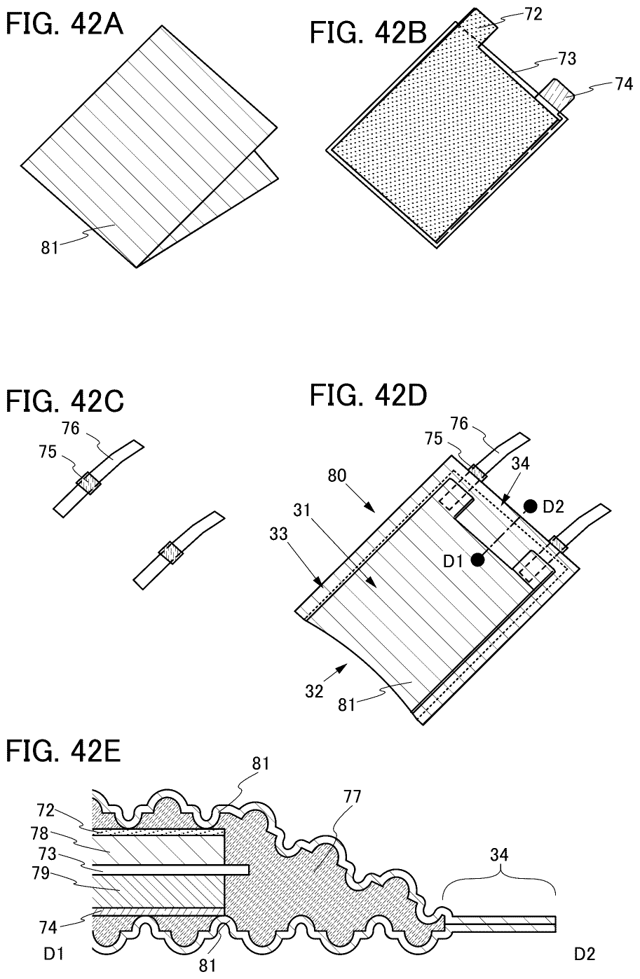

The exterior body 81 including a film processed to have a wave shape is bent to be in the state illustrated in FIG. 42A.

As illustrated in FIG. 42B, a stack including a positive electrode current collector 72, a separator 73, and a negative electrode current collector 74 included in a secondary battery is prepared. Although not illustrated, a positive electrode active material layer is formed on part of the surface of the positive electrode current collector 72. In addition, a negative electrode active material layer is formed on part of the surface of the negative electrode current collector 74. Here, for simple description, an example is described in which one stack including the positive electrode current collector 72 provided with the positive electrode active material layer, the separator 73, and the negative electrode current collector 74 provided with the negative electrode active material layer is held in an exterior body; however, to increase the capacity of a secondary battery, a plurality of the stacks are stacked and held in an exterior body.

In addition, two lead electrodes 76 including sealing layers 75 illustrated in FIG. 42C are prepared. The lead electrodes 76 are each also referred to as a lead terminal or a tab and provided to lead a positive electrode or a negative electrode of a secondary battery to the outside of an exterior film. Aluminum and nickel-plated copper are used for a positive electrode lead and a negative electrode lead, respectively, of the lead electrodes 76.

Then, the positive electrode lead is electrically connected to a protruding portion of the positive electrode current collector 72 by ultrasonic welding or the like. The negative electrode lead is electrically connected to a protruding portion of the negative electrode current collector 74 by ultrasonic welding or the like.

Then, two sides of the film-like exterior body 81 are subjected to thermocompression bonding by the above-described method and one side is left open for introduction of an electrolyte solution, whereby a bonding portion 33 is formed. After that, in reduced pressure or an inert atmosphere, a desired amount of electrolyte solution is dripped into the film-like exterior body 81 having a bag-like shape. Lastly, the outer edge of the film that has not been subjected to thermocompression bonding and is left open is subjected to thermocompression bonding, whereby a bonding portion 34 is formed. In thermocompression bonding, the sealing layers 75 provided over the lead electrodes are also melted, thereby fixing the lead electrodes and the film-like exterior body 81 to each other.

In this manner, the battery 80 illustrated in FIG. 42D, which is a secondary battery, can be fabricated.

The film-like exterior body 81 of the battery 80, which is the obtained secondary battery, has a pattern of waves. A region between a dotted line and the edge in FIG. 42D is the bonding portion 33 or the bonding portion 34, and the region is processed to be flat.

FIG. 42E illustrates an example of a cross section taken along the dashed-dotted line D1-D2 in FIG. 42D.

As illustrated in FIG. 42E, a stack in which the positive electrode current collector 72, a positive electrode active material layer 78, the separator 73, a negative electrode active material layer 79, and the negative electrode current collector 74 are stacked in this order is sandwiched between the facing portions of the folded film-like exterior body 81, the folded film-like exterior body 81 is sealed by the bonding portion 34 at its end portions, and the other space is provided with an electrolyte solution 77. That is, the space inside the film-like exterior body 81 is filled with the electrolyte solution 77. As the positive electrode current collector 72, the positive electrode active material layer 78, the separator 73, the negative electrode active material layer 79, the negative electrode current collector 74, and the electrolyte solution 77, the positive electrode current collector, the positive electrode active material layer, the separator, the negative electrode active material layer, the negative electrode current collector, and the electrolyte solution described in Embodiment 2 can be respectively used.

Note that the adhesive layer is formed in the following manner: a layer made of polypropylene is provided on the surface of the film on the side where the film is attached, and only a thermocompression-bonded portion becomes the adhesive layer.

FIG. 42E illustrates an example in which the bottom side of the film-like exterior body 81 is fixed and pressure bonding is performed. In this case, the top side is greatly bent and a step is formed; thus, when a plurality of the above-described stacks, e.g., eight or more stacks, are provided between the facing portions of the folded film-like exterior body 81, the step is large and stress might be excessively applied to the top side of the film-like exterior body 81. Furthermore, the edge of the top side of the film might be greatly misaligned with the edge of the bottom side of the film. In that case, to prevent misalignment of the edges, a step may be provided on the bottom side of the film and pressure bonding may be performed at the center so that stress is equalized.

In the case where the misalignment is large, there is a region where part of the edge of one film does not overlap with the other film. To correct the misalignment of the edges of the top and bottom sides of the film, such a region may be cut off.

### [Example of Electrode Stack]

A structure example of a stack including a plurality of electrodes will be described below.

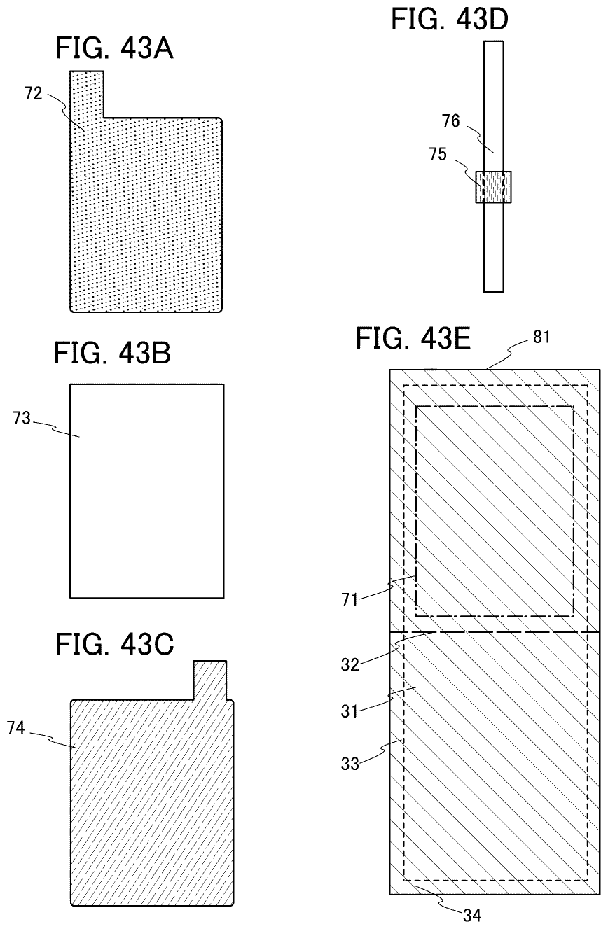

FIG. 43A shows atop view of the positive electrode current collector 72, FIG. 43B shows a top view of the separator 73, FIG. 43C shows a top view of the negative electrode current collector 74, FIG. 43D shows atop view of the sealing layer 75 and the lead electrode 76, and FIG. 43E shows a top view of the film-like exterior body 81.

The dimensions in the drawings of FIG. 43 are substantially the same, and a region 71 surrounded by a dashed-dotted line in FIG. 43E has substantially the same dimensions as the separator in FIG. 43B. A region between a dashed line and the edge in FIG. 43E becomes the bonding portion 33 and the bonding portion 34.

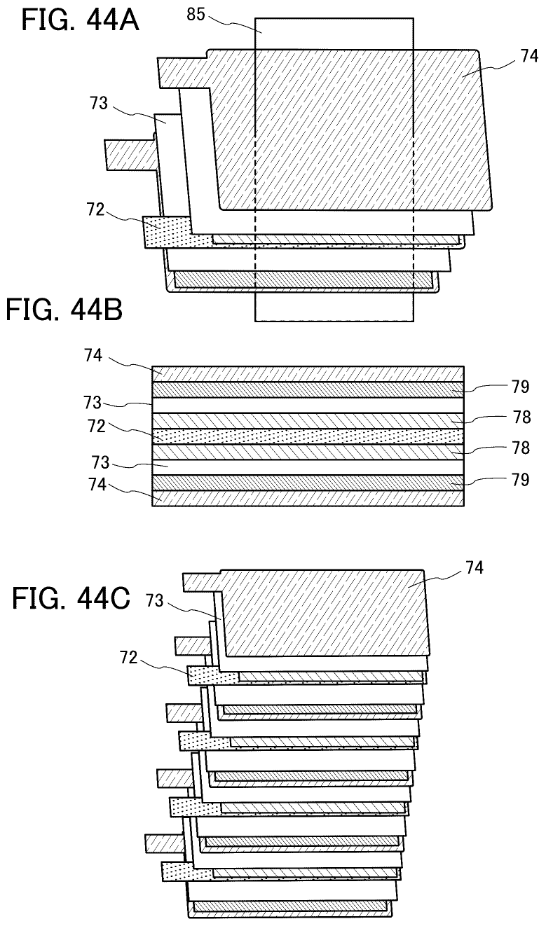

FIG. 44A is an example in which the positive electrode active material layer 78 is provided on both surfaces of the positive electrode current collector 72. Specifically, the negative electrode current collector 74, the negative electrode active material layer 79, the separator 73, the positive electrode active material layer 78, the positive electrode current collector 72, the positive electrode active material layer 78, the separator 73, the negative electrode active material layer 79, and the negative electrode current collector 74 are stacked in this order. FIG. 44B shows a cross-sectional view of the stacked-layer structure taken along a plane 85.

Although FIG. 44A illustrates an example in which two separators are used, a structure may be employed in which one separator is folded and both ends are sealed to form a bag-like shape, and the positive electrode current collector 72 is held therein. The positive electrode active material layer 78 is formed on both surfaces of the positive electrode current collector 72 held in the separator having a bag-like shape.

The negative electrode active material layer 79 can be provided on both surfaces of the negative electrode current collector 74. FIG. 44C illustrates an example of a secondary battery in which three negative electrode current collectors 74 each provided with the negative electrode active material layers 79 on both surfaces, four positive electrode current collectors 72 each provided with the positive electrode active material layers 78 on both surfaces, and eight separators 73 are sandwiched between two negative electrode current collectors 74 each provided with the negative electrode active material layer 79 on one surface. In this case, four separators each having a bag-like shape may be used instead of eight separators.

The capacity of the secondary battery can be increased by increasing the number of stacks. In addition, when the positive electrode active material layers 78 are provided on both surfaces of the positive electrode current collector 72 and the negative electrode active material layers 79 are provided on both surfaces of the negative electrode current collector 74, the thickness of the secondary battery can be made small.

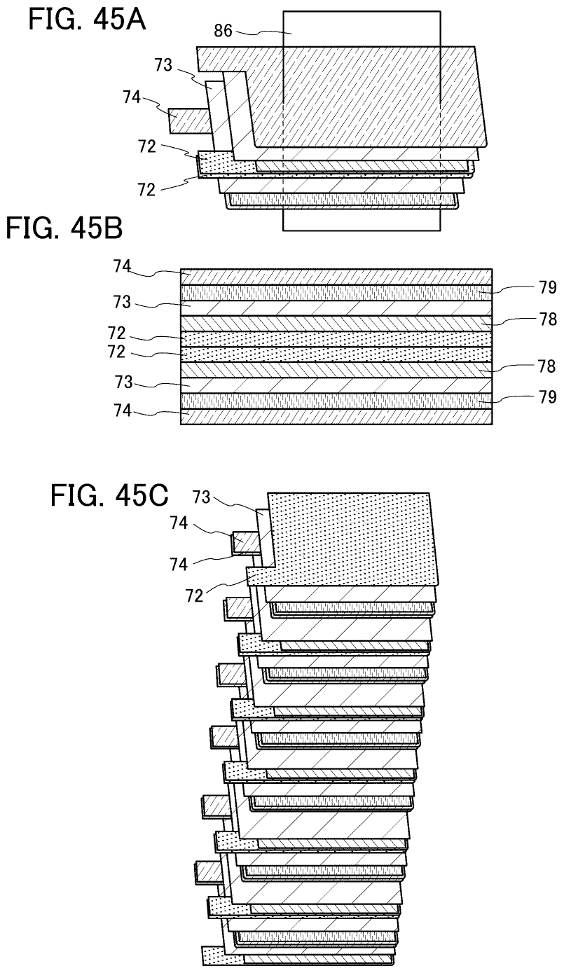

FIG. 45A shows a diagram of a secondary battery in which the positive electrode active material layer 78 is provided on one surface of the positive electrode current collector 72 and the negative electrode active material layer 79 is provided on one surface of the negative electrode current collector 74. Specifically, the negative electrode active material layer 79 is provided on one surface of the negative electrode current collector 74 and the separator 73 is stacked in contact with the negative electrode active material layer 79. The positive electrode active material layer 78 provided on one surface of the positive electrode current collector 72 is in contact with the surface of the separator 73 that is not in contact with the negative electrode active material layer 79. Another positive electrode current collector 72 whose one surface is provided with the positive electrode active material layer 78 is in contact with the surface of the positive electrode current collector 72. In that case, the positive electrode current collectors 72 are provided such that the surfaces not provided with the positive electrode active material layers 78 face each other. Then, another separator 73 is formed, and the negative electrode active material layer 79 provided on one surface of the negative electrode current collector 74 is stacked in contact with the separator. FIG. 45B shows a cross-sectional view of the stacked-layer structure in FIG. 45A taken along a plane 86.

Although two separators are used in FIG. 45A, a structure may be employed in which one separator is folded and both ends are sealed to form a bag-like shape, and two positive electrode current collectors 72 each provided with the positive electrode active material layer 78 on one surface are provided between the facing portions of the separator.

In FIG. 45C, a plurality of the stacked-layer structures each of which is illustrated in FIG. 45A are stacked. In FIG. 45C, the negative electrode current collectors 74 are provided such that the surfaces not provided with the negative electrode active material layers 79 face each other. FIG. 45C illustrates a state where twelve positive electrode current collectors 72, twelve negative electrode current collectors 74, and twelve separators 73 are stacked.

A secondary battery with a structure in which the positive electrode active material layer 78 is provided on one surface of the positive electrode current collector 72 and the negative electrode active material layer 79 is provided on one surface of the negative electrode current collector 74 has a larger thickness than a secondary battery with a structure in which the positive electrode active material layers 78 are provided on both surfaces of the positive electrode current collector 72 and the negative electrode active material layers 79 are provided on both surfaces of the negative electrode current collector 74. However, the surface of the positive electrode current collector 72 on which the positive electrode active material layer 78 is not provided faces the surface of another positive electrode current collector 72 on which the positive electrode active material layer 78 is not provided; as a result, metals are in contact with each other. Similarly, the surface of the negative electrode current collector 74 on which the negative electrode active material layer 79 is not provided faces the surface of another negative electrode current collector 74 on which the negative electrode active material layer 79 is not provided; as a result, metals are in contact with each other. Since the metals are in contact with each other, surfaces where the metals are in contact with each other easily slide on each other owing to the low friction. The metals in the secondary battery slide on each other at the time of bending the secondary battery; thus, the secondary battery is easily bent.

The protruding portion of the positive electrode current collector 72 and the protruding portion of the negative electrode current collector 74 are also referred to as tab portions. The tab portions of the positive electrode current collector 72 and the negative electrode current collector 74 are easily cut when the secondary battery is bent. This is because the tab portions have long and narrow shapes and the stress is likely to be applied to the roots of the tab portions.

The structure in which the positive electrode active material layer 78 is provided on one surface of the positive electrode current collector 72 and the negative electrode active material layer 79 is provided on one surface of the negative electrode current collector 74 has a surface where the positive electrode current collectors 72 are in contact with each other and a surface where the negative electrode current collectors 74 are in contact with each other. The surface where the current collectors are in contact with each other has low friction resistance and thus easily reduces the stress due to the difference in curvature radius that occurs when the battery is changed in shape. Furthermore, the total thickness of each tab portion is large in the structure in which the positive electrode active material layer 78 is provided on one surface of the positive electrode current collector 72 and the negative electrode active material layer 79 is provided on one surface of the negative electrode current collector 74; thus, the stress is distributed as compared with the structure in which the positive electrode active material layers 78 are provided on both surfaces of the positive electrode current collector 72 and the negative electrode active material layers 79 are provided on both surfaces of the negative electrode current collector 74; as a result, the tab portion is less likely to be cut.

In the case of thus stacking layers, ultrasonic welding is performed to fix and electrically connect all the positive electrode current collectors 72 at a time. Furthermore, when ultrasonic welding is performed with the positive electrode current collectors 72 overlapping with a lead electrode, they can be electrically connected to each other efficiently.

Ultrasonic welding can be performed in the following manner: ultrasonic waves are applied to the tab portion placed to overlap with a tab portion of another positive electrode current collector while pressure is applied thereto.

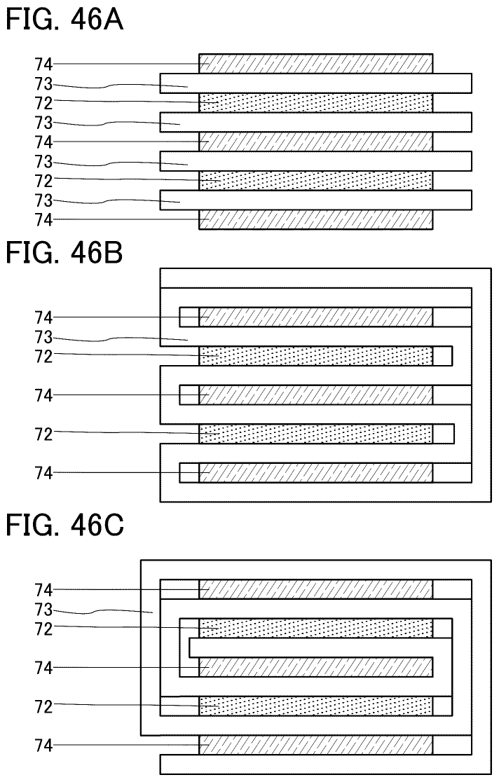

The separators 73 preferably have a shape that helps prevent an electrical short circuit between the positive electrode current collector 72 and the negative electrode current collector 74. For example, the width of each of the separators 73 is preferably larger than those of the positive electrode current collector 72 and the negative electrode current collector 74 as illustrated in FIG. 46A, in which case the positive electrode current collector 72 and the negative electrode current collector 74 are less likely to come in contact with each other even when the relative positions thereof are shifted because of a change in shape such as bending. As illustrated in FIG. 46B, one separator 73 is preferably folded into an accordion-like shape, or as illustrated in FIG. 46C, one separator 73 is preferably wrapped around the positive electrode current collectors 72 and the negative electrode current collectors 74 alternately, in which case the positive electrode current collector 72 and the negative electrode current collector 74 do not come in contact with each other even when the relative positions thereof are shifted. FIG. 46B and FIG. 46C each illustrate an example in which the separator 73 is provided to partly cover the side surface of a stacked-layer structure of the positive electrode current collectors 72 and the negative electrode current collectors 74.

Although the drawings of FIG. 46 do not illustrate the positive electrode active material layer 78 and the negative electrode active material layer 79, the above description can be referred to for formation methods thereof. Although an example in which the positive electrode current collectors 72 and the negative electrode current collectors 74 are alternately arranged is described here, two positive electrode current collectors 72 or two negative electrode current collectors 74 may be adjacent to each other as described above.

In the above example, one rectangle film is folded in half and two end portions are made to overlap with each other for sealing; however, the shape of the film is not limited to a rectangle. A polygon such as a triangle, a square, or a pentagon or any symmetric shape other than a rectangle, such as a circle or a star, may be employed.

This embodiment can be combined with any of the other embodiments as appropriate.

### Embodiment 4

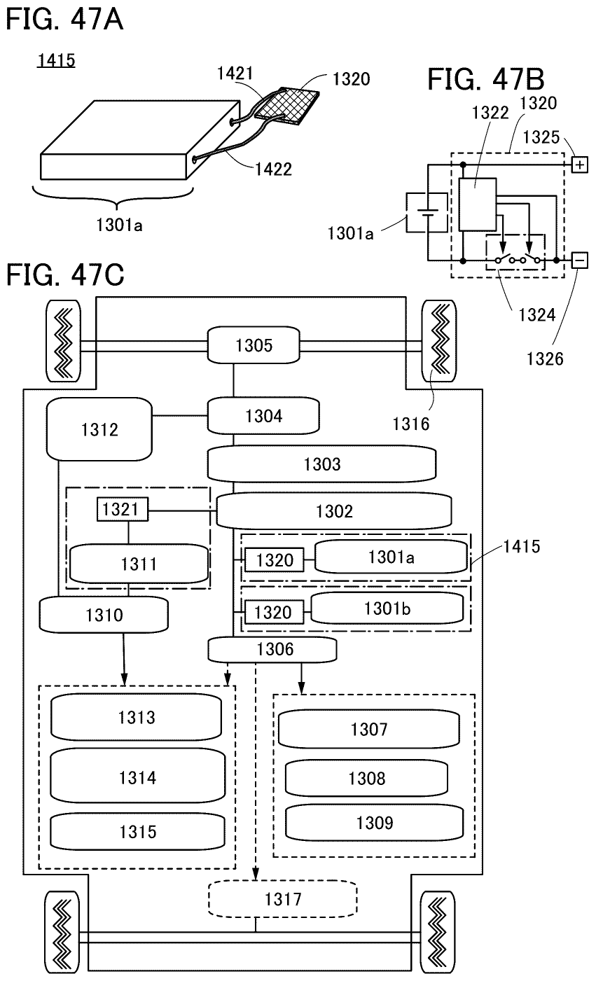

In this embodiment, application examples of the secondary battery of one embodiment of the present invention will be described with reference to FIG. 47 to FIG. 56.

### [Vehicle]

First, an example in which the secondary battery of one embodiment of the present invention is used in an electric vehicle (EV) will be described.

FIG. 47C shows a block diagram of a vehicle including a motor. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 only needs high output and a high capacity is not so much needed; the capacity of the second battery 1311 is lower than those of the first batteries 1301a and 1301b.

For example, as one or both of the first batteries 1301a and 1301b, the secondary battery fabricated by the method for fabricating the secondary battery of one embodiment of the present invention can be used.

Although this embodiment describes an example in which the two first batteries 1301a and 1301b are connected in parallel, three or more batteries may be connected in parallel. In the case where the first battery 1301a can store sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

An in-vehicle secondary battery includes a service plug or a circuit breaker that can cut off a high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (for a high-voltage system) (such as an electric power steering 1307, a heater 1308, and a defogger 1309) through a DCDC circuit 1306. In the case where there is a rear motor 1317 for the rear wheels, the first battery 1301a is used to rotate the rear motor 1317.

The second battery 1311 supplies electric power to in-vehicle parts for 14 V (for a low-voltage system) (such as a stereo 1313, power windows 1314, and lamps 1315) through a DCDC circuit 1310.

The first battery 1301a will be described with reference to FIG. 47A.

FIG. 47A illustrates an example of a large battery pack 1415. One electrode of the battery pack 1415 is electrically connected to a control circuit portion 1320 through a wiring 1421. The other electrode is electrically connected to the control circuit portion 1320 through a wiring 1422. Note that the battery pack may have a structure in which a plurality of secondary batteries are connected in series.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charge and discharge state of the secondary battery. For example, to prevent overcharging, an output transistor of a charge circuit and an interruption switch can be turned off substantially at the same time.

FIG. 47B shows an example of a block diagram of the battery pack 1415 illustrated in FIG. 47A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery is a recommended voltage range, and when voltage falls outside the range, the switch portion 1324 operates and functions as a protection circuit. The control circuit portion 1320 can also be referred to as a protection circuit because it controls the switch portion 1324 to prevent overdischarging or overcharging. For example, when the control circuit 1322 detects voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors and/or p-channel transistors. The switch portion 1324 is not limited to a switch including a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using OS transistors can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead storage battery is usually used for the second battery 1311 due to cost advantage.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

By mounting the secondary battery of one embodiment of the present invention on vehicles, next-generation clean energy vehicles such as hybrid vehicles (HVs), electric vehicles (EVs), and plug-in hybrid vehicles (PHVs) can be achieved. The secondary battery can also be mounted on transport vehicles such as agricultural machines such as electric tractors, motorized bicycles including motor-assisted bicycles, motorcycles, electric wheelchairs, electric carts, boats, ships, submarines, aircraft such as fixed-wing aircraft and rotary-wing aircraft, rockets, artificial satellites, space probes, planetary probes, and spacecraft. With the use of the method for fabricating the secondary battery of one embodiment of the present invention, a large secondary battery can be provided. Thus, the secondary battery of one embodiment of the present invention can be suitably used in transport vehicles.

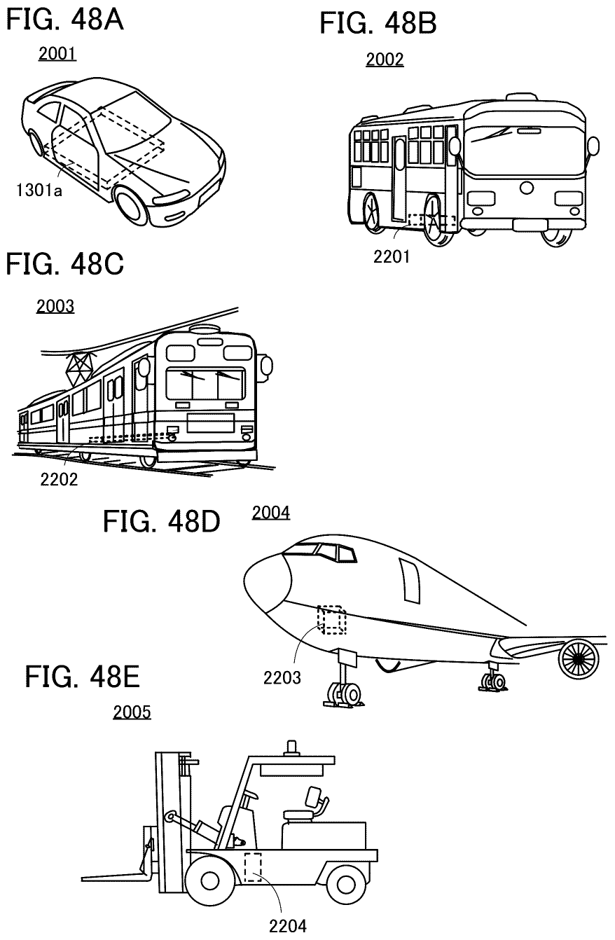

FIG. 48A to FIG. 48E illustrate transport vehicles each using the secondary battery of one embodiment of the present invention. An automobile 2001 illustrated in FIG. 48A is an electric vehicle that runs using an electric motor as a driving power source. Alternatively, the automobile 2001 is a hybrid vehicle that can appropriately select an electric motor or an engine as a driving power source. In the case where the secondary battery is mounted on the vehicle, the secondary battery is provided at one position or several positions. The automobile 2001 illustrated in FIG. 48A includes the battery pack 1415 illustrated in FIG. 47A. The battery pack 1415 includes a secondary battery module. The battery pack 1415 preferably further includes a charge control device that is electrically connected to the secondary battery module. The secondary battery module includes one or more secondary batteries.

The automobile 2001 can be charged when the secondary battery included in the automobile 2001 is supplied with electric power from external charge equipment by a plug-in system, a contactless power feeding system, or the like. In charging, a given method such as CHAdeMO (registered trademark) or Combined Charging System can be employed as a charge method, the standard of a connector, or the like as appropriate. A charge device may be a charge station provided in a commerce facility or a power source in a house. For example, with the use of the plug-in technique, a secondary battery mounted on the automobile 2001 can be charged by being supplied with electric power from the outside. The charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar panel may be provided in the exterior of the vehicle to charge the secondary battery when the vehicle stops or moves. To supply electric power in such a contactless manner, an electromagnetic induction method or a magnetic resonance method can be used. A solar panel is referred to as a solar cell module in some cases.

FIG. 48B illustrates a large transporter 2002 having a motor controlled by electricity as an example of a transport vehicle. A secondary battery module of the transporter 2002 has a cell unit of four secondary batteries with 3.5 V or higher and 4.7 V or lower, for example, and 48 cells are connected in series to have a maximum voltage of 170 V. A battery pack 2201 has the same function as the battery pack in FIG. 48A except, for example, the number of secondary batteries configuring the secondary battery module; thus, the description is omitted.

FIG. 48C illustrates a large transport vehicle 2003 having a motor controlled by electricity as an example. A secondary battery module of the transport vehicle 2003 has 100 or more secondary batteries with higher than or equal to 3.5 V and lower than or equal to 4.7 V which are connected in series, and the maximum voltage is 600 V, for example. Thus, the secondary batteries are required to have a small variation in the characteristics. With the use of the method for fabricating the secondary battery of one embodiment of the present invention, a secondary battery with stable battery performance can be fabricated, and mass production at low cost is possible in view of the yield. A battery pack 2202 has the same function as the battery pack in FIG. 48A except, for example, the number of secondary batteries configuring the secondary battery module; thus, the description is omitted.

FIG. 48D illustrates an aircraft 2004 having a combustion engine as an example. The aircraft 2004 illustrated in FIG. 48D is regarded as a kind of transport vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as the battery pack in FIG. 48A except, for example, the number of secondary batteries configuring the secondary battery module; thus, the description is omitted.

FIG. 48E illustrates a transport vehicle 2005 that transports a load as an example. The transport vehicle 2005 includes a motor controlled by electricity and executes various operations with the use of electric power supplied from secondary batteries configuring a secondary battery module of a battery pack 2204. The transport vehicle 2005 is not limited to be operated by a human who rides thereon as a driver, and an unmanned operation is also possible by CAN communication or the like. Although FIG. 48E illustrates a forklift, there is no particular limitation and a battery pack including the secondary battery of one embodiment of the present invention can be mounted on industrial machines capable of being operated by CAN communication or the like, e.g., automatic transporters, working robots, and small construction equipment.

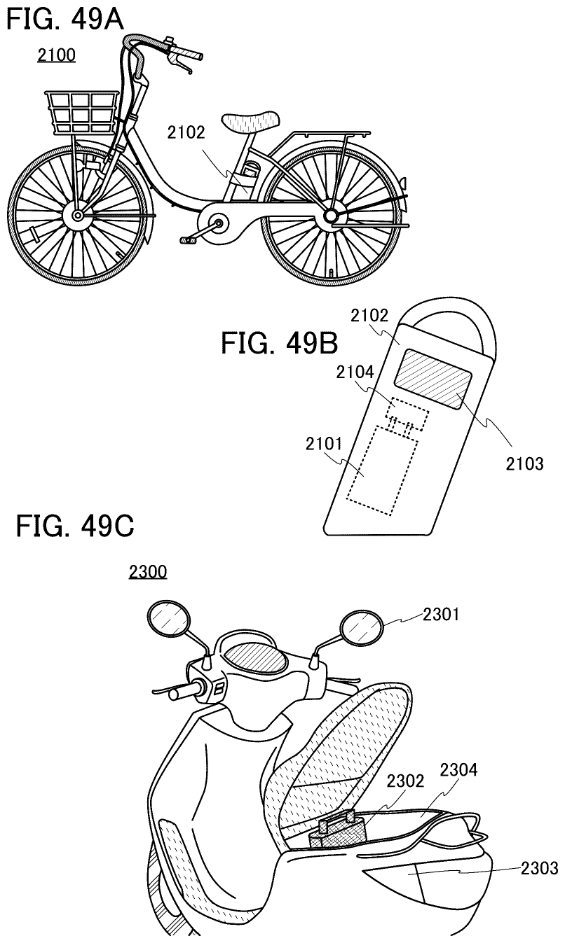

FIG. 49A illustrates an example of an electric bicycle using the secondary battery of one embodiment of the present invention. The secondary battery of one embodiment of the present invention can be used for an electric bicycle 2100 illustrated in FIG. 49A. A power storage device 2102 illustrated in FIG. 49B includes a plurality of secondary batteries and a protection circuit, for example.

The electric bicycle 2100 includes the power storage device 2102. The power storage device 2102 can supply electricity to a motor that assists a rider. The power storage device 2102 is portable, and FIG. 49B illustrates the state where the power storage device 2102 is detached from the bicycle. A plurality of secondary batteries 2101 of embodiments of the present invention are incorporated in the power storage device 2102, and the remaining battery capacity and the like can be displayed on a display portion 2103. The power storage device 2102 includes a control circuit 2104 capable of charge control or anomaly detection for the secondary battery, which is exemplified in one embodiment of the present invention. The control circuit 2104 is electrically connected to a positive electrode and a negative electrode of the secondary battery 2101. The control circuit 2104 may be provided with a small solid-state secondary battery. When the small solid-state secondary battery is provided in the control circuit 2104, electric power can be supplied to retain data in a memory circuit included in the control circuit 2104 for a long time. When the control circuit 2104 is used in combination with the secondary battery using the positive electrode active material 100 of one embodiment of the present invention in the positive electrode, the synergy on safety can be obtained. The secondary battery using the positive electrode active material 100 of one embodiment of the present invention in the positive electrode and the control circuit 2104 can greatly contribute to elimination of accidents due to secondary batteries, such as fires.

FIG. 49C illustrates an example of a motorcycle using the secondary battery of one embodiment of the present invention. A motor scooter 2300 illustrated in FIG. 49C includes a power storage device 2302, side mirrors 2301, and indicator lights 2303. The power storage device 2302 can supply electricity to the indicator lights 2303. The power storage device 2302 including a plurality of secondary batteries including a positive electrode using the positive electrode active material 100 of one embodiment of the present invention can have a high capacity and contribute to a reduction in size. To improve safety, a protection circuit that prevents overcharging and/or overdischarging of the secondary battery may be electrically connected to the secondary battery.

In the motor scooter 2300 illustrated in FIG. 49C, the power storage device 2302 can be stored in an under-seat storage unit 2304. The power storage device 2302 can be stored in the under-seat storage unit 2304 even with a small size.

### [Building]

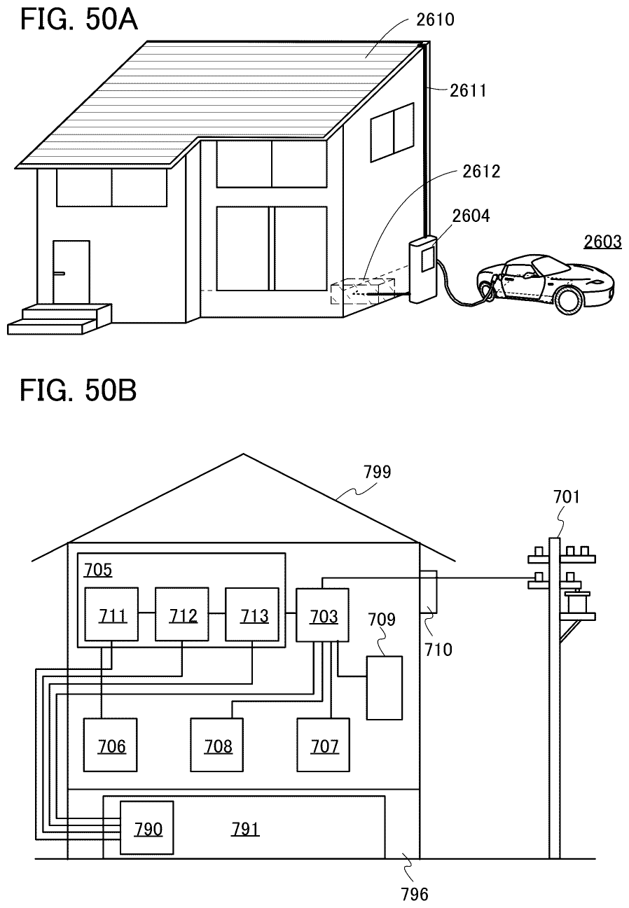

Next, examples in which the secondary battery of one embodiment of the present invention is mounted on a building will be described with reference to FIG. 50.

A house illustrated in FIG. 50A includes a power storage device 2612 including the secondary battery that has stable battery performance by employing the method for fabricating the secondary battery of one embodiment of the present invention and a solar panel 2610. The power storage device 2612 is electrically connected to the solar panel 2610 through a wiring 2611 or the like. The power storage device 2612 may be electrically connected to a ground-based charge device 2604. The power storage device 2612 can be charged with electric power generated by the solar panel 2610. A secondary battery included in a vehicle 2603 can be charged with the electric power stored in the power storage device 2612 through the charge device 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 as an uninterruptible power source, electronic devices can be used even when electric power cannot be supplied from a commercial power source due to power failure or the like.

FIG. 50B illustrates an example of a power storage device of one embodiment of the present invention. As illustrated in FIG. 50B, a large power storage device 791 obtained by the method for fabricating the secondary battery of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

### [Electronic Device]

The secondary battery of one embodiment of the present invention can be used for one or both of an electronic device and a lighting device, for example. Examples of the electronic device include portable information terminals such as mobile phones, smartphones, and laptop computers; portable game machines; portable music players; digital cameras; and digital video cameras.

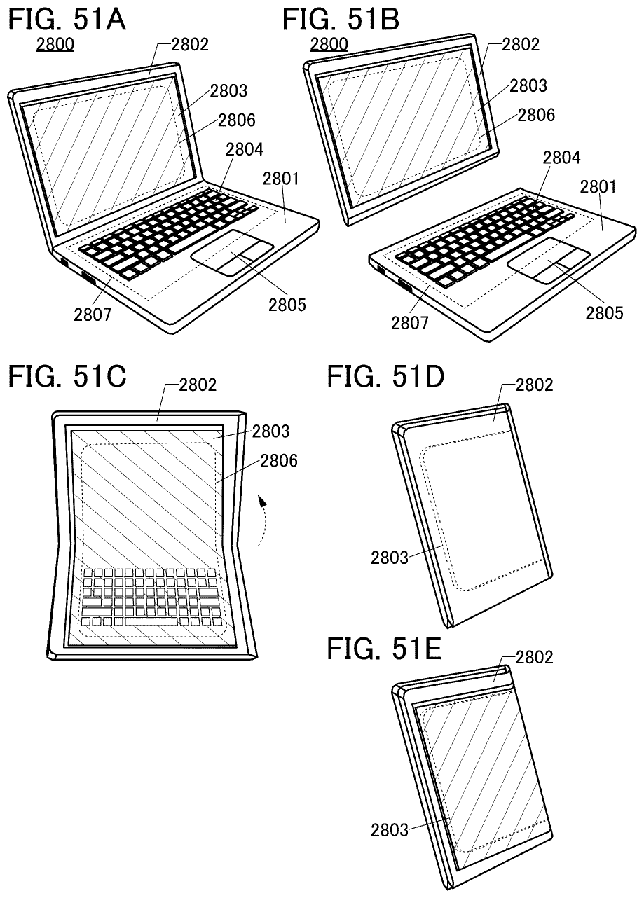

A personal computer 2800 illustrated in FIG. 51A includes a housing 2801, a housing 2802, a display portion 2803, a keyboard 2804, a pointing device 2805, and the like. A secondary battery 2807 is provided inside the housing 2801, and a secondary battery 2806 is provided inside the housing 2802. To improve safety, a protection circuit that prevents overcharging and/or overdischarging of the secondary battery 2807 may be electrically connected to the secondary battery 2807. A touch panel is used for the display portion 2803. As illustrated in FIG. 51B, the housing 2801 and the housing 2802 of the personal computer 2800 can be detached and the housing 2802 can be used alone as a tablet terminal.

The large secondary battery obtained by the method for fabricating the secondary battery of one embodiment of the present invention can be used as one or both of the secondary battery 2806 and the secondary battery 2807. The shape of the secondary battery obtained by the method for fabricating the secondary battery of one embodiment of the present invention can be changed freely by changing the shape of the exterior body. When the shapes of the secondary batteries 2806 and 2807 fit with the shapes of the housings 2801 and 2802, for example, the secondary batteries can have a high capacity and thus the operating time of the personal computer 2800 can be lengthened. Moreover, the weight of the personal computer 2800 can be reduced.

A flexible display is used for the display portion 2803 of the housing 2802. As the secondary battery 2806, the large secondary battery obtained by the method for fabricating the secondary battery of one embodiment of the present invention is used. With the use of a flexible film as the exterior body in the large secondary battery obtained by the method for fabricating the secondary battery of one embodiment of the present invention, a bendable secondary battery can be obtained. Thus, as illustrated in FIG. 51C, the housing 2802 can be used while being bent. In that case, part of the display portion 2803 can be used as a keyboard as illustrated in FIG. 51C.

Furthermore, the housing 2802 can be folded such that the display portion 2803 is placed inward as illustrated in FIG. 51D, and the housing 2802 can be folded such that the display portion 2803 faces outward as illustrated in FIG. 51E.

When the secondary battery of one embodiment of the present invention is used as a bendable secondary battery, the secondary battery can be mounted on an electronic device and incorporated along a curved inside/outside wall surface of a house or a building or a curved interior/exterior surface of an automobile.

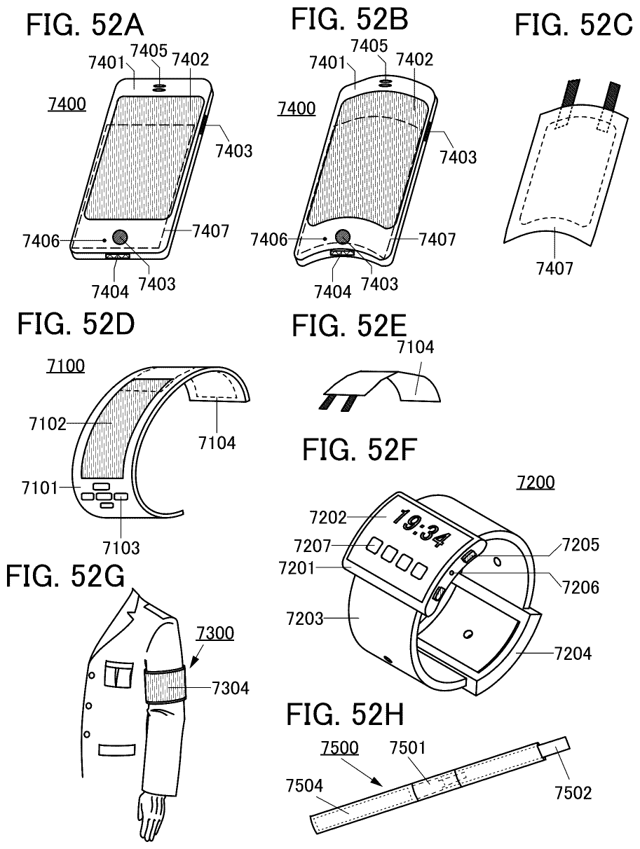

FIG. 52A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided. To improve safety, a protection circuit that prevents overcharging and/or overdischarging of the secondary battery 7407 may be electrically connected to the secondary battery 7407.

FIG. 52B illustrates the mobile phone 7400 that is curved. When the whole mobile phone 7400 is curved by external force, the secondary battery 7407 provided therein is also curved. FIG. 52C illustrates the secondary battery 7407 that is being bent at that time. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 52D illustrates an example of a bangle display device. A portable display device 7100 includes a housing 7101, a display portion 7102, operation buttons 7103, and a secondary battery 7104. To improve safety, a protection circuit that prevents overcharging and/or overdischarging of the secondary battery 7104 may be electrically connected to the secondary battery 7104. FIG. 52E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the curvature radius, and the reciprocal of the curvature radius is referred to as curvature. Specifically, part or the whole of the housing or the main surface of the secondary battery 7104 is changed in the range of curvature radius from 40 mm to 150 mm inclusive. When the curvature radius at the main surface of the secondary battery 7104 is in the range from 40 mm to 150 mm inclusive, the reliability can be kept high. When the secondary battery of one embodiment of the present invention is used as the secondary battery 7104, a lightweight portable display device with a long lifetime can be provided.

FIG. 52F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charging via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. To improve safety, a protection circuit that prevents overcharging and/or overdischarging of the secondary battery may be electrically connected to the secondary battery. For example, the secondary battery 7104 illustrated in FIG. 52E that is in the state of being curved can be provided in the housing 7201. Alternatively, the secondary battery 7104 illustrated in FIG. 52E can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 52G illustrates an example of an armband display device. A display device 7300 includes a display portion 7304 and the secondary battery of one embodiment of the present invention. To improve safety, a protection circuit that prevents overcharging and/or overdischarging of the secondary battery may be electrically connected to the secondary battery. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. Note that the charge operation may be performed by wireless power feeding without using the input/output terminal.

When the secondary battery of one embodiment of the present invention is used as the secondary battery included in the display device 7300, a lightweight display device with a long lifetime can be provided.

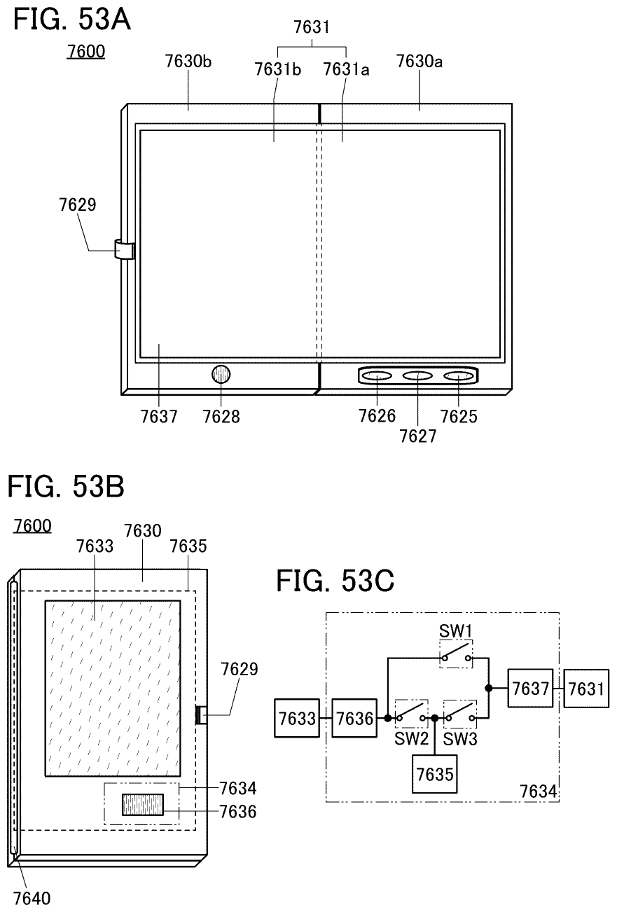

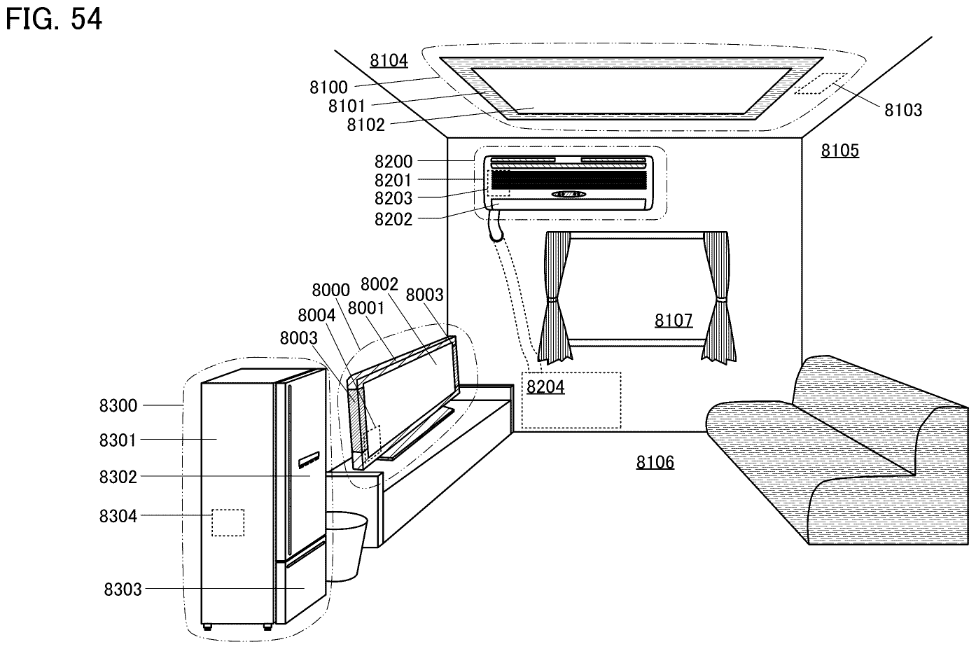

Examples of electronic devices each including the secondary battery of one embodiment of the present invention with excellent cycle performance will be described with reference to FIG. 52H, FIG. 53, and FIG. 54.

When the secondary battery of one embodiment of the present invention is used as a secondary battery of an electronic device, a lightweight product with a long lifetime can be provided. Examples of the daily electronic device include an electric toothbrush, an electric shaver, and electric beauty equipment. As secondary batteries of these products, small and lightweight stick type secondary batteries with a high capacity are desired in consideration of handling ease for users.

FIG. 52H is a perspective view of a device called a cigarette smoking device (electronic cigarette). In FIG. 52H, an electronic cigarette 7500 includes an atomizer 7501 including a heating element, a secondary battery 7504 that supplies electric power to the atomizer, and a cartridge 7502 including a liquid supply bottle, a sensor, or the like. To improve safety, a protection circuit that prevents overcharging and/or overdischarging of the secondary battery 7504 may be electrically connected to the secondary battery 7504. The secondary battery 7504 illustrated in FIG. 52H includes an external terminal for connection to a charger. When the electronic cigarette 7500 is held, the secondary battery 7504 is a tip portion; thus, it is desirable that the secondary battery 7504 have a short total length and be lightweight. With the secondary battery of one embodiment of the present invention, which has a high capacity and excellent cycle performance, the small and lightweight electronic cigarette 7500 that can be used for a long time over a long period can be provided.

Next, FIG. 53A and FIG. 53B illustrate an example of a tablet terminal that can be folded in half A tablet terminal 7600 illustrated in FIG. 53A and FIG. 53B includes a housing 7630a, a housing 7630b, a movable portion 7640 connecting the housing 7630a and the housing 7630b to each other, a display portion 7631 including a display portion 7631a and a display portion 7631b, a switch 7625 to a switch 7627, a fastener 7629, and an operation switch 7628. A flexible panel is used for the display portion 7631, whereby a tablet terminal with a larger display portion can be provided. FIG. 53A illustrates the tablet terminal 7600 that is opened, and FIG. 53B illustrates the tablet terminal 7600 that is closed.

The tablet terminal 7600 includes a power storage unit 7635 inside the housing 7630a and the housing 7630b. The power storage unit 7635 is provided across the housing 7630a and the housing 7630b, passing through the movable portion 7640.

The entire region or part of the region of the display portion 7631 can be a touch panel region, and data can be input by touching text, an input form, an image including an icon, and the like displayed on the region. For example, it is possible that keyboard buttons are displayed on the entire display portion 7631a on the housing 7630a side, and information such as text or an image is displayed on the display portion 7631b on the housing 7630b side.

It is possible that a keyboard is displayed on the display portion 7631b on the housing 7630b side, and information such as text or an image is displayed on the display portion 7631a on the housing 7630a side. Furthermore, it is possible that a switching button for showing/hiding a keyboard on a touch panel is displayed on the display portion 7631 and the button is touched with a finger, a stylus, or the like to display a keyboard on the display portion 7631.

Touch input can be performed concurrently in a touch panel region in the display portion 7631a on the housing 7630a side and a touch panel region in the display portion 7631b on the housing 7630b side.

The switch 7625 to the switch 7627 may function not only as an interface for operating the tablet terminal 7600 but also as an interface that can switch various functions. For example, at least one of the switch 7625 to the switch 7627 may function as a switch for switching power on/off of the tablet terminal 7600. For another example, at least one of the switch 7625 to the switch 7627 may have a function of switching the display orientation between a portrait mode and a landscape mode or a function of switching display between monochrome display and color display. For another example, at least one of the switch 7625 to the switch 7627 may have a function of adjusting the luminance of the display portion 7631. The luminance of the display portion 7631 can be optimized in accordance with the amount of external light in use of the tablet terminal 7600 detected by an optical sensor incorporated in the tablet terminal 7600. Note that another sensing device including a sensor for sensing inclination, such as a gyroscope sensor or an acceleration sensor, may be incorporated in the tablet terminal 7600, in addition to the optical sensor.

FIG. 53A illustrates an example in which the display portion 7631a on the housing 7630a side and the display portion 7631b on the housing 7630b side have substantially the same display area; however, there is no particular limitation on the display areas of the display portion 7631a and the display portion 7631b, and the display portions may have different sizes or different display quality. For example, one may be a display panel that can display higher-definition images than the other.

The tablet terminal 7600 is folded in half in FIG. 53B. The tablet terminal 7600 includes a housing 7630, a solar panel 7633, and a charge and discharge control circuit 7634 including a DCDC converter 7636. The secondary battery of one embodiment of the present invention is used as the power storage unit 7635. A solar panel is referred to as a solar cell module in some cases.

Note that as described above, the tablet terminal 7600 can be folded in half, and thus can be folded when not in use such that the housing 7630a and the housing 7630b overlap with each other. By the folding, the display portion 7631 can be protected, which increases the durability of the tablet terminal 7600. With the power storage unit 7635 using the secondary battery of one embodiment of the present invention, which has a high capacity and excellent cycle performance, the tablet terminal 7600 that can be used for a long time over a long period can be provided. To improve safety, a protection circuit that prevents overcharging and/or overdischarging of the secondary battery included in the power storage unit 7635 may be electrically connected to the secondary battery.

In addition, the tablet terminal 7600 illustrated in FIG. 53A and FIG. 53B can also have a function of displaying various kinds of information (e.g., a still image, a moving image, and a text image), a function of displaying a calendar, a date, the time, or the like on the display portion, a touch input function of operating or editing information displayed on the display portion by touch input, a function of controlling processing by various kinds of software (programs), and the like.

The solar panel 7633, which is attached on the surface of the tablet terminal 7600, can supply electric power to a touch panel, a display portion, a video signal processing portion, and the like. Note that the solar panel 7633 can be provided on one surface or both surfaces of the housing 7630 and the power storage unit 7635 can be charged efficiently. The use of a lithium-ion battery as the power storage unit 7635 brings an advantage such as a reduction in size.

The structure and operation of the charge and discharge control circuit 7634 illustrated in FIG. 53B are described with reference to a block diagram in FIG. 53C. The solar panel 7633, the power storage unit 7635, the DCDC converter 7636, a converter 7637, a switch SW1 to a switch SW3, and the display portion 7631 are illustrated in FIG. 53C, and the power storage unit 7635, the DCDC converter 7636, the converter 7637, and the switch SW1 to the switch SW3 correspond to the charge and discharge control circuit 7634 illustrated in FIG. 53B.

First, an operation example in which electric power is generated by the solar panel 7633 using external light is described. The voltage of electric power generated by the solar panel is raised or lowered by the DCDC converter 7636 to voltage for charging the power storage unit 7635. When the display portion 7631 is operated with the electric power from the solar panel 7633, the switch SW1 is turned on and the voltage is raised or lowered by the converter 7637 to voltage needed for the display portion 7631. When display on the display portion 7631 is not performed, the switch SW1 is turned off and the switch SW2 is turned on, so that the power storage unit 7635 is charged.

Note that the solar panel 7633 is described as an example of a power generation unit; however, one embodiment of the present invention is not limited to this example. The power storage unit 7635 may be charged using another power generation unit such as a piezoelectric element or a thermoelectric conversion element (Peltier element). For example, charging may be performed with a non-contact electric power transmission module that performs charging by transmitting and receiving electric power wirelessly (without contact), or with a combination of other charge units.

FIG. 54 illustrates other examples of electronic devices. In FIG. 54, a display device 8000 is an example of an electronic device using a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. To improve safety, a protection circuit that prevents overcharging and/or overdischarging of the secondary battery 8004 may be electrically connected to the secondary battery 8004. The secondary battery 8004 of one embodiment of the present invention is provided in the housing 8001. The display device 8000 can be supplied with electric power from a commercial power source and can use electric power stored in the secondary battery 8004. Thus, the display device 8000 can be operated with the use of the secondary battery 8004 of one embodiment of the present invention as an uninterruptible power source even when electric power cannot be supplied from a commercial power source due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes, in its category, all of information display devices for personal computers, advertisement displays, and the like besides information display devices for TV broadcast reception.

In FIG. 54, an installation lighting device 8100 is an example of an electronic device using a secondary battery 8103 of one embodiment of the present invention. Specifically, the lighting device 8100 includes a housing 8101, a light source 8102, the secondary battery 8103, and the like. To improve safety, a protection circuit that prevents overcharging and/or overdischarging of the secondary battery 8103 may be electrically connected to the secondary battery 8103. Although FIG. 54 illustrates an example of the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power source and can use electric power stored in the secondary battery 8103. Thus, the lighting device 8100 can be operated with the use of the secondary battery 8103 of one embodiment of the present invention as an uninterruptible power source even when electric power cannot be supplied from a commercial power source due to power failure or the like.

Note that although the installation lighting device 8100 provided in the ceiling 8104 is illustrated in FIG. 54 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and/or an organic EL element are given as examples of the artificial light source.

In FIG. 54, an air conditioner including an indoor unit 8200 and an outdoor unit 8204 is an example of an electronic device using a secondary battery 8203 of one embodiment of the present invention. Specifically, the indoor unit 8200 includes a housing 8201, an air outlet 8202, the secondary battery 8203, and the like. To improve safety, a protection circuit that prevents overcharging and/or overdischarging of the secondary battery 8203 may be electrically connected to the secondary battery 8203. Although FIG. 54 illustrates an example of the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power source and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power source even when electric power cannot be supplied from a commercial power source due to power failure or the like.

Note that although the split-type air conditioner including the indoor unit and the outdoor unit is illustrated in FIG. 54 as an example, the secondary battery of one embodiment of the present invention can be used in an air conditioner in which the function of an indoor unit and the function of an outdoor unit are integrated in one housing.

In FIG. 54, an electric refrigerator-freezer 8300 is an example of an electronic device using a secondary battery 8304 of one embodiment of the present invention. Specifically, the electric refrigerator-freezer 8300 includes a housing 8301, a refrigerator door 8302, a freezer door 8303, the secondary battery 8304, and the like. To improve safety, a protection circuit that prevents overcharging and/or overdischarging of the secondary battery 8304 may be electrically connected to the secondary battery 8304. The secondary battery 8304 is provided in the housing 8301 in FIG. 54. The electric refrigerator-freezer 8300 can be supplied with electric power from a commercial power source and can use electric power stored in the secondary battery 8304. Thus, the electric refrigerator-freezer 8300 can be operated with the use of the secondary battery 8304 of one embodiment of the present invention as an uninterruptible power source even when electric power cannot be supplied from a commercial power source due to power failure or the like.

Note that among the electronic devices described above, a high-frequency heating apparatus such as a microwave oven and an electronic device such as an electric rice cooker require high electric power in a short time. Therefore, the tripping of a breaker of a commercial power source in use of the electronic device can be prevented by using the secondary battery of one embodiment of the present invention as an auxiliary power source for supplying electric power that cannot be supplied enough by a commercial power source.

In a time period when electronic devices are not used, particularly when the proportion of the amount of electric power that is actually used to the total amount of electric power that can be supplied from a commercial power supply source (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the temperature is low and the refrigerator door 8302 and the freezer door 8303 are not opened or closed. Moreover, in daytime when the temperature is high and the refrigerator door 8302 and the freezer door 8303 are opened and closed, the usage rate of electric power in daytime can be kept low by using the secondary battery 8304 as an auxiliary power source.

According to one embodiment of the present invention, the secondary battery can have excellent cycle performance and improved reliability. Furthermore, according to one embodiment of the present invention, a secondary battery with a high capacity can be obtained; thus, the secondary battery itself can be made more compact and lightweight as a result of improved performance of the secondary battery. Thus, the secondary battery of one embodiment of the present invention is used in the electronic device described in this embodiment, whereby a more lightweight electronic device with a longer lifetime can be obtained.

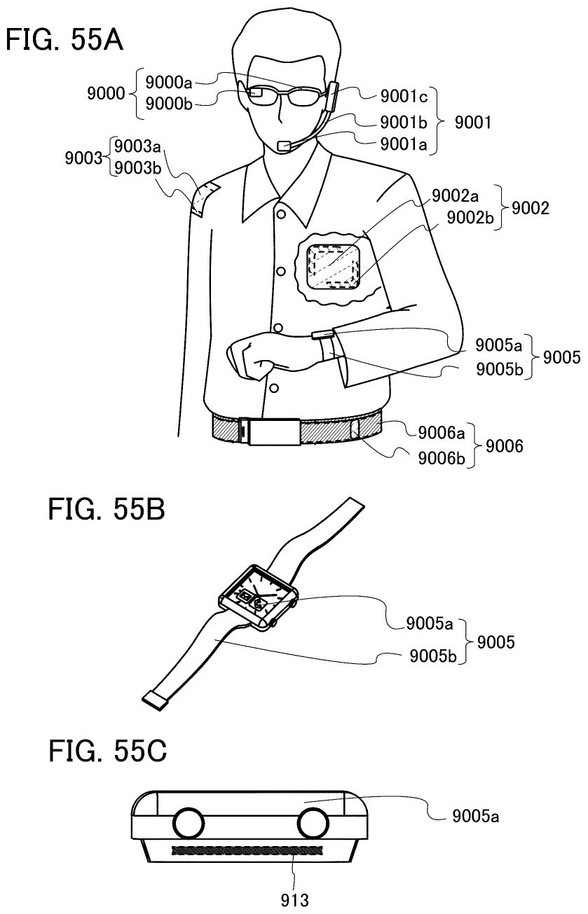

FIG. 55A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 9000 illustrated in FIG. 55A. The glasses-type device 9000 includes a frame 9000a and a display part 9000b. The secondary battery is provided in a temple of the frame 9000a having a curved shape, whereby the glasses-type device 9000 can be lightweight, can have a well-balanced weight, and can be used continuously for a long time. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The secondary battery of one embodiment of the present invention can be provided in a headset-type device 9001. The headset-type device 9001 includes at least a microphone portion 9001a, a flexible pipe 9001b, and an earphone portion 9001c. The secondary battery can be provided in the flexible pipe 9001b or the earphone portion 9001c. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The secondary battery of one embodiment of the present invention can be provided in a device 9002 that can be attached directly to a body. A secondary battery 9002b can be provided in a thin housing 9002a of the device 9002. To improve safety, a protection circuit that prevents overcharging and/or overdischarging of the secondary battery 9002b may be electrically connected to the secondary battery 9002b. With the use of the secondary battery of one embodiment of the present invention, space saving required with downsizing of a housing can be achieved.

The secondary battery of one embodiment of the present invention can be provided in a device 9003 that can be attached to clothes. A secondary battery 9003b can be provided in a thin housing 9003a of the device 9003. To improve safety, a protection circuit that prevents overcharging and/or overdischarging of the secondary battery 9003b may be electrically connected to the secondary battery 9003b. With the use of the secondary battery of one embodiment of the present invention, space saving required with downsizing of a housing can be achieved.

The secondary battery of one embodiment of the present invention can be provided in a belt-type device 9006. The belt-type device 9006 includes a belt portion 9006a and a wireless power feeding and receiving portion 9006b, and the secondary battery can be provided inside the belt portion 9006a. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The secondary battery of one embodiment of the present invention can be provided in a watch-type device 9005. The watch-type device 9005 includes a display portion 9005a and a belt portion 9005b, and the secondary battery can be provided in the display portion 9005a or the belt portion 9005b. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The display portion 9005a can display various kinds of information such as time and reception information of an e-mail and/or an incoming call.

In addition, the watch-type device 9005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 55B is a perspective view of the watch-type device 9005 that is detached from an arm.

FIG. 55C is a side view. FIG. 55C illustrates a state where the secondary battery 913 of one embodiment of the present invention is incorporated in the watch-type device 9005. The secondary battery 913, which is small and lightweight, overlaps with the display portion 9005a.

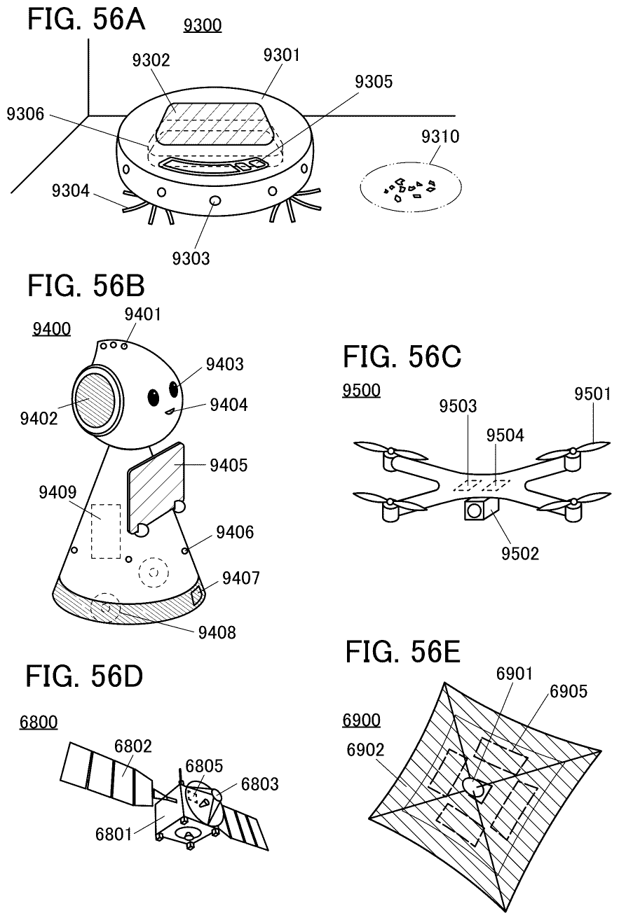

FIG. 56A illustrates an example of a cleaning robot. A cleaning robot 9300 includes a display portion 9302 placed on the top surface of a housing 9301, a plurality of cameras 9303 placed on the side surface of the housing 9301, a brush 9304, operation buttons 9305, a secondary battery 9306, a variety of sensors, and the like. To improve safety, a protection circuit that prevents overcharging and/or overdischarging of the secondary battery 9306 may be electrically connected to the secondary battery 9306. Although not illustrated, the cleaning robot 9300 is provided with a tire, an inlet, and the like. The cleaning robot 9300 is self-propelled, detects dust 9310, and sucks up the dust through the inlet provided on the bottom surface.

For example, the cleaning robot 9300 can determine whether there is an obstacle such as a wall, furniture, or a step by analyzing images taken by the cameras 9303. In the case where the cleaning robot 9300 detects an object, such as a wire, that is likely to be caught in the brush 9304 by image analysis, the rotation of the brush 9304 can be stopped. The cleaning robot 9300 includes the secondary battery 9306 of one embodiment of the present invention and a semiconductor device or an electronic component. The cleaning robot 9300 using the secondary battery 9306 of one embodiment of the present invention can be a highly reliable electronic device that can operate for a long time.

FIG. 56B illustrates an example of a robot. A robot 9400 illustrated in FIG. 56B includes a secondary battery 9409, an illuminance sensor 9401, a microphone 9402, an upper camera 9403, a speaker 9404, a display portion 9405, a lower camera 9406, an obstacle sensor 9407, a moving mechanism 9408, an arithmetic device, and the like. To improve safety, a protection circuit that prevents overcharging and/or overdischarging of the secondary battery 9409 may be electrically connected to the secondary battery 9409.

The microphone 9402 has a function of detecting a speaking voice of a user, an environmental sound, and the like. The speaker 9404 has a function of outputting sound. The robot 9400 can communicate with a user using the microphone 9402 and the speaker 9404.

The display portion 9405 has a function of displaying various kinds of information. The robot 9400 can display information desired by a user on the display portion 9405. The display portion 9405 may be provided with a touch panel. Moreover, the display portion 9405 may be a detachable information terminal, in which case charging and data communication can be performed when the display portion 9405 is set at the home position of the robot 9400.

The upper camera 9403 and the lower camera 9406 each have a function of taking an image of the surroundings of the robot 9400. The obstacle sensor 9407 can detect the presence of an obstacle in the direction where the robot 9400 advances with the moving mechanism 9408. The robot 9400 can move safely by recognizing the surroundings with the upper camera 9403, the lower camera 9406, and the obstacle sensor 9407.

The robot 9400 includes the secondary battery 9409 of one embodiment of the present invention and a semiconductor device or an electronic component. The robot 9400 using the secondary battery of one embodiment of the present invention can be a highly reliable electronic device that can operate for a long time.

FIG. 56C illustrates an example of a flying object. A flying object 9500 illustrated in FIG. 56C includes propellers 9501, a camera 9502, a secondary battery 9503, and the like and has a function of flying autonomously. To improve safety, a protection circuit that prevents overcharging and/or overdischarging of the secondary battery 9503 may be electrically connected to the secondary battery 9503.

For example, image data taken by the camera 9502 is stored in an electronic component 9504. The electronic component 9504 can analyze the image data to detect whether there is an obstacle in the way of the movement. Moreover, the electronic component 9504 can estimate the remaining battery level from a change in the power storage capacity of the secondary battery 9503. The flying object 9500 includes the secondary battery 9503 of one embodiment of the present invention. The flying object 9500 using the secondary battery of one embodiment of the present invention can be a highly reliable electronic device that can operate for a long time.

FIG. 56D illustrates an artificial satellite 6800 as an example of a device for space. The artificial satellite 6800 includes a body 6801, a solar panel 6802, an antenna 6803, and a secondary battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the secondary battery 6805.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

FIG. 56E illustrates a probe 6900 including a solar sail as an example of a device for space. The probe 6900 includes a body 6901, a solar sail 6902, and a secondary battery 6905. When photons from the sun are incident on the surface of the solar sail 6902, the momentum is transmitted to the solar sail 6902.

When being in the expanse beyond the earth's atmosphere (outer space), the solar sail 6902 is unfurled to have a large thin-film sheet-like shape as illustrated in FIG. 56E. That is, the solar sail 6902 is furled in a small size until it goes beyond the earth's atmosphere. Here, it is preferable that one surface of the solar sail 6902 have a thin film with high reflectance and face the sun. The other surface of the solar sail 6902 can be provided with the secondary battery 6905. It is preferable to use, as the secondary battery 6905, the bendable secondary battery of one embodiment of the present invention.

This embodiment can be implemented in appropriate combination with any of the other embodiments.

(Notes on Description of this Specification and the Like)

The description of the above embodiments and each structure in the embodiments are noted below.

One embodiment of the present invention can be constituted by combining, as appropriate, the structure described in each embodiment with the structures described in the other embodiments. In addition, in the case where a plurality of structure examples are described in one embodiment, the structure examples can be combined as appropriate.

Note that a content (or part thereof) described in one embodiment can be applied to, combined with, or replaced with another content (or part thereof) described in the embodiment and/or a content (or part thereof) described in another embodiment or other embodiments, for example.

Note that in each embodiment, a content described in the embodiment is a content described with reference to a variety of drawings or a content described with text disclosed in the specification.

Note that by combining a drawing (or part thereof) described in one embodiment with another part of the drawing, a different drawing (or part thereof) described in the embodiment, and/or a drawing (or part thereof) described in another embodiment or other embodiments, much more drawings can be formed.

In addition, in this specification and the like, components are classified on the basis of the functions, and shown as blocks independent of one another in block diagrams. However, in an actual circuit or the like, it is difficult to separate components on the basis of the functions, and there is such a case where one circuit is associated with a plurality of functions or a case where a plurality of circuits are associated with one function. Therefore, blocks in the block diagrams are not limited by the components described in this specification, and the description can be changed appropriately depending on the situation.

In drawings, the size, the layer thickness, or the region is shown arbitrarily for description convenience. Therefore, they are not limited to the illustrated scale. Note that the drawings are schematically shown for clarity, and embodiments of the present invention are not limited to shapes, values, or the like shown in the drawings. For example, variation in signal, voltage, or current due to noise or variation in signal, voltage, or current due to difference in timing can be included.

### Example 1

In this example, a secondary battery of one embodiment of the present invention was fabricated and evaluated.

### [Formation of Positive Electrode Active Material]

A positive electrode active material was formed with reference to the formation method shown in FIG. 8 and FIG. 9.

As LiMO₂ in Step S14, commercially available lithium cobalt oxide (Cellseed C-10N produced by NIPPON CHEMICAL INDUSTRIAL CO., LTD.) containing cobalt as the transition metal M and not containing any additive was prepared.

Next, in Step S15, heating was performed at 850° C. for 2 hours in an oxygen atmosphere.

Next, lithium fluoride and magnesium fluoride were prepared as the X1 source in Step S20a, and the lithium fluoride and the magnesium fluoride were mixed by a solid phase method in Step S31 to Step S32. The lithium fluoride and the magnesium fluoride were added such that the number of molecules of the lithium fluoride was 0.33 and the number of molecules of the magnesium fluoride was 1 with the number of cobalt atoms assumed as 100. The mixture here is the mixture 902.

Next, annealing was performed in Step S33. In a square-shaped alumina container, 30 g of the mixture 902 was placed, a lid was put on the container, and heating was performed in a muffle furnace. The atmosphere in the furnace was purged and an oxygen gas was introduced; the oxygen flow was stopped during the heating. The annealing temperature was 900° C., and the annealing time was 20 hours.

To the composite oxide that had been heated, nickel hydroxide and aluminum hydroxide were added and mixed by a dry method in Step S51, whereby a mixture 904 was obtained. The addition was performed such that the number of nickel atoms was 0.5 and the number of aluminum atoms was 0.5 with the number of cobalt atoms assumed as 100. The mixture here is the mixture 904.

Next, annealing was performed in Step S53. In a square-shaped alumina container, 30 g of the mixture 904 was placed, a lid was put on the container, and heating was performed in a muffle furnace. The atmosphere in the furnace was purged and an oxygen gas was introduced; the oxygen flow was performed during the heating. The annealing temperature was 850° C., and the annealing time was 10 hours.

After that, the mixture was made to pass through a sieve with 53 μmϕ and powder was collected, so that a positive electrode active material was obtained.

### [Formation of Positive Electrode]

Next, a positive electrode was formed using the positive electrode active material formed in the above manner. The positive electrode active material formed in the above manner, acetylene black (AB), and polyvinylidene fluoride (PVDF) were mixed at the positive electrode active material:AB:PVDF=95:3:2 (weight ratio) using NMP as a solvent, whereby slurry was formed. After a current collector was coated with the formed slurry, the solvent was volatilized. After that, pressing was performed with 120 kN/m at 120° C. and a positive electrode active material layer was formed on the current collector; thus, a positive electrode was formed. Aluminum foil having a thickness of 20 μm was used as the current collector. The positive electrode active material layer was provided on one surface of the current collector. The loading amount was approximately 10 mg/cm².

### [Formation of Negative Electrode]

A negative electrode was formed using graphite as a negative electrode active material.

MCMB graphite having a specific surface area of 1.5 μm²/g was used as the graphite and mixed with a conductive material, CMC-Na, and SBR at the graphite:the conductive material:CMC-Na:SBR=96:1:1:2 (weight ratio) using water as a solvent, whereby slurry was formed.

The polymerization degree of CMC-Na that was used was 600 to 800, and the viscosity of a 1 weight % CMC-Na aqueous solution was in the range from 300 mPa·s to 500 mPa·s. As the conductive material, VGCF (registered trademark)-H (produced by SHOWA DENKO K.K., the fiber diameter: 150 nm, the specific surface area: 13 μm²/g), which is vapor-grown carbon fiber, was used.

A current collector was coated with the formed slurry and then drying was performed, so that a negative electrode active material layer was formed on the current collector. Copper foil having a thickness of 18 μm was used as the current collector. The negative electrode active material layer was provided on both surfaces or one surface of the current collector. The loading amount was approximately 9 mg/cm².

### [Fabrication of Secondary Battery]

With the use of the positive electrode and the negative electrode formed in the above manner, a secondary battery using a film as an exterior body was fabricated.

As a separator, 50-μm-thick nonwoven fabric was used.

Fifteen negative electrodes each having the negative electrode active material layers on both surfaces, fourteen positive electrodes each having the positive electrode active material layers on both surfaces, and two positive electrodes each having the positive electrode active material layer on one surface were prepared. The positive electrode active material layers were arranged to face the respective negative electrode active material layers formed on both surfaces of the negative electrodes with the separator sandwiched therebetween.

Leads were bonded to the positive electrodes and the negative electrodes.

A stack in which the positive electrodes, the negative electrodes, and the separators were stacked was sandwiched between facing portions of the exterior body that was folded in half, and the stack was placed such that one ends of the leads extended outside the exterior body. Next, one side of the exterior body was left as an aperture, and the other sides were sealed.

As a film to be the exterior body, a film in which a polypropylene layer, an acid modified polypropylene layer, an aluminum layer, and a nylon layer were stacked in this order was used. The thickness of the film was approximately 110 n m. The film to be the exterior body was bent such that the nylon layer was placed as the surface of the exterior body placed on the outer side and the polypropylene layer was placed as the surface of the exterior body placed on the inner side. The thickness of the aluminum layer was approximately 40 μm, the thickness of the nylon layer was approximately 25 μm, and the total thickness of the polypropylene layer and the acid modified polypropylene layer was approximately 45 μm.

Next, in an argon gas atmosphere, an electrolyte solution was introduced from the one side left as an aperture.

The electrolyte solution was prepared. As a solvent of the electrolyte solution, EMI-FSA represented by Structural Formula (G11) was used. As a lithium salt, LiFSA (lithium bis(fluorosulfonyl)amide) was used, and the concentration of the lithium salt in the electrolyte solution was 2.15 mol/L.

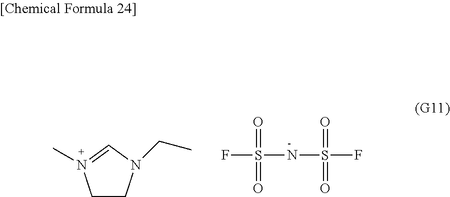

Then, the one side of the exterior body left as an aperture was sealed in a reduced-pressure atmosphere.

Through the above steps, the secondary battery (Cell A) was fabricated.

### [Aging]

Next, the secondary battery (Cell A) was subjected to aging.

The secondary battery was sandwiched between two plates, CC charging was performed at 0.01 C until a charge capacity reached 15 mAh/g, a 10-minute break was taken, and then CC charging was performed at 0.1 C until a charge capacity reached 105 mAh/g (120 mAh/g in total). After that, the two plates were removed, the secondary battery was held for 24 hours at 60° C., the one side of the exterior body was cut open in an argon atmosphere, degassing was performed, and then resealing was performed.

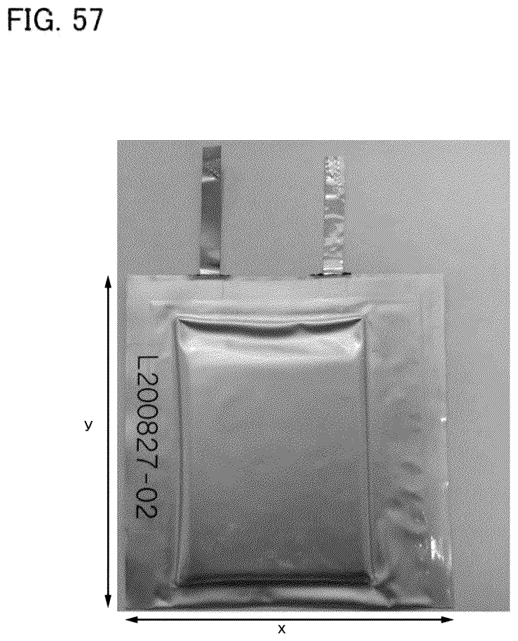

FIG. 57 shows a photograph of a secondary battery having the same structure as the secondary battery fabricated in this example. Note that the secondary battery shown in FIG. 57 differs from that in this example in the material of the separator and the loading amounts of the electrodes.

The external dimensions of the fabricated secondary battery were measured. For the external dimensions, measurement was performed on the exterior body and the lead electrodes were not measured. The external dimensions of the secondary battery seen from above were as follows: the horizontal length (x in FIG. 57) was approximately 87 mm, the vertical length (y in FIG. 57) was approximately 77 mm, and the thickness was approximately 6.3 mm.

### [Evaluation 1 of Cycle Performance]

The secondary battery (Cell A) was sandwiched between two plates and cycle performance of the secondary battery was evaluated.

The area of the positive electrode active material layer of the positive electrode was 20.493 cm².

The loading amount of the negative electrode active material of the negative electrode in each battery cell was adjusted such that the capacity ratio becomes approximately higher than or equal to 75% and lower than or equal to 85%. Here, the capacity ratio denotes a value representing the capacity of the positive electrode with respect to the capacity of the negative electrode by percentage. In calculation of the capacity ratio, the capacity of the negative electrode was 300 mAh/g using the weight of the negative electrode active material as a reference. Note that in the case where the negative electrode active material layers are provided on the both surfaces of the current collector, the loading amount of the negative electrode active material was calculated by halving the total loading amount.

Note that the positive electrodes and the negative electrodes had the same area.

Cycle tests were performed in environments at −20° C., 0° C., 25° C., 45° C., 60° C., 80° C., and 100° C.

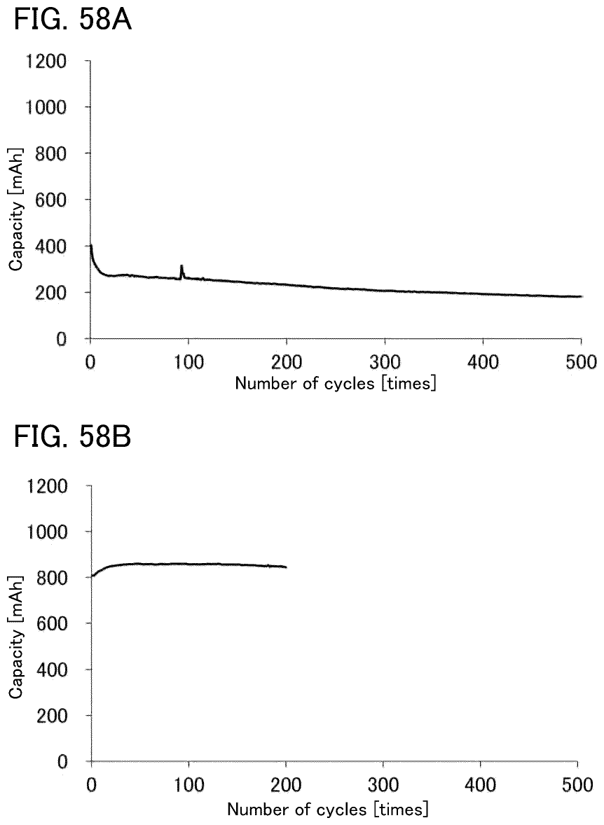

In the environment at −20° C., CCCV charging (0.1 C, a termination current of 0.05 C, 4.3 V) was performed and CC discharging (0.1 C, 3.0 V) was performed. The capacity of the secondary battery was calculated using the weight of the positive electrode active material as a reference. The C rate was calculated on the assumption that 1 C was 200 mA/g (per positive electrode active material weight). FIG. 58A shows the results of the cycle performance.

In the environment at 0° C., CCCV charging (0.2 C, a termination current of 0.1 C, 4.3 V) was performed and CC discharging (0.2 C, 3.0 V) was performed. The capacity of the secondary battery was calculated using the weight of the positive electrode active material as a reference. The C rate was calculated on the assumption that 1 C was 200 mA/g (per positive electrode active material weight). FIG. 58B shows the results of the cycle performance.

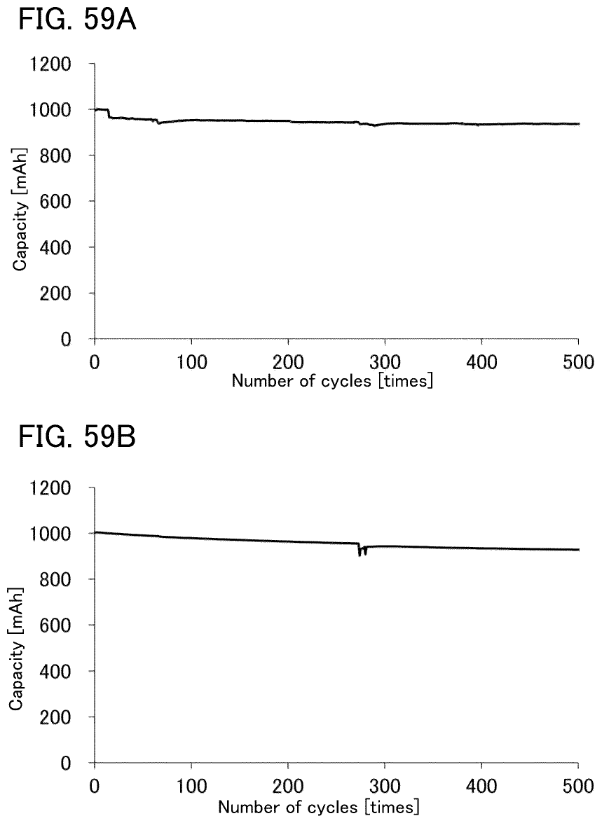

In the environment at 25° C., CCCV charging (0.2 C, a termination current of 0.1 C, 4.3 V) was performed and CC discharging (0.2 C, 3.0 V) was performed. The capacity of the secondary battery was calculated using the weight of the positive electrode active material as a reference. The C rate was calculated on the assumption that 1 C was 200 mA/g (per positive electrode active material weight). FIG. 59A shows the results of the cycle performance.

In the environment at 45° C., CCCV charging (0.5 C, a termination current of 0.2 C, 4.3 V) was performed and CC discharging (0.5 C, 3.0 V) was performed. The capacity of the secondary battery was calculated using the weight of the positive electrode active material as a reference. The C rate was calculated on the assumption that 1 C was 200 mA/g (per positive electrode active material weight). FIG. 59B shows the results of the cycle performance.

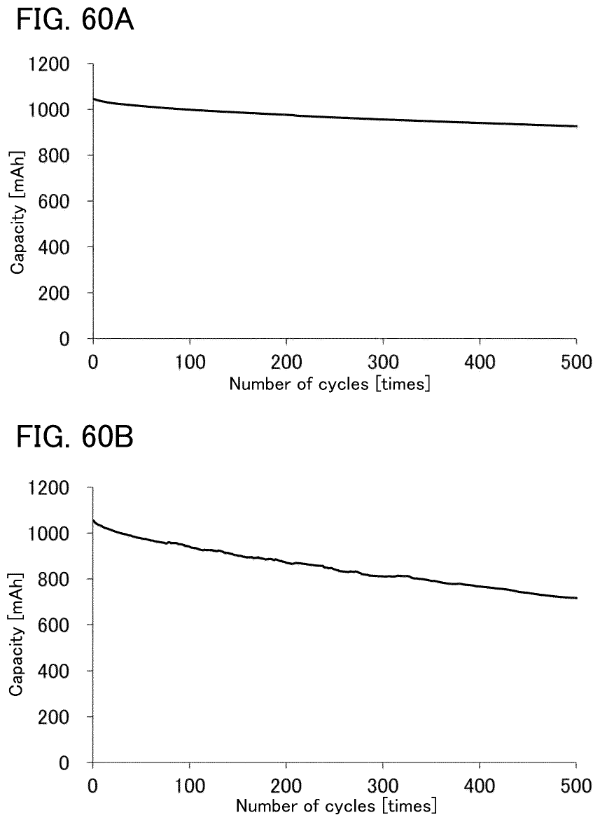

In the environment at 60° C., CCCV charging (0.5 C, a termination current of 0.2 C, 4.3 V) was performed and CC discharging (0.5 C, 3.0 V) was performed. The capacity of the secondary battery was calculated using the weight of the positive electrode active material as a reference. The C rate was calculated on the assumption that 1 C was 200 mA/g (per positive electrode active material weight). FIG. 60A shows the results of the cycle performance.

In the environment at 80° C., CCCV charging (0.5 C, a termination current of 0.2 C, 4.3 V) was performed and CC discharging (0.5 C, 3.0 V) was performed. The capacity of the secondary battery was calculated using the weight of the positive electrode active material as a reference. The C rate was calculated on the assumption that 1 C was 200 mA/g (per positive electrode active material weight). FIG. 60B shows the results of the cycle performance.

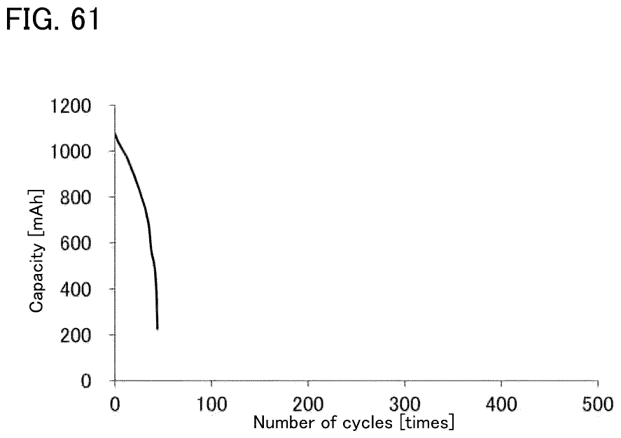

In the environment at 100° C., CCCV charging (0.5 C, a termination current of 0.2 C, 4.3 V) was performed and CC discharging (0.5 C, 3.0 V) was performed. The capacity of the secondary battery was calculated using the weight of the positive electrode active material as a reference. The C rate was calculated on the assumption that 1 C was 200 mA/g (per positive electrode active material weight). FIG. 61 shows the results of the cycle performance.

It is found that the fabricated secondary battery operates at each of the temperatures. It is also found that the fabricated secondary battery has excellent cycle performance.

### Example 2

In this example, bendable secondary batteries of embodiments of the present invention were fabricated and evaluated.

The bendable secondary batteries (Cell B, Cell C, Cell D, Cell E, Cell F, Cell G, Cell H, and Cell J) in this example were fabricated in the same manner as the secondary battery in Example 1 except that 24-μm-thick polyimide separators were used as separators and aluminum laminated films with alternating wave shapes that had been subjected to embossing were used as exterior bodies.

### [Cell B]

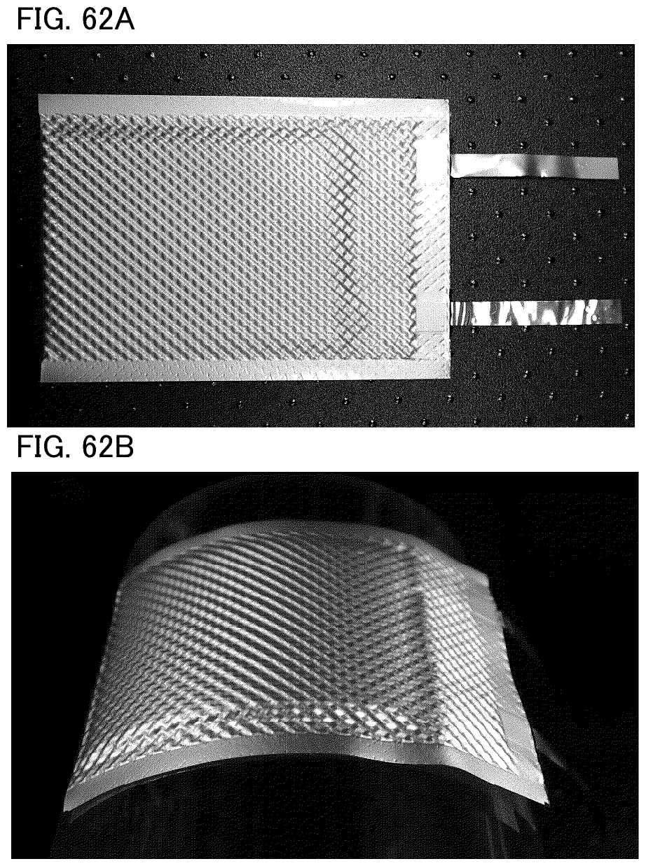

FIG. 62A and FIG. 62B are photographs showing the appearance of Cell B. FIG. 62A is a top view photograph of Cell B before bending. FIG. 62B is a bird's eye photograph of Cell B in the bent state. Cell B was able to perform a normal battery operation not only in the flat state before bending but also in the bent state shown in FIG. 62B.

### [Cell C to Cell G]

Measurement was performed on Cell C to Cell G. Table 1 lists the battery weights and the battery dimensions of Cell C to Cell G. Table 2 lists charge capacities and discharge capacities at 15° C., charge capacities and discharge capacities at 25° C., and impedance at 25° C.

TABLE 1

| | | Battery dimension (W × L × t) | | |
|---|---|---|---|---|
| | Battery weight | [mm] | | |
| Cell name | [g] | W | L | t |
| Cell C | 12.59 | 60.52 | 76.15 | 2.38 |
| Cell D | 12.60 | 60.66 | 75.96 | 2.36 |
| Cell E | 12.65 | 60.43 | 75.87 | 2.37 |
| Cell F | 12.68 | 60.10 | 76.15 | 2.41 |
| Cell G | 12.70 | 60.20 | 75.90 | 2.41 |

TABLE 2

| | 15° C. | | 25° C. | | |
|---|---|---|---|---|---|
| | Charge | Discharge | Charge | Discharge | Impedance |
| | capacity | capacity | capacity | capacity | (1 kHz) |
| Cell name | [mAh] | [mAh] | [mAh] | [mAh] | [×10⁻² Ω] |
| Cell C | 381.2 | 372.2 | 381.2 | 375.9 | 6.82 |
| Cell D | 378.9 | 373.6 | 380.7 | 377.2 | 6.75 |
| Cell E | 380.0 | 375.2 | 381.7 | 378.9 | 7.26 |
| Cell F | 382.3 | 375.9 | 383.5 | 380.0 | 6.80 |
| Cell G | 385.6 | 381.7 | 388.5 | 385.5 | 7.05 |

The conditions of the measurement shown in Table 2 are described below.

As the measurement shown in Table 2, aging treatment was performed first, charging at 15° C. was performed as first measurement, discharging at 15° C. was performed as second measurement, charging at 25° C. was performed as third measurement, discharging at 25° C. was performed as fourth measurement, and impedance measurement at 25° C. was performed as fifth measurement.

The aging treatment was performed in the following manner: in an environment at 25° C., 15° C. charging was performed at 0.01 C until a charge capacity reached 15 mAh/g, a 10-minute break was taken, and then CC charging was performed at 0.1 C until a charge capacity reached 105 mAh/g (120 mAh/g in total). After that, each of the cells was held for 24 hours at 60° C., the one side of the exterior body was cut open in an argon atmosphere, degassing was performed, and then resealing was performed. The resealing after the degassing was performed in a reduced-pressure environment at −95 kPa or lower (a pressure value read by a differential pressure gauge). Next, in an environment at 25° C., CCCV charging (0.1 C, a termination current of 0.01 C, 4.5 V) was performed and CC discharging (0.2 C, 2.5 V) was performed. Next, in an environment at 25° C., charging (CCCV charging (0.2 C, a termination current of 0.02 C, 4.5 V) and discharging (CC discharging (0.2 C, 2.5 V)) were repeated three times, so that the aging treatment was completed.

As the first measurement, CCCV charging (0.2 C, a termination current of 0.02 C, 4.5 V) was performed in an environment at 15° C. As the second measurement, CC discharging (0.2 C, 2.75 V) was performed in an environment at 15° C.

As the third measurement, CCCV charging (0.2 C, a termination current of 0.02 C, 4.5 V) was performed in an environment at 25° C. As the fourth measurement, CC discharging (0.2 C, 2.75 V) was performed in an environment at 25° C.

As the fifth measurement, in an environment at 25° C., CC charging was performed at 0.2 C until the charge rate (SOC: State of Charge) became 10% and then AC (Alternating Current) impedance measurement was performed. The measurement was performed under a plurality of frequency conditions (10 points per digit of frequency) including 1 kHz in the range of the measurement frequency from 10 mHz to 200 kHz. The measurement amplitude was set to ±10 mV. The values of the impedance shown in Table 2 were obtained at 1 kHz.

### [Cell H and Cell J]

Cell H and Cell J were subjected to bending tests. The measurement results are shown in Table 3.

TABLE 3

Discharge capacity [mAh]

| | First measurement | Second measurement |
|---|---|---|
| Cell name | (Before bending test) | (After bending test) |
| Cell H | 373.2 | 378.5 |
| Cell J | 377.6 | 377.1 |

The conditions of the measurement shown in Table 3 are described below.

As the measurement shown in Table 3, aging treatment was performed first, charging and discharging at 25° C. were performed as first measurement, bending tests were performed, and then charging and discharging at 25° C. were performed as second measurement.

The aging treatment was performed under the same conditions as the measurement in Table 2.

As the first measurement and the second measurement, in an environment at 25° C., CCCV charging (0.2 C, a termination current of 0.02 C, 4.5 V) was performed and CC discharging (0.2 C, 2.75 V) was performed. Table 3 shows discharge capacities.

In the bending tests, a bending and unbending operation in which each of the cells was changed (bent) from a first shape (with a curvature radius of 150 mm) to a second shape (with a curvature radius of 40 mm) and then was changed (unbent) from the second shape to the first shape was repeated 100 times.

Table 3 reveals that the discharge capacities in the second measurement do not decrease from the discharge capacities in the first measurement, which indicates that Cell G and Cell J in this example can be bent repeatedly.

Note that the C rate was calculated on the assumption that 1 C was 200 mA/g (per positive electrode active material weight). Table 4 lists the positive electrode active material weights and current values at 0.2 C as an example of the C rate of Cell C to Cell J.

TABLE 4

| | Positive electrode | Charge and discharge |
|---|---|---|
| | active material weight | current |
| Cell name | [g] | (0.2 C) [mA] |
| Cell C | 1.826 | 73.04 |
| Cell D | 1.836 | 73.45 |
| Cell E | 1.840 | 73.61 |
| Cell F | 1.850 | 73.99 |
| Cell G | 1.878 | 75.13 |
| Cell H | 1.834 | 73.36 |
| Cell J | 1.846 | 73.82 |

### REFERENCE NUMERALS

10: film, 10a: projection, 10b: projection, 12: stack, 15: sealing layer, 16: lead electrode, 17: thermocompression-bonded region, 18: positive electrode active material layer, 19: negative electrode active material layer, 20: electrolyte solution, 30: adhesive layer, 33: bonding portion, 34: bonding portion, 40: secondary battery, 45: extraction angle, 51: positive electrode active material, 61: film, 61a: film, 61b: film, 62: film, 63: film, 64: positive electrode current collector, 65: separator, 66: negative electrode current collector, 71: region, 72: positive electrode current collector, 73: separator, 74: negative electrode current collector, 75: sealing layer, 76: lead electrode, 77: electrolyte solution, 78: positive electrode active material layer, 79: negative electrode active material layer, 90: film, 90a: film, 90b: film, 100: positive electrode active material, 100a: surface portion, 100b: inner portion, 101: crystal grain boundary, 102: portion, 103: projection, 104: coating film, 130: stack, 131: stack, 210: electrode stack, 211a: positive electrode, 211b: negative electrode, 212a: lead, 212b: lead, 214: separator, 215a: bonding portion, 215b: bonding portion, 217: fixing member, 250: secondary battery, 251: exterior body, 261: portion, 262: seal portion, 263: seal portion, 271: crest line, 272: trough line, 273: space, 352: pitch, 354: distance, 400: negative electrode active material, 401: region, 401a: region, 401b: region, 402: region, 500: secondary battery, 501: positive electrode current collector, 502: positive electrode active material layer, 503: positive electrode, 504: negative electrode current collector, 505: negative electrode active material layer, 506: negative electrode, 507: separator, 507a: region, 507b: region, 508: electrolyte, 509: exterior body, 509a: exterior body, 509b: exterior body, 510: positive electrode lead electrode, 511: negative electrode lead electrode, 512: stack, 513: resin layer, 514: region, 515a: electrolyte, 515b: electrolyte, 515c: electrolyte, 516: inlet, 550: stack, 553: acetylene black, 554: graphene, 556: acetylene black, 557: graphene, 560: secondary battery, 561: positive electrode active material, 563: negative electrode active material, 570: manufacturing apparatus, 571: component introduction chamber, 572: transfer chamber, 573: processing chamber, 580: transfer mechanism, 581: polymer film, 582: hole, 584: polymer film, 585: hole, 591: stage, 594: nozzle, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 901: compound, 902: mixture, 903: positive electrode active material, 904: mixture, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 970: secondary battery, 971: housing, 972: stack, 973a: positive electrode lead electrode, 973b: terminal, 973c: conductor, 974a: negative electrode lead electrode, 974b: terminal, 974c: conductor, 975a: positive electrode, 975b: positive electrode, 976: separator, 977a: negative electrode, 1301a: battery, 1301b: battery, 1302: battery controller, 1303: motor controller, 1304: motor, 1305: gear, 1306: DCDC circuit, 1307: electric power steering, 1308: heater, 1309: defogger, 1310: DCDC circuit, 1311: battery, 1312: inverter, 1313: stereo, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1415: battery pack, 1421: wiring, 1422: wiring, 2001: automobile, 2002: transporter, 2003: transport vehicle, 2004: aircraft, 2005: transport vehicle, 2100: electric bicycle, 2101: secondary battery, 2102: power storage device, 2103: display portion, 2104: control circuit, 2201: battery pack, 2202: battery pack, 2203: battery pack, 2204: battery pack, 2300: motor scooter, 2301: side mirror, 2302: power storage device, 2303: indicator light, 2304: under-seat storage unit, 2603: vehicle, 2604: charge device, 2610: solar panel, 2611: wiring, 2612: power storage device, 2800: personal computer, 2801: housing, 2802: housing, 2803: display portion, 2804: keyboard, 2805: pointing device, 2806: secondary battery, 2807: secondary battery, 6800: artificial satellite, 6801: body, 6802: solar panel, 6803: antenna, 6805: secondary battery, 6900: probe, 6901: body, 6902: solar sail, 6905: secondary battery, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 7600: tablet terminal, 7625: switch, 7627: switch, 7628: operation switch, 7629: fastener, 7630: housing, 7630a: housing, 7630b: housing, 7631: display portion, 7631a: display portion, 7631b: display portion, 7633: solar panel, 7634: charge and discharge control circuit, 7635: power storage unit, 7636: DCDC converter, 7637: converter, 7640: movable portion, 8000: display device, 8001: housing, 8002: display portion, 8003: speaker portion, 8004: secondary battery, 8100: lighting device, 8101: housing, 8102: light source, 8103: secondary battery, 8104: ceiling, 8105: side wall, 8106: floor, 8107: window, 8200: indoor unit, 8201: housing, 8202: air outlet, 8203: secondary battery, 8204: outdoor unit, 8300: electric refrigerator-freezer, 8301: housing, 8302: refrigerator door, 8303: freezer door, 8304: secondary battery, 9000: glasses-type device, 9000a: frame, 9000b: display portion, 9001: headset-type device, 9001a: microphone portion, 9001b: flexible pipe, 9001c: earphone portion, 9002: device, 9002a: housing, 9002b: secondary battery, 9003: device, 9003a: housing, 9003b: secondary battery, 9005: watch-type device, 9005a: display portion, 9005b: belt portion, 9006: belt-type device, 9006a: belt portion, 9006b: wireless power feeding and receiving portion, 9300: cleaning robot, 9301: housing, 9302: display portion, 9303: camera, 9304: brush, 9305: operation button, 9306: secondary battery, 9310: dust, 9400: robot, 9401: illuminance sensor, 9402: microphone, 9403: upper camera, 9404: speaker, 9405: display portion, 9406: lower camera, 9407: obstacle sensor, 9408: moving mechanism, 9409: secondary battery, 9500: flying object, 9501: propeller, 9502: camera, 9503: secondary battery, 9504: electronic component

1. A secondary battery comprising:
a positive electrode active material; and
an electrolyte,
wherein the positive electrode active material is lithium cobalt oxide comprising magnesium,
wherein the magnesium has a gradient in which a concentration increases from an inner portion toward a surface of the positive electrode active material,
wherein the electrolyte comprises an imidazolium salt, and
wherein a temperature range where the secondary battery is capable of operating is higher than or equal to −20° C. and lower than or equal to 100° C.

2. A secondary battery comprising:
a positive electrode active material;
an electrolyte; and
an exterior body,
wherein the positive electrode active material is lithium cobalt oxide comprising magnesium,
wherein the magnesium has a gradient in which a concentration increases from an inner portion toward a surface of the positive electrode active material,
wherein the electrolyte comprises an imidazolium salt,
wherein the exterior body comprises a film having a depression and a projection, and
wherein a temperature range where the secondary battery is capable of operating is higher than or equal to −20° C. and lower than or equal to 100° C.

3. The secondary battery according to claim 1,
wherein the positive electrode active material is lithium cobalt oxide comprising aluminum in addition to the magnesium,
wherein the aluminum has a gradient in which a concentration increases from the inner portion toward the surface of the positive electrode active material, and
wherein a peak of the concentration of the magnesium is closer to the surface than a peak of the concentration of the aluminum is in a surface portion of the positive electrode active material.

4. The secondary battery according to claim 1,
wherein the electrolyte comprises a compound represented by General Formula (G1): 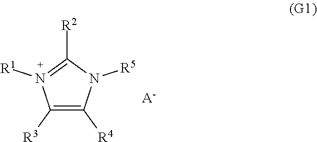
wherein R¹ represents an alkyl group having 1 to 4 carbon atoms,
wherein R², R³, and R⁴ each independently represent a hydrogen atom or an alkyl group having 1 to 4 carbon atoms,
wherein R⁵ represents an alkyl group or a main chain comprising two or more atoms selected from C, O, Si, N, S, and P atoms, and
wherein A⁻ represents an amide-based anion represented by (CₙF₂ₙ₊₁SO₂)₂N⁻, n being greater than or equal to 0 and less than or equal to 3.

5. The secondary battery according to claim 4,
wherein R¹ in General Formula (G1) represents one group selected from a methyl group,
an ethyl group, and a propyl group,
wherein one of R², R³, and R⁴ represents a hydrogen atom or a methyl group and the other two of R², R³, and R⁴ each represent a hydrogen atom,
wherein R⁵ represents an alkyl group or a main chain comprising two or more atoms selected from C, O, Si, N, S, and P atoms, and
wherein A⁻ represents one of (FSO₂)₂N⁻ and (CF₃SO₂)₂N⁻ or a mixture of (FSO₂)₂N⁻ and (CF₃SO₂)₂N⁻.

6. The secondary battery according to claim 5,
wherein a sum of the number of carbon atoms of R¹, the number of carbon atoms of R⁵,
and the number of oxygen atoms of R⁵ is less than or equal to 7 in General Formula (G1).

7. The secondary battery according to claim 5,
wherein R¹ represents a methyl group, R² represents a hydrogen atom, and a sum of the numbers of carbon atoms and oxygen atoms of R⁵ is less than or equal to 6 in General Formula (G1).

8. An electronic device comprising the secondary battery according to claim 4, and a solar panel.

9. The secondary battery according to claim 2,
wherein the electrolyte comprises a compound represented by General Formula (G1): 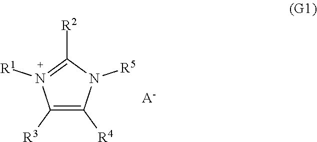
wherein R¹ represents an alkyl group having 1 to 4 carbon atoms,
wherein R², R³, and R⁴ each independently represent a hydrogen atom or an alkyl group having 1 to 4 carbon atoms,
wherein R⁵ represents an alkyl group or a main chain comprising two or more atoms selected from C, O, Si, N, S, and P atoms, and
wherein A⁻ represents an amide-based anion represented by (CₙF₂ₙ₊₁SO₂)₂N⁻, n being greater than or equal to 0 and less than or equal to 3.

10. The secondary battery according to claim 9,
wherein R¹ in General Formula (G1) represents one group selected from a methyl group, an ethyl group, and a propyl group,
wherein one of R², R³, and R⁴ represents a hydrogen atom or a methyl group and the other two of R², R³, and R⁴ each represent a hydrogen atom,
wherein R⁵ represents an alkyl group or a main chain comprising two or more atoms selected from C, O, Si, N, S, and P atoms, and
wherein A⁻ represents one of (FSO₂)₂N⁻ and (CF₃SO₂)₂N⁻ or a mixture of (FSO₂)₂N⁻ and (CF₃SO₂)₂N⁻.

11. The secondary battery according to claim 10,
wherein a sum of the number of carbon atoms of R¹, the number of carbon atoms of R⁵, and the number of oxygen atoms of R⁵ is less than or equal to 7 in General Formula (G1).

12. The secondary battery according to claim 10,
wherein R¹ represents a methyl group, R² represents a hydrogen atom, and a sum of the numbers of carbon atoms and oxygen atoms of R⁵ is less than or equal to 6 in General Formula (G1).

13. An electronic device comprising the secondary battery according to claim 9, and a solar panel.
